(19) United States
(12) Patent Application Publication
(10) Pub. No.: US 2025/0271856 A1
(43) Pub. Date: Aug. 28, 2025

(54) NAVIGATION USER INTERFACES

(71) Applicant: Apple Inc., Cupertino, CA (US)

(72) Inventors: Moritz VON VOLKMANN, Cupertino, CA (US); David A. KRIMSLEY, Sunnyvale, CA (US); Andrew S. KIM, Walnut Creek, CA (US); Christopher P. FOSS, San Francisco, CA (US); Corey K. WANG, Palo Alto, CA (US); Daamun MOHSENI, Campbell, CA (US); Daniel De Rocha ROSARIO, San Francisco, CA (US); Tom HSU, Santa Clara, CA (US)

(21) Appl. No.: 19/088,413

(22) Filed: Mar. 24, 2025

Related U.S. Application Data
(63) Continuation of application No. 19/109,483, filed on Jan. 1, 0001.
(60) Provisional application No. 63/409,773, filed on Sep. 24, 2022.
(60) Provisional application No. 63/409,774, filed on Sep. 24, 2022.
(60) Provisional application No. 63/409,776, filed on Sep. 24, 2022.
(60) Provisional application No. 63/409,777, filed on Sep. 24, 2022.

(51) Int. Cl. G05D 1/2285; G06F 3/01; G06V 40/20

(52) U.S. Cl. CPC G05D 1/2285; G06F 3/017; G06V 40/20

(57) ABSTRACT

The present disclosure generally relates to navigation user interfaces.

### CROSS-REFERENCE TO RELATED APPLICATIONS

This application is a continuation application of U.S. Non-Provisional patent application Ser. No. 19/109,483, entitled “NAVIGATION USER INTERFACES,” filed Mar. 6, 2025, which is a 371 patent application of International Patent Application Serial No. PCT/US2023/033559, entitled “NAVIGATION USER INTERFACES,” filed Sep. 23, 2023, which claims the benefit of U.S. Provisional Application No. 63/409,773, entitled “NAVIGATION TO OBJECTS,” filed Sep. 24, 2022, U.S. Provisional Application No. 63/409,774, entitled “REPOSITIONING PHYSICAL COMPONENTS,” filed Sep. 24, 2022, U.S. Provisional Application No. 63/409,776, entitled “DETOUR OPTIONS,” filed Sep. 24, 2022, U.S. Provisional Application No. 63/409,777, entitled “MULTI-STOP DESTINATION,” filed Sep. 24, 2022, the entirety of each of which is incorporated herein by reference.

### FIELD

The present disclosure relates generally to computer user interfaces, and more specifically to techniques for navigating.

### BACKGROUND

Map applications provide instructions to users to navigate to different locations. Traditionally, a user searches for a location in a database of a map application and initiates navigation to the location.

### SUMMARY

Some techniques for navigating using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for navigating. Such methods and interfaces optionally complement or replace other methods for navigating. Such methods and interfaces reduce the cognitive burden on a user and produce a more efficient human-machine interface. For battery-operated computing devices, such methods and interfaces conserve power and increase the time between battery charges.

In some embodiments, a method performed at a computer system that is in communication with a display generation component and one or more sensors is described. In some embodiments, the method comprises: displaying, via the display generation component, a representation of a physical environment, where the representation includes one or more objects detected via at least one sensor of the one or more sensors; receiving, via at least one sensor of the one or more sensors, a set of one or more inputs that includes an input corresponding to selection of an object of the one or more objects; and in response to receiving the set of one or more user inputs, displaying, via the display generation component, a path to a location corresponding to the object in the representation of the physical environment.

In some embodiments, a non-transitory computer-readable storage medium storing one or more programs configured to be executed by one or more processors of a computer system that is in communication with a display generation component and one or more sensors is described. In some embodiments, the non-transitory computer-readable storage medium storing one or more programs includes: displaying, via the display generation component, a representation of a physical environment, where the representation includes one or more objects detected via at least one sensor of the one or more sensors; receiving, via at least one sensor of the one or more sensors, a set of one or more inputs that includes an input corresponding to selection of an object of the one or more objects; and in response to receiving the set of one or more user inputs, displaying, via the display generation component, a path to a location corresponding to the object in the representation of the physical environment.

In some embodiments, a transitory computer-readable storage medium storing one or more programs configured to be executed by one or more processors of a computer system that is in communication with a display generation component and one or more sensors is described. In some embodiments, the non-transitory computer-readable storage medium storing one or more programs includes: displaying, via the display generation component, a representation of a physical environment, where the representation includes one or more objects detected via at least one sensor of the one or more sensors; receiving, via at least one sensor of the one or more sensors, a set of one or more inputs that includes an input corresponding to selection of an object of the one or more objects; and in response to receiving the set of one or more user inputs, displaying, via the display generation component, a path to a location corresponding to the object in the representation of the physical environment.

In some embodiments, a computer system configured to communicate with a display generation component and one or more sensors is described. In some embodiments, the computer system includes one or more processors; and memory storing one or more programs configured to be executed by the one or more processors, the one or more programs including instructions for: displaying, via the display generation component, a representation of a physical environment, where the representation includes one or more objects detected via at least one sensor of the one or more sensors; receiving, via at least one sensor of the one or more sensors, a set of one or more inputs that includes an input corresponding to selection of an object of the one or more objects; and in response to receiving the set of one or more user inputs, displaying, via the display generation component, a path to a location corresponding to the object in the representation of the physical environment.

In some embodiments, a computer system configured to communicate with a display generation component and one or more sensors is described. In some embodiments, the computer system includes: means for displaying, via the display generation component, a representation of a physical environment, where the representation includes one or more objects detected via at least one sensor of the one or more sensors; means for receiving, via at least one sensor of the one or more sensors, a set of one or more inputs that includes an input corresponding to selection of an object of the one or more objects; and means, responsive to receiving the set of one or more user inputs, for displaying, via the display generation component, a path to a location corresponding to the object in the representation of the physical environment.

In some embodiments, a computer program product is described. In some embodiments, the computer program product includes: displaying, via the display generation component, a representation of a physical environment, where the representation includes one or more objects detected via at least one sensor of the one or more sensors; receiving, via at least one sensor of the one or more sensors, a set of one or more inputs that includes an input corresponding to selection of an object of the one or more objects; and in response to receiving the set of one or more user inputs, displaying, via the display generation component, a path to a location corresponding to the object in the representation of the physical environment. Other embodiments of this aspect include corresponding computer systems, apparatus, and computer programs recorded on one or more computer storage devices, each configured to perform the actions of the methods.

In some embodiments, a method performed at a computer system that is in communication with a display generation component and one or more sensors is described. In some embodiments, the method comprises: displaying, via the display generation component, a representation of a physical environment; while displaying the representation of the physical environment, detecting, via at least one sensor of the one or more sensors, a first object in the physical environment; and in conjunction with detecting the first object in the physical environment: in accordance with a determination that a path to the first object is a first type of path, emphasizing the first object; and in accordance with a determination that the path to the first object is a second type of path that is different from the first type of path, forgoing emphasis of the first object.

In some embodiments, a non-transitory computer-readable storage medium storing one or more programs configured to be executed by one or more processors of a computer system that is in communication with a display generation component and one or more sensors is described. In some embodiments, the non-transitory computer-readable storage medium storing one or more programs includes: displaying, via the display generation component, a representation of a physical environment; while displaying the representation of the physical environment, detecting, via at least one sensor of the one or more sensors, a first object in the physical environment; and in conjunction with detecting the first object in the physical environment: in accordance with a determination that a path to the first object is a first type of path, emphasizing the first object; and in accordance with a determination that the path to the first object is a second type of path that is different from the first type of path, forgoing emphasis of the first object.

In some embodiments, a transitory computer-readable storage medium storing one or more programs configured to be executed by one or more processors of a computer system that is in communication with a display generation component and one or more sensors is described. In some embodiments, the transitory computer-readable storage medium storing one or more programs includes: displaying, via the display generation component, a representation of a physical environment; while displaying the representation of the physical environment, detecting, via at least one sensor of the one or more sensors, a first object in the physical environment; and in conjunction with detecting the first object in the physical environment: in accordance with a determination that a path to the first object is a first type of path, emphasizing the first object; and in accordance with a determination that the path to the first object is a second type of path that is different from the first type of path, forgoing emphasis of the first object.

In some embodiments, a computer system configured to communicate with a display generation component and one or more sensors is described. In some embodiments, the computer system includes one or more processors; and memory storing one or more programs configured to be executed by the one or more processors, the one or more programs including instructions for: displaying, via the display generation component, a representation of a physical environment; while displaying the representation of the physical environment, detecting, via at least one sensor of the one or more sensors, a first object in the physical environment; and in conjunction with detecting the first object in the physical environment: in accordance with a determination that a path to the first object is a first type of path, emphasizing the first object; and in accordance with a determination that the path to the first object is a second type of path that is different from the first type of path, forgoing emphasis of the first object.

In some embodiments, a computer system configured to communicate with a display generation component and one or more sensors is described. In some embodiments, the computer system includes: means for displaying, via the display generation component, a representation of a physical environment; means for while displaying the representation of the physical environment, detecting, via at least one sensor of the one or more sensors, a first object in the physical environment; and means, in conjunction with detecting the first object in the physical environment, for: in accordance with a determination that a path to the first object is a first type of path, emphasizing the first object; and in accordance with a determination that the path to the first object is a second type of path that is different from the first type of path, forgoing emphasis of the first object.

In some embodiments, a computer program product is described. In some embodiments, the computer program product also includes displaying, via the display generation component, a representation of a physical environment; while displaying the representation of the physical environment, detecting, via at least one sensor of the one or more sensors, a first object in the physical environment; and in conjunction with detecting the first object in the physical environment: in accordance with a determination that a path to the first object is a first type of path, emphasizing the first object; and in accordance with a determination that the path to the first object is a second type of path that is different from the first type of path, forgoing emphasis of the first object.

In some embodiments, a method performed at a computer system that is in communication with a display generation component; and one or more sensors is described. In some embodiments, the method comprises: detecting, via at least one sensor of the one or more sensors, a plurality of objects in a physical environment; displaying, via the display generation component, a representation of the physical environment including the plurality of objects; after displaying the representation of the physical environment including the plurality objects, displaying, via the display generation component, a plurality of user interface objects including: a first user interface object corresponding to a first object type; and a second user interface object corresponding to a second object type different from the first object type. The method also includes receiving, via at least one sensor of the one or more sensors, a set of one or more user inputs, the set of one or more user inputs including an input directed to the plurality of user interface objects; and while displaying the representation of the physical environment including the plurality of objects and in response to receiving the set of one or more user inputs: in accordance with a determination that the input was directed to the first user interface object, emphasizing a first set of one or more objects in the plurality of objects, where the first set of one or more objects are the first object type; and in accordance with a determination that the input was directed to the second user interface object, emphasizing a second set of one or more objects in the plurality of objects, where the second set of one or more objects are the second object type.

In some embodiments, a non-transitory computer-readable storage medium storing one or more programs configured to be executed by one or more processors of a computer system that is in communication with a display generation component and one or more sensors is described. In some embodiments, the non-transitory computer-readable storage medium storing one or more programs includes: detecting, via at least one sensor of the one or more sensors, a plurality of objects in a physical environment; displaying, via the display generation component, a representation of the physical environment including the plurality of objects; after displaying the representation of the physical environment including the plurality objects, displaying, via the display generation component, a plurality of user interface objects including: a first user interface object corresponding to a first object type; and a second user interface object corresponding to a second object type different from the first object type. The programs also includes receiving, via at least one sensor of the one or more sensors, a set of one or more user inputs, the set of one or more user inputs including an input directed to the plurality of user interface objects; and while displaying the representation of the physical environment including the plurality of objects and in response to receiving the set of one or more user inputs: in accordance with a determination that the input was directed to the first user interface object, emphasizing a first set of one or more objects in the plurality of objects, where the first set of one or more objects are the first object type; and in accordance with a determination that the input was directed to the second user interface object, emphasizing a second set of one or more objects in the plurality of objects, where the second set of one or more objects are the second object type.

In some embodiments, a transitory computer-readable storage medium storing one or more programs configured to be executed by one or more processors of a computer system that is in communication with a display generation component and one or more sensors is described. In some embodiments, the non-transitory computer-readable storage medium storing one or more programs includes: detecting, via at least one sensor of the one or more sensors, a plurality of objects in a physical environment; displaying, via the display generation component, a representation of the physical environment including the plurality of objects; after displaying the representation of the physical environment including the plurality objects, displaying, via the display generation component, a plurality of user interface objects including: a first user interface object corresponding to a first object type; and a second user interface object corresponding to a second object type different from the first object type. The programs also includes receiving, via at least one sensor of the one or more sensors, a set of one or more user inputs, the set of one or more user inputs including an input directed to the plurality of user interface objects; and while displaying the representation of the physical environment including the plurality of objects and in response to receiving the set of one or more user inputs: in accordance with a determination that the input was directed to the first user interface object, emphasizing a first set of one or more objects in the plurality of objects, where the first set of one or more objects are the first object type; and in accordance with a determination that the input was directed to the second user interface object, emphasizing a second set of one or more objects in the plurality of objects, where the second set of one or more objects are the second object type.

In some embodiments, a computer system configured to communicate with a display generation component and one or more sensors is described. In some embodiments, the computer system includes one or more processors; and memory storing one or more programs configured to be executed by the one or more processors, the one or more programs including instructions for: detecting, via at least one sensor of the one or more sensors, a plurality of objects in a physical environment; displaying, via the display generation component, a representation of the physical environment including the plurality of objects; after displaying the representation of the physical environment including the plurality objects, displaying, via the display generation component, a plurality of user interface objects including: a first user interface object corresponding to a first object type; and a second user interface object corresponding to a second object type different from the first object type. The system also includes receiving, via at least one sensor of the one or more sensors, a set of one or more user inputs, the set of one or more user inputs including an input directed to the plurality of user interface objects; and while displaying the representation of the physical environment including the plurality of objects and in response to receiving the set of one or more user inputs: in accordance with a determination that the input was directed to the first user interface object, emphasizing a first set of one or more objects in the plurality of objects, where the first set of one or more objects are the first object type; and in accordance with a determination that the input was directed to the second user interface object, emphasizing a second set of one or more objects in the plurality of objects, where the second set of one or more objects are the second object type.

In some embodiments, a computer system configured to communicate with a display generation component and one or more sensors is described. In some embodiments, the computer system includes means for detecting, via at least one sensor of the one or more sensors, a plurality of objects in a physical environment; means for displaying, via the display generation component, a representation of the physical environment including the plurality of objects; means, after displaying the representation of the physical environment including the plurality objects, for displaying, via the display generation component, a plurality of user interface objects including: a first user interface object corresponding to a first object type; and a second user interface object corresponding to a second object type different from the first object type. The system also includes means for receiving, via at least one sensor of the one or more sensors, a set of one or more user inputs, the set of one or more user inputs including an input directed to the plurality of user interface objects; and means, while displaying the representation of the physical environment including the plurality of objects and in response to receiving the set of one or more user inputs, for: in accordance with a determination that the input was directed to the first user interface object, emphasizing a first set of one or more objects in the plurality of objects, where the first set of one or more objects are the first object type; and in accordance with a determination that the input was directed to the second user interface object, emphasizing a second set of one or more objects in the plurality of objects, where the second set of one or more objects are the second object type.

In some embodiments, a computer program product is described. In some embodiments, the computer program product includes: detecting, via at least one sensor of the one or more sensors, a plurality of objects in a physical environment; displaying, via the display generation component, a representation of the physical environment including the plurality of objects; after displaying the representation of the physical environment including the plurality objects, displaying, via the display generation component, a plurality of user interface objects including: a first user interface object corresponding to a first object type; and a second user interface object corresponding to a second object type different from the first object type. The product also includes receiving, via at least one sensor of the one or more sensors, a set of one or more user inputs, the set of one or more user inputs including an input directed to the plurality of user interface objects; and while displaying the representation of the physical environment including the plurality of objects and in response to receiving the set of one or more user inputs: in accordance with a determination that the input was directed to the first user interface object, emphasizing a first set of one or more objects in the plurality of objects, where the first set of one or more objects are the first object type; and in accordance with a determination that the input was directed to the second user interface object, emphasizing a second set of one or more objects in the plurality of objects, where the second set of one or more objects are the second object type.

Some techniques include a method at a computer system that is in communication with a display generation component and one or more sensors. The method includes detecting, via the one or more sensors, a gesture and in response to detecting the gesture: in accordance with a determination that a first set of one or more criteria is met, where the set of criteria includes a criterion that is met when a determination is made that the gesture is a particular type of gesture, causing a portion of the computer system to move in the physical environment; and in accordance with a determination that a second set of one or more criteria is met, forgoing causing the portion of the computer system to move in the physical environment, where the second set of one or more criteria is different from the first set of one or more criteria.

Some techniques include a non-transitory computer-readable storage medium storing one or more programs configured to be executed by one or more processors of a computer system that is in communication with a display generation component and one or more sensors. The non-transitory computer-readable storage medium storing one or more programs includes: detecting, via the one or more sensors, a gesture and in response to detecting the gesture: in accordance with a determination that a first set of one or more criteria is met, where the set of criteria includes a criterion that is met when a determination is made that the gesture is a particular type of gesture, causing a portion of the computer system to move in the physical environment; and in accordance with a determination that a second set of one or more criteria is met, forgoing causing the portion of the computer system to move in the physical environment, where the second set of one or more criteria is different from the first set of one or more criteria.

Some techniques include a transitory computer-readable storage medium storing one or more programs configured to be executed by one or more processors of a computer system that is in communication with a display generation component and one or more sensors. The transitory computer-readable storage medium storing one or more programs includes: detecting, via the one or more sensors, a gesture and in response to detecting the gesture: in accordance with a determination that a first set of one or more criteria is met, where the set of criteria includes a criterion that is met when a determination is made that the gesture is a particular type of gesture, causing a portion of the computer system to move in the physical environment; and in accordance with a determination that a second set of one or more criteria is met, forgoing causing the portion of the computer system to move in the physical environment, where the second set of one or more criteria is different from the first set of one or more criteria.

Some techniques include a computer system configured to communicate with a display generation component and one or more sensors. The computer system includes one or more processors. The computer system includes memory storing one or more programs configured to be executed by the one or more processors, the one or more programs including instructions for: detecting, via the one or more sensors, a gesture and in response to detecting the gesture: in accordance with a determination that a first set of one or more criteria is met, where the set of criteria includes a criterion that is met when a determination is made that the gesture is a particular type of gesture, causing a portion of the computer system to move in the physical environment; and in accordance with a determination that a second set of one or more criteria is met, forgoing causing the portion of the computer system to move in the physical environment, where the second set of one or more criteria is different from the first set of one or more criteria.

Some techniques include a computer system configured to communicate with a display generation component and one or more input devices. The computer system includes means for detecting, via the one or more sensors, a gesture; and in response to detecting the gesture: in accordance with a determination that a first set of one or more criteria is met, where the set of criteria includes a criterion that is met when a determination is made that the gesture is a particular type of gesture, means for causing a portion of the computer system to move in the physical environment; and in accordance with a determination that a second set of one or more criteria is met, means for forgoing causing the portion of the computer system to move in the physical environment, where the second set of one or more criteria is different from the first set of one or more criteria.

Some techniques include a computer program product configured to communicate with a display generation component and one or more input devices. The computer program product includes detecting, via the one or more sensors, a gesture and in response to detecting the gesture: in accordance with a determination that a first set of one or more criteria is met, where the set of criteria includes a criterion that is met when a determination is made that the gesture is a particular type of gesture, causing a portion of the computer system to move in the physical environment; and in accordance with a determination that a second set of one or more criteria is met, forgoing causing the portion of the computer system to move in the physical environment, where the second set of one or more criteria is different from the first set of one or more criteria.

Some techniques include a method at a computer system that is in communication with a display generation component and one or more sensors: while the computer system is at a first position in a physical environment, detecting, via the one or more sensors, a gesture; and in response to detecting the gesture: in accordance with a determination that a first set of one or more criteria is met, causing a portion of the computer system to move from the first position to a second position within the physical environment, where the second position is different from the first position, and where the first set of one or more criteria includes a criterion that is met when a determination is made that a first user is detected; and in accordance with a determination that a second set of one or more criteria is met, forgoing causing the portion of the computer system to move from the first position to the second position, where the second set of one or more criteria includes a criterion that is met when a determination is made that a second user is detected where the second user is different from the first user, and where the second set of one or more criteria is different from the first set of one or more criteria.

Some techniques include a non-transitory computer-readable storage medium storing one or more programs configured to be executed by one or more processors of a computer system that is in communication with a display generation component and one or more sensors. The non-transitory computer-readable storage medium storing one or more programs includes: while the computer system is at a first position in a physical environment, detecting, via the one or more sensors, a gesture; and in response to detecting the gesture: in accordance with a determination that a first set of one or more criteria is met, causing a portion of the computer system to move from the first position to a second position within the physical environment, where the second position is different from the first position, and where the first set of one or more criteria includes a criterion that is met when a determination is made that a first user is detected; and in accordance with a determination that a second set of one or more criteria is met, forgoing causing the portion of the computer system to move from the first position to the second position, where the second set of one or more criteria includes a criterion that is met when a determination is made that a second user is detected where the second user is different from the first user, and where the second set of one or more criteria is different from the first set of one or more criteria.

Some techniques include a transitory computer-readable storage medium storing one or more programs configured to be executed by one or more processors of a computer system that is in communication with a display generation component and one or more sensors. The non-transitory computer-readable storage medium storing one or more programs includes: while the computer system is at a first position in a physical environment, detecting, via the one or more sensors, a gesture; and in response to detecting the gesture: in accordance with a determination that a first set of one or more criteria is met, causing a portion of the computer system to move from the first position to a second position within the physical environment, where the second position is different from the first position, and where the first set of one or more criteria includes a criterion that is met when a determination is made that a first user is detected; and in accordance with a determination that a second set of one or more criteria is met, forgoing causing the portion of the computer system to move from the first position to the second position, where the second set of one or more criteria includes a criterion that is met when a determination is made that a second user is detected where the second user is different from the first user, and where the second set of one or more criteria is different from the first set of one or more criteria.

Some techniques include a computer system configured to communicate with a display generation component and one or more sensors. The computer system includes one or more processors. The system includes memory storing one or more programs configured to be executed by the one or more processors, the one or more programs including instructions for: while the computer system is at a first position in a physical environment, detecting, via the one or more sensors, a gesture; and in response to detecting the gesture: in accordance with a determination that a first set of one or more criteria is met, causing a portion of the computer system to move from the first position to a second position within the physical environment, where the second position is different from the first position, and where the first set of one or more criteria includes a criterion that is met when a determination is made that a first user is detected; and in accordance with a determination that a second set of one or more criteria is met, forgoing causing the portion of the computer system to move from the first position to the second position, where the second set of one or more criteria includes a criterion that is met when a determination is made that a second user is detected where the second user is different from the first user, and where the second set of one or more criteria is different from the first set of one or more criteria.

Some techniques include a computer system configured to communicate with a display generation component and one or more input devices. The computer system includes while the computer system is at a first position in a physical environment, means for detecting, via the one or more sensors, a gesture; and in response to detecting the gesture: in accordance with a determination that a first set of one or more criteria is met, means for causing a portion of the computer system to move from the first position to a second position within the physical environment, where the second position is different from the first position, and where the first set of one or more criteria includes a criterion that is met when a determination is made that a first user is detected; and in accordance with a determination that a second set of one or more criteria is met, means for forgoing causing the portion of the computer system to move from the first position to the second position, where the second set of one or more criteria includes a criterion that is met when a determination is made that a second user is detected where the second user is different from the first user, and where the second set of one or more criteria is different from the first set of one or more criteria.

Some techniques include a computer program product configured to communicate with a display generation component and one or more sensors. The computer program product includes while the computer system is at a first position in a physical environment, detecting, via the one or more sensors, a gesture; and in response to detecting the gesture: in accordance with a determination that a first set of one or more criteria is met, causing a portion of the computer system to move from the first position to a second position within the physical environment, where the second position is different from the first position, and where the first set of one or more criteria includes a criterion that is met when a determination is made that a first user is detected; and in accordance with a determination that a second set of one or more criteria is met, forgoing causing the portion of the computer system to move from the first position to the second position, where the second set of one or more criteria includes a criterion that is met when a determination is made that a second user is detected where the second user is different from the first user, and where the second set of one or more criteria is different from the first set of one or more criteria.

In some embodiments, a method is performed at a computer system that is in communication with a display generation component and one or more sensor components. In some embodiments, the method comprises: while navigating to a destination, displaying, via the display generation component, a first user interface that includes a representation of a physical environment; while at the destination, displaying, via the display generation component, a plurality of user interface objects, including: a first user interface object to navigate to a predefined location for the destination; and a second user interface object to navigate to a non-predefined location, where the non-predefined location is determined based on a current state of the physical environment. The method also includes receiving, via at least one sensor component of the one or more sensor components, a set of one or more user inputs, the set of one or more user inputs including a first input directed to the plurality of user interface objects; and while displaying the representation of the physical environment and in response to receiving the set of one or more user inputs: in accordance with a determination that the first input was directed to the first user interface object, displaying, via the display generation component, a path to the predefined location; and in accordance with a determination that the first input was directed to the second user interface object, displaying, via the display generation component, a path to the non-predefined location.

In some embodiments, a non-transitory computer-readable storage medium storing one or more programs configured to be executed by one or more processors of a computer system that is in communication with a display generation component and one or more sensor components. In some embodiments, the one or more programs include includes while navigating to a destination, displaying, via the display generation component, a first user interface that includes a representation of a physical environment; while at the destination, displaying, via the display generation component, a plurality of user interface objects, including: a first user interface object to navigate to a predefined location for the destination; and a second user interface object to navigate to a non-predefined location, where the non-predefined location is determined based on a current state of the physical environment. The programs also includes receiving, via at least one sensor component of the one or more sensor components, a set of one or more user inputs, the set of one or more user inputs including a first input directed to the plurality of user interface objects; and while displaying the representation of the physical environment and in response to receiving the set of one or more user inputs: in accordance with a determination that the first input was directed to the first user interface object, displaying, via the display generation component, a path to the predefined location; and in accordance with a determination that the first input was directed to the second user interface object, displaying, via the display generation component, a path to the non-predefined location.

In some embodiments, a transitory computer-readable storage medium storing one or more programs configured to be executed by one or more processors of a computer system that is in communication with a display generation component and one or more sensor components. In some embodiments, the one or more programs include includes while navigating to a destination, displaying, via the display generation component, a first user interface that includes a representation of a physical environment; while at the destination, displaying, via the display generation component, a plurality of user interface objects, including: a first user interface object to navigate to a predefined location for the destination; and a second user interface object to navigate to a non-predefined location, where the non-predefined location is determined based on a current state of the physical environment. The programs also includes receiving, via at least one sensor component of the one or more sensor components, a set of one or more user inputs, the set of one or more user inputs including a first input directed to the plurality of user interface objects; and while displaying the representation of the physical environment and in response to receiving the set of one or more user inputs: in accordance with a determination that the first input was directed to the first user interface object, displaying, via the display generation component, a path to the predefined location; and in accordance with a determination that the first input was directed to the second user interface object, displaying, via the display generation component, a path to the non-predefined location.

In some embodiments, a computer system configured to communicate with a display generation component and one or more sensor components is described. In some embodiments, the computer system includes one or more processors; and memory storing one or more programs configured to be executed by the one or more processors, the one or more programs including instructions for: while navigating to a destination, displaying, via the display generation component, a first user interface that includes a representation of a physical environment; while at the destination, displaying, via the display generation component, a plurality of user interface objects, including: a first user interface object to navigate to a predefined location for the destination; and a second user interface object to navigate to a non-predefined location, where the non-predefined location is determined based on a current state of the physical environment. The system also includes receiving, via at least one sensor component of the one or more sensor components, a set of one or more user inputs, the set of one or more user inputs including a first input directed to the plurality of user interface objects; and while displaying the representation of the physical environment and in response to receiving the set of one or more user inputs: in accordance with a determination that the first input was directed to the first user interface object, displaying, via the display generation component, a path to the predefined location; and in accordance with a determination that the first input was directed to the second user interface object, displaying, via the display generation component, a path to the non-predefined location.

In some embodiments, a computer system configured to communicate with a display generation component and one or more sensor components is described. In some embodiments, computer system includes means, while navigating to a destination, displaying, via the display generation component, for a first user interface that includes a representation of a physical environment; means, while at the destination, displaying, via the display generation component, a plurality of user interface objects, for including: a first user interface object to navigate to a predefined location for the destination; and a second user interface object to navigate to a non-predefined location, where the non-predefined location is determined based on a current state of the physical environment. The system also includes means for receiving, via at least one sensor component of the one or more sensor components, a set of one or more user inputs, the set of one or more user inputs including a first input directed to the plurality of user interface objects; and means, while displaying the representation of the physical environment and in response to receiving the set of one or more user inputs, for: in accordance with a determination that the first input was directed to the first user interface object, displaying, via the display generation component, a path to the predefined location; and in accordance with a determination that the first input was directed to the second user interface object, displaying, via the display generation component, a path to the non-predefined location. Other embodiments of this aspect include corresponding computer systems, apparatus, and computer programs recorded on one or more computer storage devices, each configured to perform the actions of the methods.

In some embodiments, a computer program product configured to communicate with a display generation component and one or more sensor components is described. In some embodiments, the computer program product includes: while navigating to a destination, displaying, via the display generation component, a first user interface that includes a representation of a physical environment; while at the destination, displaying, via the display generation component, a plurality of user interface objects, including: a first user interface object to navigate to a predefined location for the destination; and a second user interface object to navigate to a non-predefined location, where the non-predefined location is determined based on a current state of the physical environment. The product also includes receiving, via at least one sensor component of the one or more sensor components, a set of one or more user inputs, the set of one or more user inputs including a first input directed to the plurality of user interface objects; and while displaying the representation of the physical environment and in response to receiving the set of one or more user inputs: in accordance with a determination that the first input was directed to the first user interface object, displaying, via the display generation component, a path to the predefined location; and in accordance with a determination that the first input was directed to the second user interface object, displaying, via the display generation component, a path to the non-predefined location.

In some embodiments, a method is performed at a computer system that is in communication with a display generation component and one or more sensor components is described. In some embodiments, the method comprises: while navigating to a destination, displaying, via the display generation component, a representation of a physical environment; while displaying the representation, detecting, via at least one sensor component of the one or more sensor components, an input corresponding to the representation; and in response to detecting the input: in accordance with a determination that a first set of one or more criteria are met, changing a lateral position within the navigation from a first predefined lateral area to a second predefined lateral area; and in accordance with a determination that a second set of one or more criteria are met, where the second set of one or more criteria includes a criterion that is met when a determination is made that the first set of one or more criteria are not met, forgoing change of the lateral position within the navigation.

In some embodiments, a non-transitory computer-readable storage medium storing one or more programs configured to be executed by one or more processors of a computer system that is in communication with a display generation component and one or more sensor components is described. In some embodiments, one or more programs includes: while navigating to a destination, displaying, via the display generation component, a representation of a physical environment; while displaying the representation, detecting, via at least one sensor component of the one or more sensor components, an input corresponding to the representation; and in response to detecting the input: in accordance with a determination that a first set of one or more criteria are met, changing a lateral position within the navigation from a first predefined lateral area to a second predefined lateral area; and in accordance with a determination that a second set of one or more criteria are met, where the second set of one or more criteria includes a criterion that is met when a determination is made that the first set of one or more criteria are not met, forgoing change of the lateral position within the navigation.

In some embodiments, transitory computer-readable storage medium storing one or more programs configured to be executed by one or more processors of a computer system that is in communication with a display generation component and one or more sensor components is described. In some embodiments, one or more programs includes: while navigating to a destination, displaying, via the display generation component, a representation of a physical environment; while displaying the representation, detecting, via at least one sensor component of the one or more sensor components, an input corresponding to the representation; and in response to detecting the input: in accordance with a determination that a first set of one or more criteria are met, changing a lateral position within the navigation from a first predefined lateral area to a second predefined lateral area; and in accordance with a determination that a second set of one or more criteria are met, where the second set of one or more criteria includes a criterion that is met when a determination is made that the first set of one or more criteria are not met, forgoing change of the lateral position within the navigation.

In some embodiments, a computer system configured to communicate with a display generation component and one or more sensor components is described. In some embodiments, the computer system includes one or more processors; and memory storing one or more programs configured to be executed by the one or more processors, the one or more programs including instructions for: while navigating to a destination, displaying, via the display generation component, a representation of a physical environment; while displaying the representation, detecting, via at least one sensor component of the one or more sensor components, an input corresponding to the representation; and in response to detecting the input: in accordance with a determination that a first set of one or more criteria are met, changing a lateral position within the navigation from a first predefined lateral area to a second predefined lateral area; and in accordance with a determination that a second set of one or more criteria are met, where the second set of one or more criteria includes a criterion that is met when a determination is made that the first set of one or more criteria are not met, forgoing change of the lateral position within the navigation.

In some embodiments, a computer system configured to communicate with a display generation component and one or more sensor components is described. In some embodiments, the computer system includes means, while navigating to a destination, for displaying, via the display generation component, a representation of a physical environment; means, while displaying the representation, for detecting, via at least one sensor component of the one or more sensor components, an input corresponding to the representation; and means, responsive to detecting the input, for: in accordance with a determination that a first set of one or more criteria are met, changing a lateral position within the navigation from a first predefined lateral area to a second predefined lateral area; and in accordance with a determination that a second set of one or more criteria are met, where the second set of one or more criteria includes a criterion that is met when a determination is made that the first set of one or more criteria are not met, forgoing change of the lateral position within the navigation.

In some embodiments, a computer program product configured to communicate with a display generation component and one or more sensor components is described. In some embodiments, the computer program product includes: while navigating to a destination, displaying, via the display generation component, a representation of a physical environment; while displaying the representation, detecting, via at least one sensor component of the one or more sensor components, an input corresponding to the representation; and in response to detecting the input: in accordance with a determination that a first set of one or more criteria are met, changing a lateral position within the navigation from a first predefined lateral area to a second predefined lateral area; and in accordance with a determination that a second set of one or more criteria are met, where the second set of one or more criteria includes a criterion that is met when a determination is made that the first set of one or more criteria are not met, forgoing change of the lateral position within the navigation.

Some techniques include a method at a computer system that is in communication with a first set of one or more devices and a second set of one or more devices that is different from the first set of one or more devices. The method includes: detecting a request to navigate to a destination that includes a plurality of locations; in response to detecting the request, navigating to the destination; in conjunction with arriving at the destination, navigating to a first location of the plurality of locations; in conjunction with navigating to the first location, activating, automatically and without intervening user input, the first set of one or more devices without activating the second set of one or more devices; after navigating to the first location, navigating to a second location of the plurality of locations, where the second location is different from the first location; and in conjunction with navigating to the second location, activating, automatically and without intervening user input, the second set of one or more devices without activating the first set of one or more devices.

Some techniques include a non-transitory computer-readable storage medium storing one or more programs configured to be executed by one or more processors of a computer system that is in communication with a first set of one or more devices and a second set of one or more devices that is different from the first set of one or more devices. The non-transitory computer-readable storage medium includes one or more programs for: detecting a request to navigate to a destination that includes a plurality of locations; in response to detecting the request, navigating to the destination; in conjunction with arriving at the destination, navigating to a first location of the plurality of locations; in conjunction with navigating to the first location, activating, automatically and without intervening user input, the first set of one or more devices without activating the second set of one or more devices; after navigating to the first location, navigating to a second location of the plurality of locations, where the second location is different from the first location; and in conjunction with navigating to the second location, activating, automatically and without intervening user input, the second set of one or more devices without activating the first set of one or more devices.

Some techniques include a transitory computer-readable storage medium storing one or more programs configured to be executed by one or more processors of a computer system that is in communication with a first set of one or more devices and a second set of one or more devices that is different from the first set of one or more devices. The transitory computer-readable storage medium includes one or more programs for: detecting a request to navigate to a destination that includes a plurality of locations; in response to detecting the request, navigating to the destination; in conjunction with arriving at the destination, navigating to a first location of the plurality of locations; in conjunction with navigating to the first location, activating, automatically and without intervening user input, the first set of one or more devices without activating the second set of one or more devices; after navigating to the first location, navigating to a second location of the plurality of locations, where the second location is different from the first location; and in conjunction with navigating to the second location, activating, automatically and without intervening user input, the second set of one or more devices without activating the first set of one or more devices.

Some techniques include a computer system configured to communicate with a first set of one or more devices and a second set of one or more devices that is different from the first set of one or more devices. The computer system includes one or more processors. The system includes memory storing one or more programs configured to be executed by the one or more processors, the one or more programs including instructions for: detecting a request to navigate to a destination that includes a plurality of locations; in response to detecting the request, navigating to the destination; in conjunction with arriving at the destination, navigating to a first location of the plurality of locations; in conjunction with navigating to the first location, activating, automatically and without intervening user input, the first set of one or more devices without activating the second set of one or more devices; after navigating to the first location, navigating to a second location of the plurality of locations, where the second location is different from the first location; and in conjunction with navigating to the second location, activating, automatically and without intervening user input, the second set of one or more devices without activating the first set of one or more devices.

Some techniques include a computer system configured to communicate with a first set of one or more devices and a second set of one or more devices that is different from the first set of one or more devices. The computer system includes means for detecting a request to navigate to a destination that includes a plurality of locations; in response to detecting the request, means for navigating to the destination; in conjunction with arriving at the destination, means for navigating to a first location of the plurality of locations; in conjunction with navigating to the first location, means for activating, automatically and without intervening user input, the first set of one or more devices without activating the second set of one or more devices; after navigating to the first location, means for navigating to a second location of the plurality of locations, where the second location is different from the first location; and in conjunction with navigating to the second location, means for activating, automatically and without intervening user input, the second set of one or more devices without activating the first set of one or more devices.

Some techniques include a computer program product. The computer program product includes software for: detecting a request to navigate to a destination that includes a plurality of locations; in response to detecting the request, navigating to the destination; in conjunction with arriving at the destination, navigating to a first location of the plurality of locations; in conjunction with navigating to the first location, activating, automatically and without intervening user input, the first set of one or more devices without activating the second set of one or more devices; after navigating to the first location, navigating to a second location of the plurality of locations, where the second location is different from the first location; and in conjunction with navigating to the second location, activating, automatically and without intervening user input, the second set of one or more devices without activating the first set of one or more devices.

Some techniques include a method at a computer system that is in communication with a first set of one or more devices and a second set of one or more devices that is different from the first set of one or more devices, the method including: navigating to a destination, where the destination includes a plurality of predefined activities and a plurality of predefined locations; while navigating to the destination, displaying a plurality of user interface objects, including: a first user interface object corresponding to a first predefined activity of the plurality of predefined activities; and a second user interface object corresponding to a second predefined activity of the plurality of predefined activities, where the second user interface object is different from the first user interface object, and where the second predefined activity is different from the first predefined activity. The method also includes receiving a set of one or more user inputs that includes a respective input that is directed to the plurality of user interface objects; and in response to receiving the set of one or more user inputs: in accordance with a determination that the respective input was directed to the first user interface object: navigating to a first predefined location of the plurality of predefined locations, where the first predefined location corresponds to the first predefined activity; and in conjunction with being at the first predefined location, activating the first set of one or more devices. The method also includes in accordance with a determination that the respective input was directed to the second user interface object: navigating to a second predefined location of the plurality of predefined locations, where the second predefined location corresponds to the second predefined activity, and where the second predefined location is different from the first predefined location; and in conjunction with being at the second predefined location, activating the second set of one or more devices.

Some techniques include a non-transitory computer-readable storage medium storing one or more programs configured to be executed by one or more processors of a computer system that is in communication with a first set of one or more devices and a second set of one or more devices that is different from the first set of one or more devices. The non-transitory computer-readable storage medium storing one or more programs includes: navigating to a destination, where the destination includes a plurality of predefined activities and a plurality of predefined locations; while navigating to the destination, displaying a plurality of user interface objects, including: a first user interface object corresponding to a first predefined activity of the plurality of predefined activities; and a second user interface object corresponding to a second predefined activity of the plurality of predefined activities, where the second user interface object is different from the first user interface object, and where the second predefined activity is different from the first predefined activity. The programs also includes receiving a set of one or more user inputs that includes a respective input that is directed to the plurality of user interface objects; and in response to receiving the set of one or more user inputs: in accordance with a determination that the respective input was directed to the first user interface object: navigating to a first predefined location of the plurality of predefined locations, where the first predefined location corresponds to the first predefined activity; and in conjunction with being at the first predefined location, activating the first set of one or more devices. The programs also includes in accordance with a determination that the respective input was directed to the second user interface object: navigating to a second predefined location of the plurality of predefined locations, where the second predefined location corresponds to the second predefined activity, and where the second predefined location is different from the first predefined location; and in conjunction with being at the second predefined location, activating the second set of one or more devices.

Some techniques include a transitory computer-readable storage medium storing one or more programs configured to be executed by one or more processors of a computer system that is in communication with a first set of one or more devices and a second set of one or more devices that is different from the first set of one or more devices. The transitory computer-readable storage medium storing one or more programs includes: navigating to a destination, where the destination includes a plurality of predefined activities and a plurality of predefined locations; while navigating to the destination, displaying a plurality of user interface objects, including: a first user interface object corresponding to a first predefined activity of the plurality of predefined activities; and a second user interface object corresponding to a second predefined activity of the plurality of predefined activities, where the second user interface object is different from the first user interface object, and where the second predefined activity is different from the first predefined activity. The programs also includes receiving a set of one or more user inputs that includes a respective input that is directed to the plurality of user interface objects; and in response to receiving the set of one or more user inputs: in accordance with a determination that the respective input was directed to the first user interface object: navigating to a first predefined location of the plurality of predefined locations, where the first predefined location corresponds to the first predefined activity; and in conjunction with being at the first predefined location, activating the first set of one or more devices. The programs also includes in accordance with a determination that the respective input was directed to the second user interface object: navigating to a second predefined location of the plurality of predefined locations, where the second predefined location corresponds to the second predefined activity, and where the second predefined location is different from the first predefined location; and in conjunction with being at the second predefined location, activating the second set of one or more devices.

Some techniques include a computer system configured to communicate with a first set of one or more devices and a second set of one or more devices that is different from the first set of one or more devices. The computer system also includes one or more processors. The system also includes memory storing one or more programs configured to be executed by the one or more processors, the one or more programs including instructions for: navigating to a destination, where the destination includes a plurality of predefined activities and a plurality of predefined locations; while navigating to the destination, displaying a plurality of user interface objects, including: a first user interface object corresponding to a first predefined activity of the plurality of predefined activities; and a second user interface object corresponding to a second predefined activity of the plurality of predefined activities, where the second user interface object is different from the first user interface object, and where the second predefined activity is different from the first predefined activity. The system also includes receiving a set of one or more user inputs that includes a respective input that is directed to the plurality of user interface objects; and in response to receiving the set of one or more user inputs: in accordance with a determination that the respective input was directed to the first user interface object: navigating to a first predefined location of the plurality of predefined locations, where the first predefined location corresponds to the first predefined activity; and in conjunction with being at the first predefined location, activating the first set of one or more devices. The system also includes in accordance with a determination that the respective input was directed to the second user interface object: navigating to a second predefined location of the plurality of predefined locations, where the second predefined location corresponds to the second predefined activity, and where the second predefined location is different from the first predefined location; and in conjunction with being at the second predefined location, activating the second set of one or more devices.

Some techniques include a computer system configured to communicate with a first set of one or more devices and a second set of one or more devices that is different from the first set of one or more devices. The computer system also includes means for navigating to a destination, where the destination includes a plurality of predefined activities and a plurality of predefined locations; while navigating to the destination, means for displaying a plurality of user interface objects, including: a first user interface object corresponding to a first predefined activity of the plurality of predefined activities; and a second user interface object corresponding to a second predefined activity of the plurality of predefined activities, where the second user interface object is different from the first user interface object, and where the second predefined activity is different from the first predefined activity. The system also includes means for receiving a set of one or more user inputs that includes a respective input that is directed to the plurality of user interface objects; and in response to receiving the set of one or more user inputs: in accordance with a determination that the respective input was directed to the first user interface object: means for navigating to a first predefined location of the plurality of predefined locations, where the first predefined location corresponds to the first predefined activity; and in conjunction with being at the first predefined location, means for activating the first set of one or more devices. The system also includes in accordance with a determination that the respective input was directed to the second user interface object: means for navigating to a second predefined location of the plurality of predefined locations, where the second predefined location corresponds to the second predefined activity, and where the second predefined location is different from the first predefined location; and in conjunction with being at the second predefined location, means for activating the second set of one or more devices.

Some techniques include a computer program product. The computer program product includes instructions for: navigating to a destination, where the destination includes a plurality of predefined activities and a plurality of predefined locations; while navigating to the destination, displaying a plurality of user interface objects, including: a first user interface object corresponding to a first predefined activity of the plurality of predefined activities; and a second user interface object corresponding to a second predefined activity of the plurality of predefined activities, where the second user interface object is different from the first user interface object, and where the second predefined activity is different from the first predefined activity. The product also includes receiving a set of one or more user inputs that includes a respective input that is directed to the plurality of user interface objects; and in response to receiving the set of one or more user inputs: in accordance with a determination that the respective input was directed to the first user interface object: navigating to a first predefined location of the plurality of predefined locations, where the first predefined location corresponds to the first predefined activity; and in conjunction with being at the first predefined location, activating the first set of one or more devices. The product also includes in accordance with a determination that the respective input was directed to the second user interface object: navigating to a second predefined location of the plurality of predefined locations, where the second predefined location corresponds to the second predefined activity, and where the second predefined location is different from the first predefined location; and in conjunction with being at the second predefined location, activating the second set of one or more devices.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for navigating to objects, thereby increasing the effectiveness, efficiency, and user satisfaction with such devices. Such methods and interfaces may complement or replace other methods for navigating to objects.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6L illustrate exemplary user interfaces for navigating in a physical environment using a computer system in accordance with some embodiments.

FIG. 7 is a flow diagram illustrating a method for displaying a path to an object using a computer system in accordance with some embodiments.

FIG. 8 is a flow diagram illustrating a method for emphasizing an object using a computer system in accordance with some embodiments.

FIG. 9 is a flow diagram illustrating a method for emphasizing a type of object using a computer system in accordance with some embodiments.

FIGS. 10A-10C illustrate exemplary user interfaces for manipulating a physical input mechanism using a computer system in accordance with some embodiments.

FIG. 11 is a flow diagram illustrating a method for gesture-based repositioning using a computer system in accordance with some embodiments.

FIG. 12 is a flow diagram illustrating a method for identity-based repositioning using a computer system in accordance with some embodiments.

FIGS. 13A-13G illustrate exemplary user interfaces for navigating in a physical environment using a computer system in accordance with some embodiments.

FIG. 14 is a flow diagram illustrating a method for changing a destination using a computer system in accordance with some embodiments.

FIG. 15 is a flow diagram illustrating a method for modifying navigation to a destination using a computer system in accordance with some embodiments.

FIGS. 16A-16E illustrate exemplary user interfaces for navigating to a destination using a computer system in accordance with some embodiments.

FIG. 17 is a flow diagram illustrating a method for navigating in a physical environment using a computer system in accordance with some embodiments.

FIG. 18 is a flow diagram illustrating a method for displaying different predefined activities for a destination using a computer system in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for navigating. Some techniques display paths to objects detected via sensors. Other techniques emphasize certain objects detected via sensors. Other techniques emphasize objects of a certain type detected via sensors. Other techniques reposition a physical component. Other techniques display different controls for navigating to different locations at a destination. Other techniques allow a user to modify a navigation to a destination. Other techniques activate different sensors at different locations of a destination. Other techniques display different predefined activities for a destination to navigate to respective locations of the destination. Such techniques can reduce the cognitive burden on a user navigating, thereby enhancing productivity. Further, such techniques can reduce processor and battery power otherwise wasted on redundant user inputs.

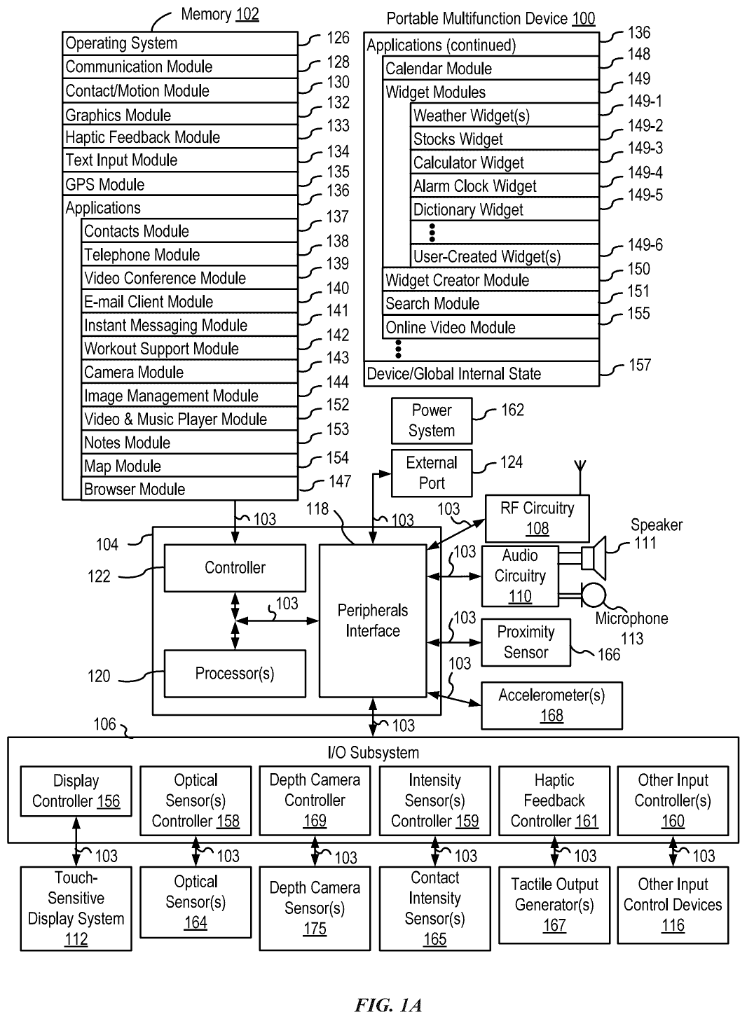

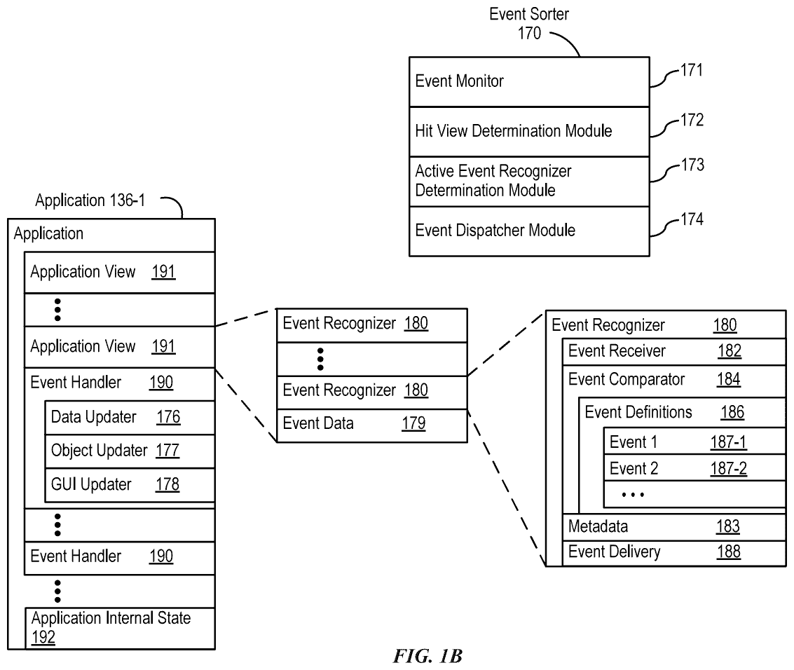

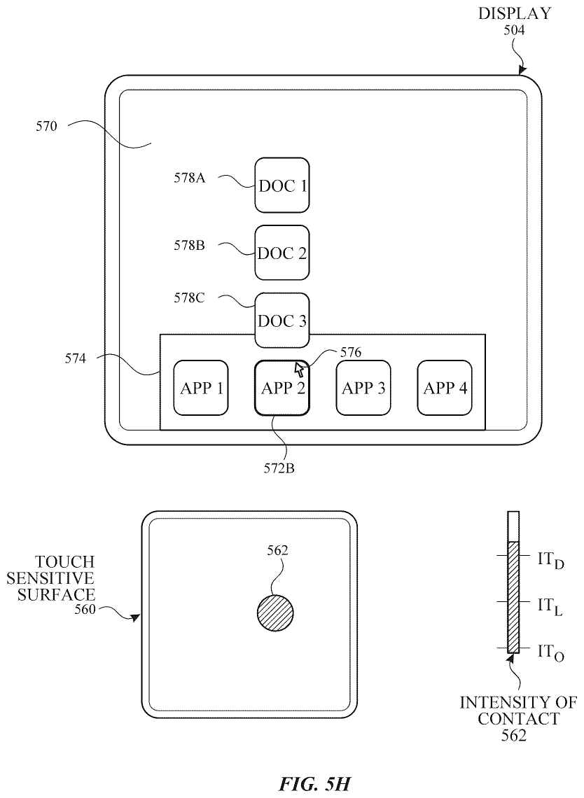

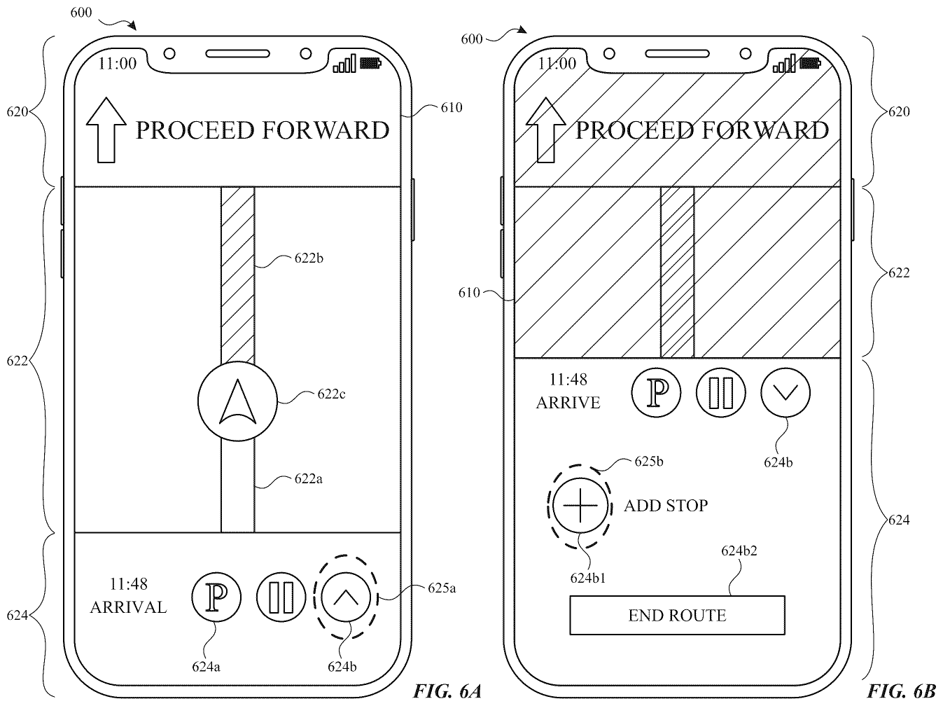

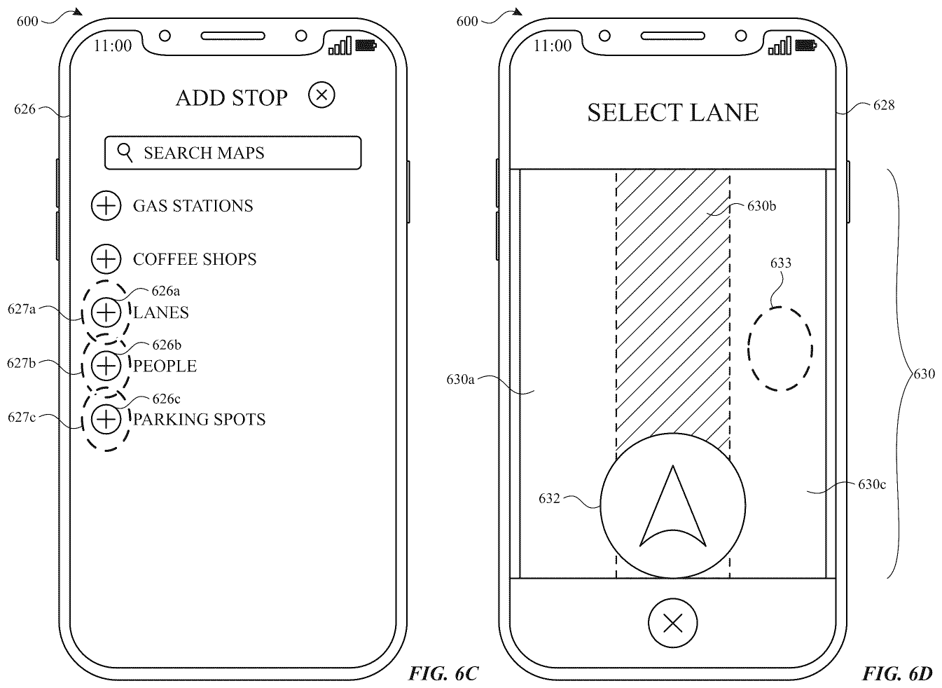

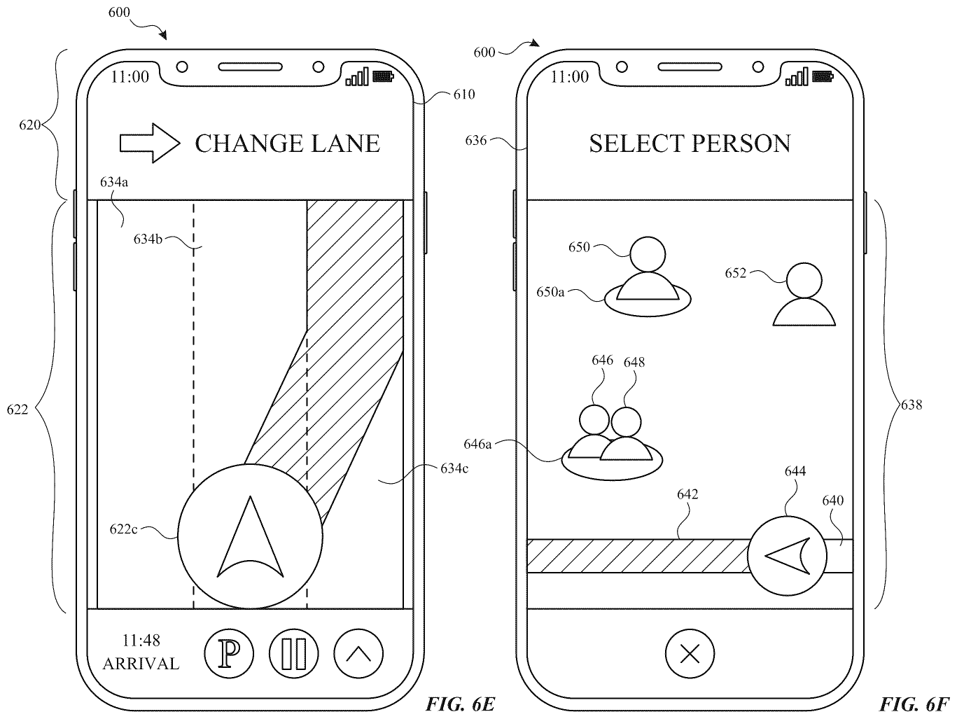

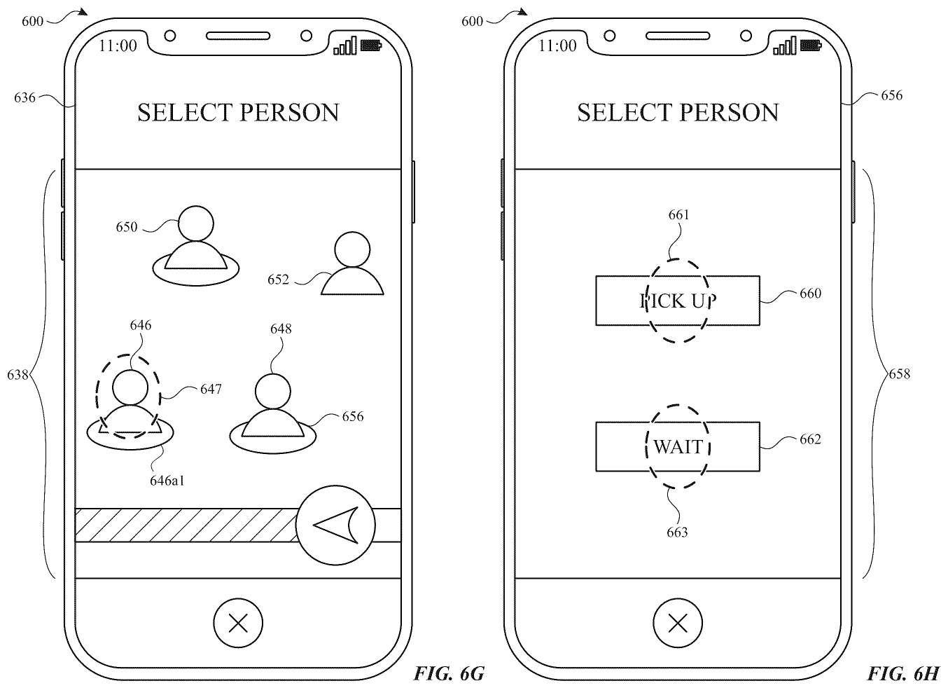

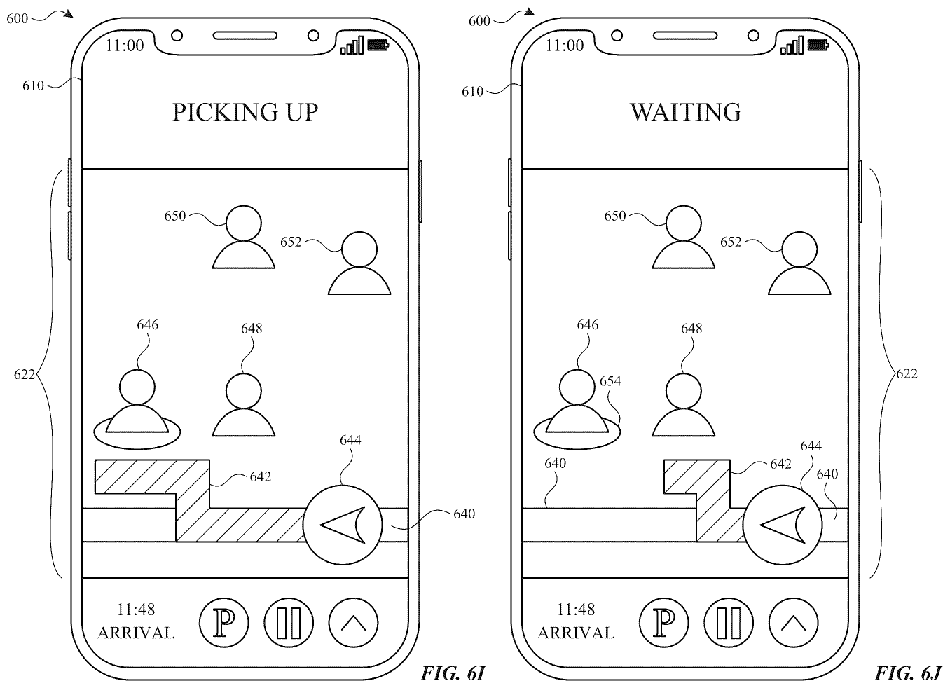

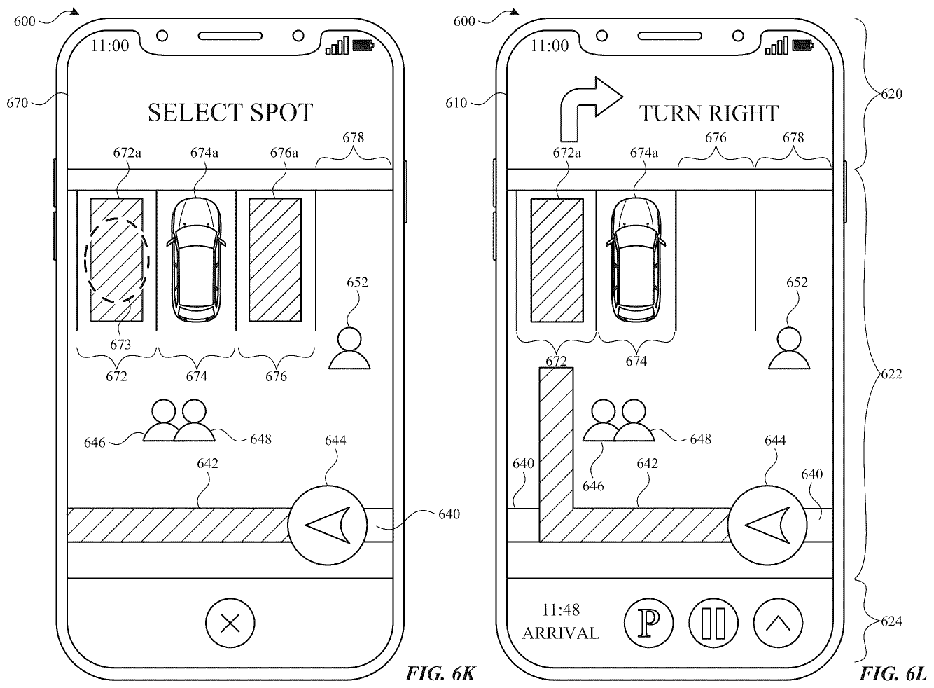

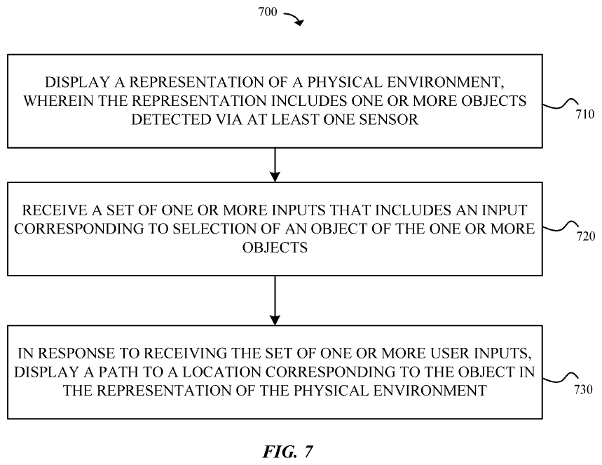

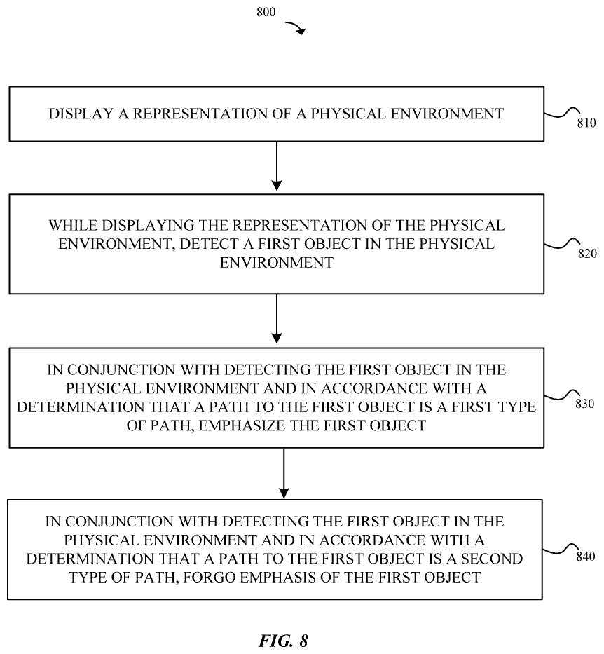

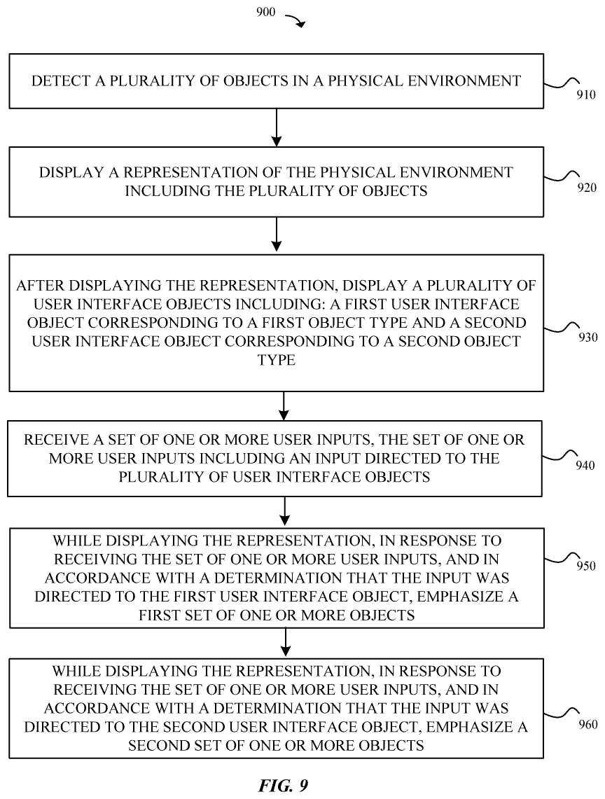

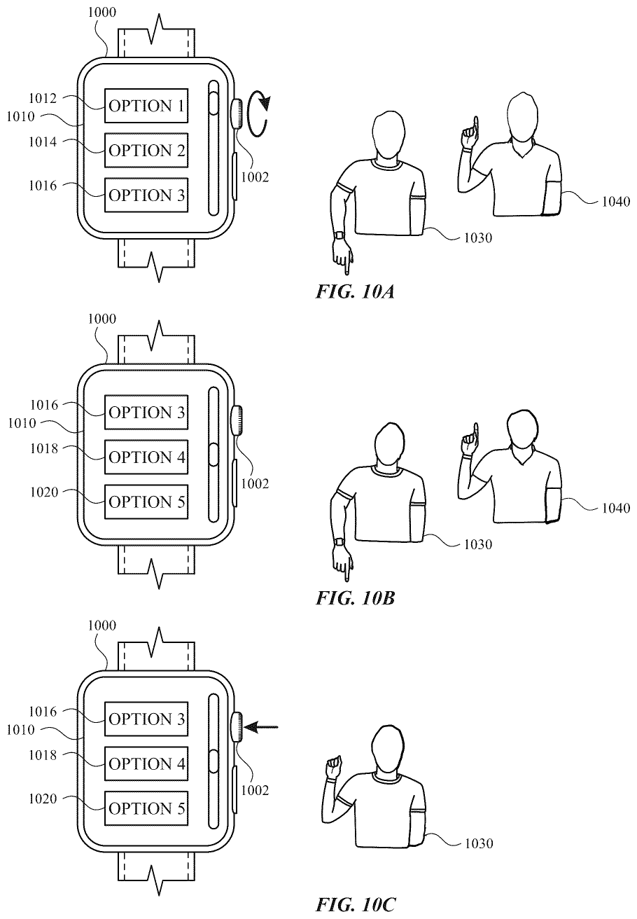

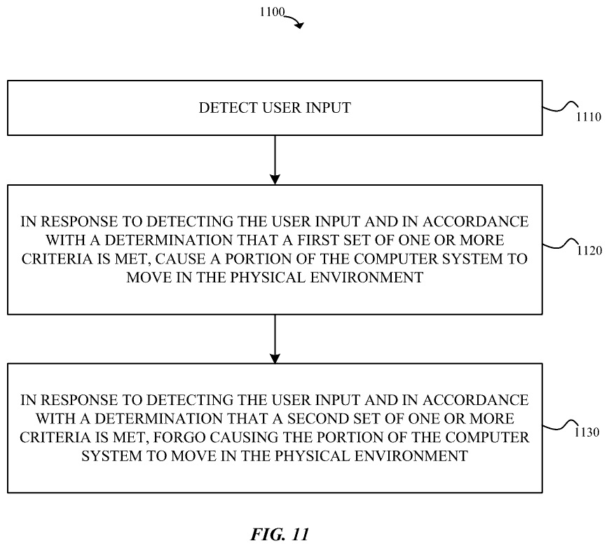

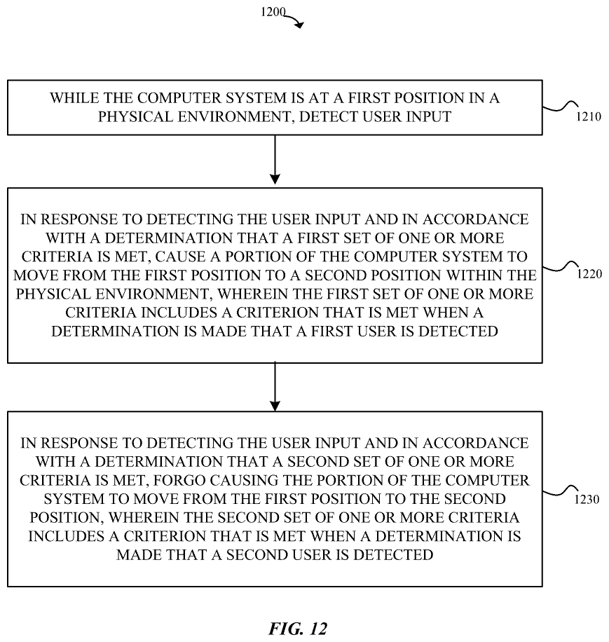

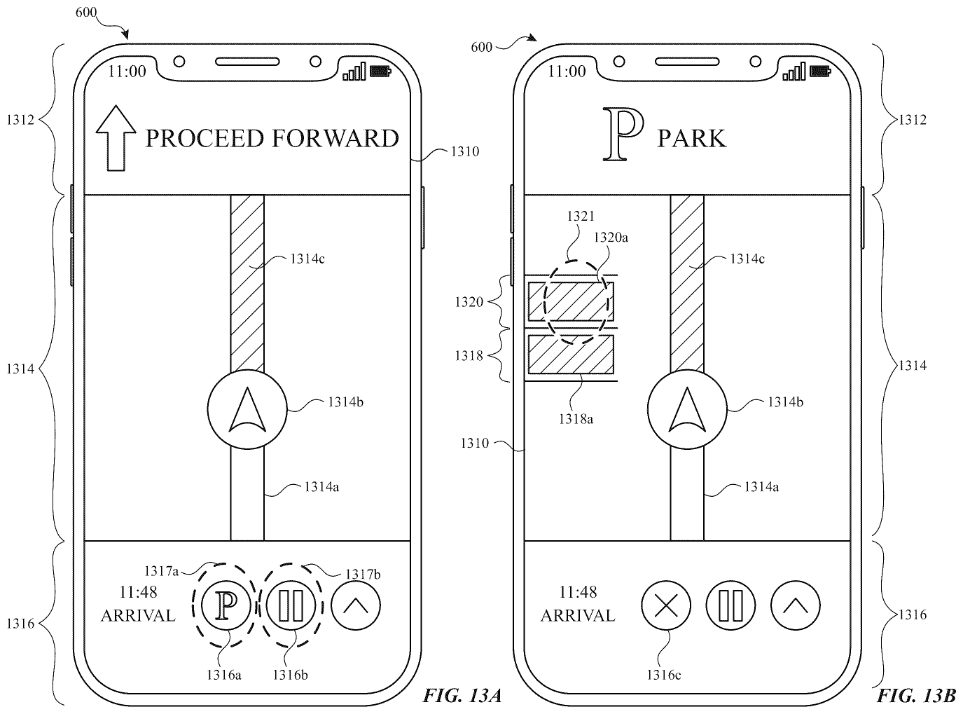

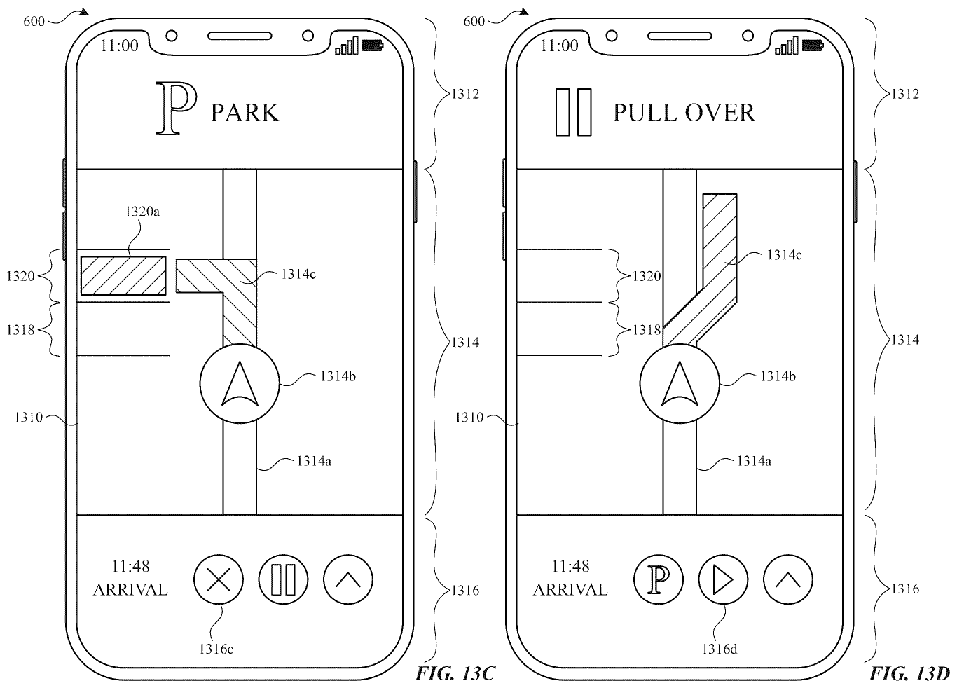

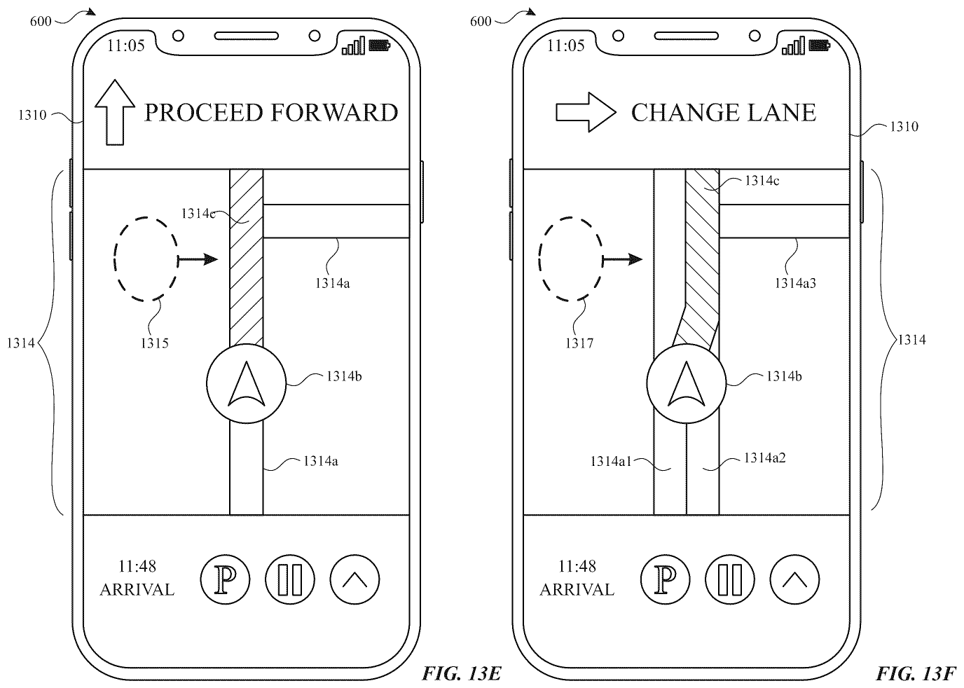

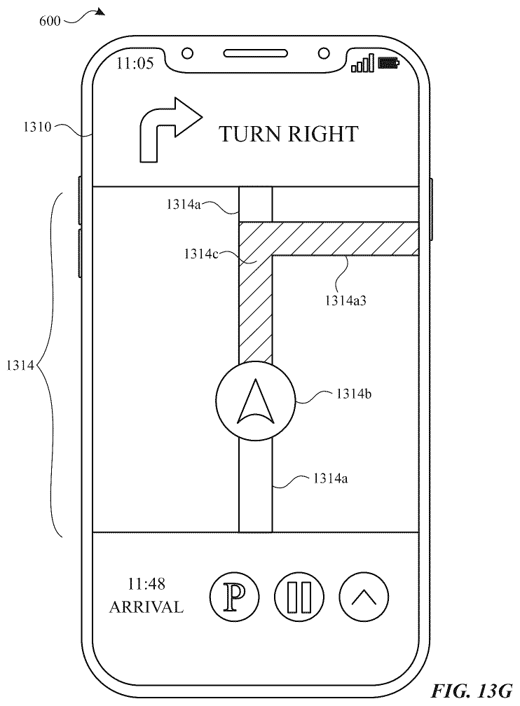

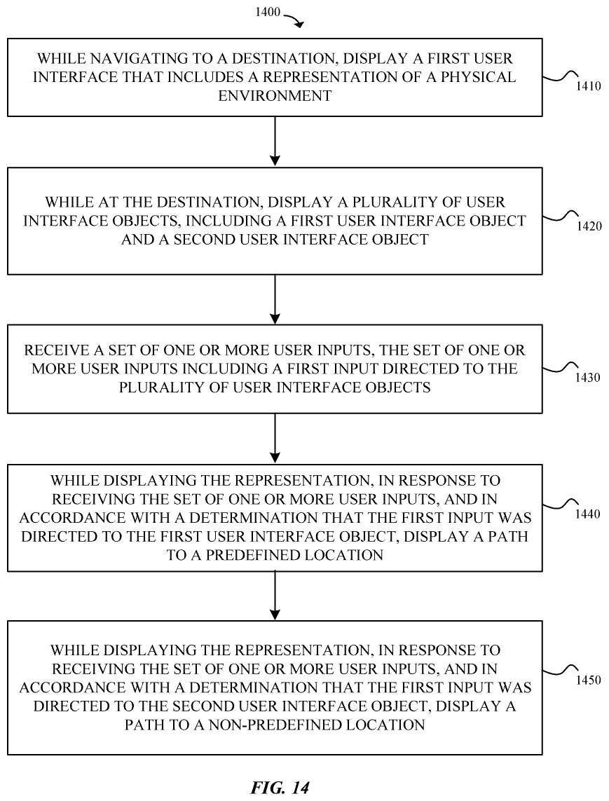

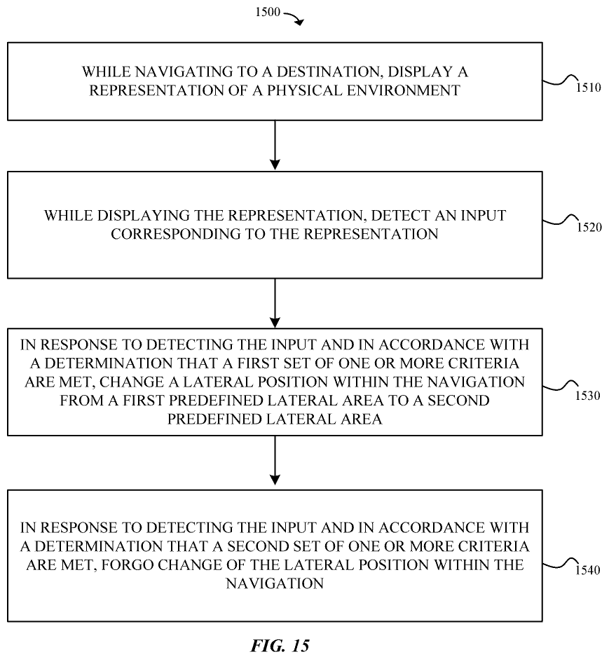

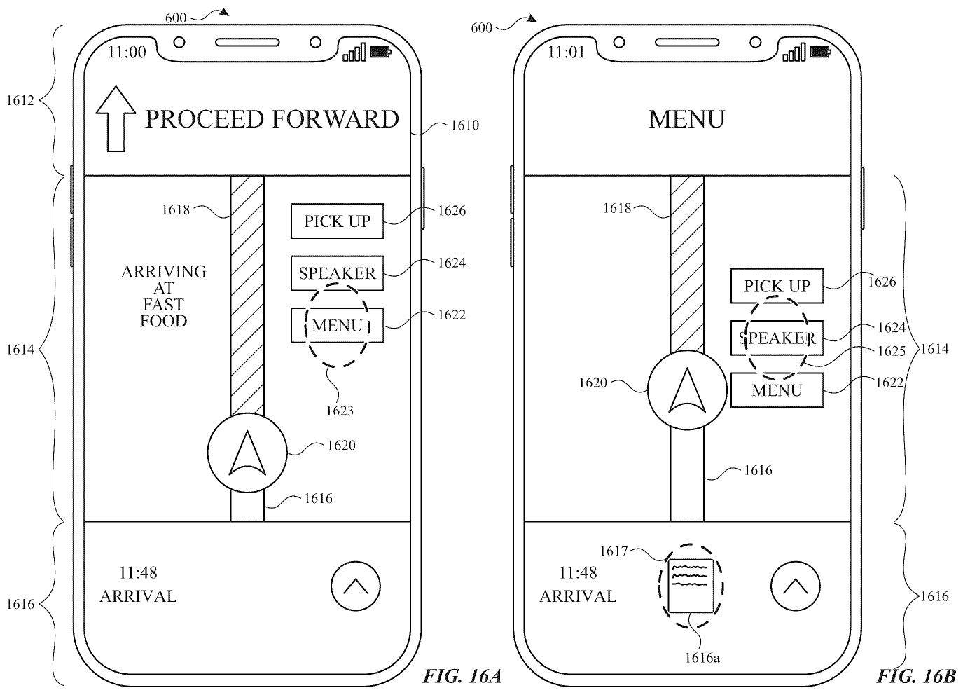

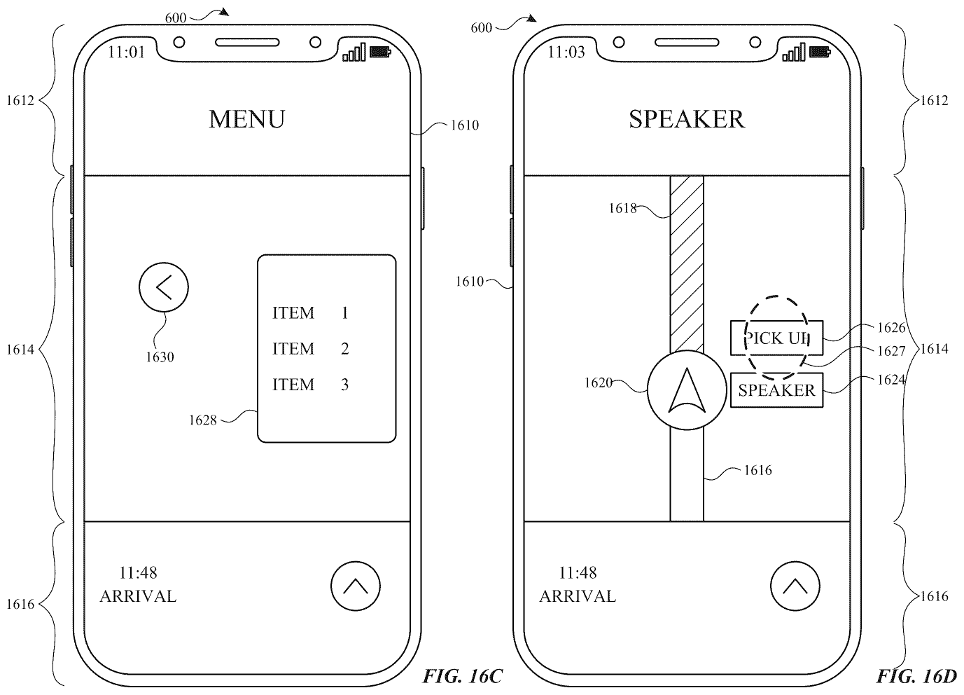

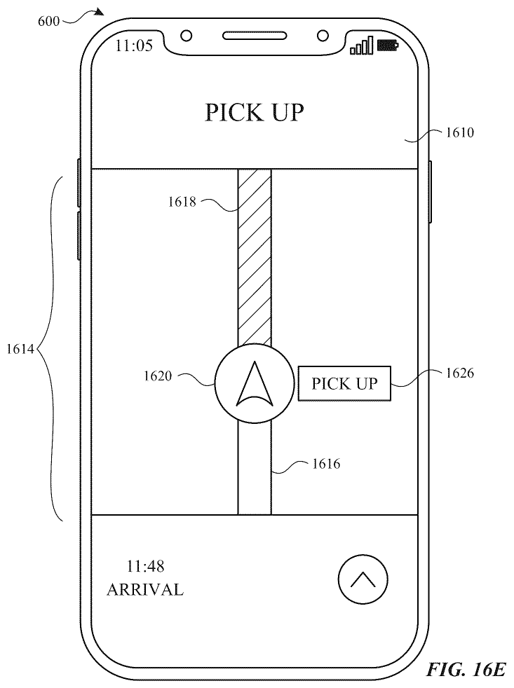

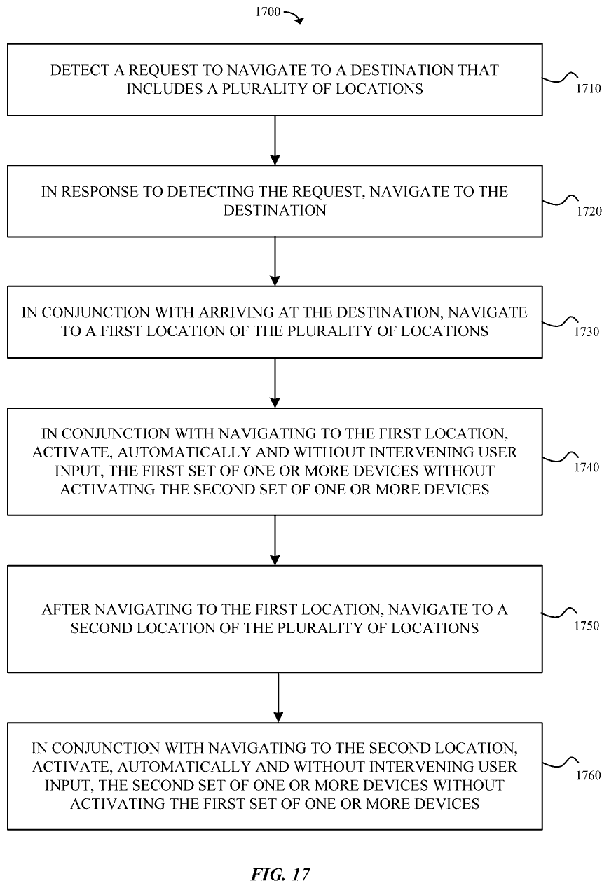

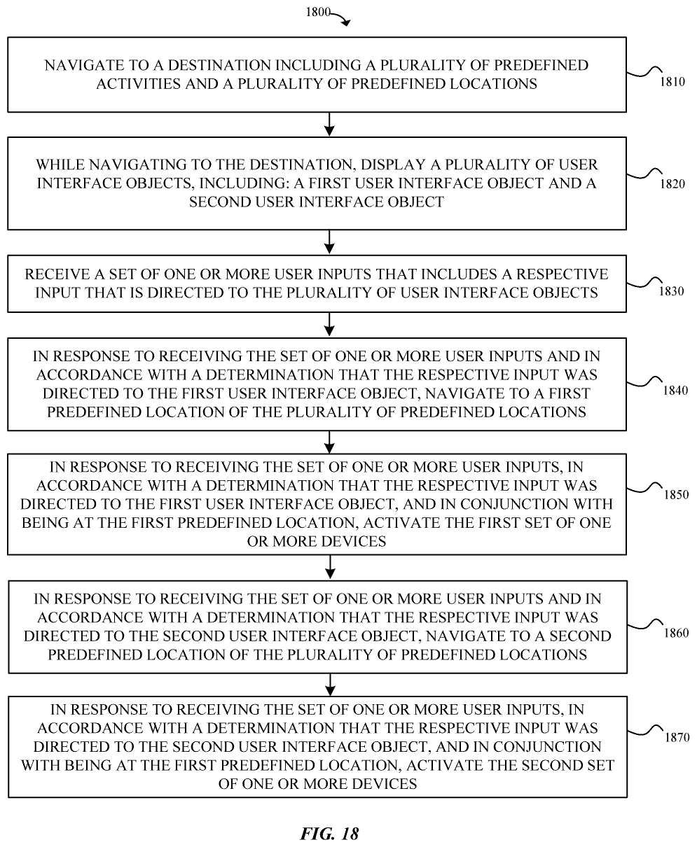

Below, FIGS. 1A-1B, 2, 3, 4A-4B, and 5A-5H provide a description of exemplary devices for performing the techniques for navigating to objects. FIGS. 6A-6L illustrate exemplary user interfaces for navigating to objects. FIG. 7 is a flow diagram illustrating methods of displaying a path to an object in accordance with some embodiments. FIG. 8 is a flow diagram illustrating methods of emphasizing an object in accordance with some embodiments. FIG. 9 is a flow diagram illustrating methods of emphasizing a type of object in accordance with some embodiments. The user interfaces in FIGS. 6A-6L are used to illustrate the processes described below, including the processes in FIGS. 7, 8 and 9. FIGS. 10A-10C illustrate exemplary user interfaces for manipulating a physical input mechanism using a computer system in accordance with some embodiments. FIG. 11 is a flow diagram illustrating a method for gesture-based repositioning using a computer system in accordance with some embodiments. FIG. 12 is a flow diagram illustrating a method for identity-based repositioning using a computer system in accordance with some embodiments. The user interfaces in FIGS. 10A-10C are used to illustrate the processes described below, including the processes in FIGS. 11 and 12. FIGS. 13A-13G illustrate exemplary user interfaces for navigating in a physical environment. FIG. 14 is a flow diagram illustrating a method for changing a destination using a computer system in accordance with some embodiments. FIG. 15 is a flow diagram illustrating a method for modifying navigation to a destination using a computer system in accordance with some embodiments. The user interfaces in FIGS. 13A-13G are used to illustrate the processes described below, including the processes in FIGS. 14 and 15. FIGS. 16A-16E illustrate exemplary user interfaces for navigating in a physical environment. FIG. 17 is a flow diagram illustrating a method for navigating in a physical environment using a computer system in accordance with some embodiments. FIG. 18 is a flow diagram illustrating a method for displaying different predefined activities for a destination using a computer system in accordance with some embodiments. The user interfaces in FIGS. 16A-16E are used to illustrate the processes described below, including the processes in FIGS. 17 and 18.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

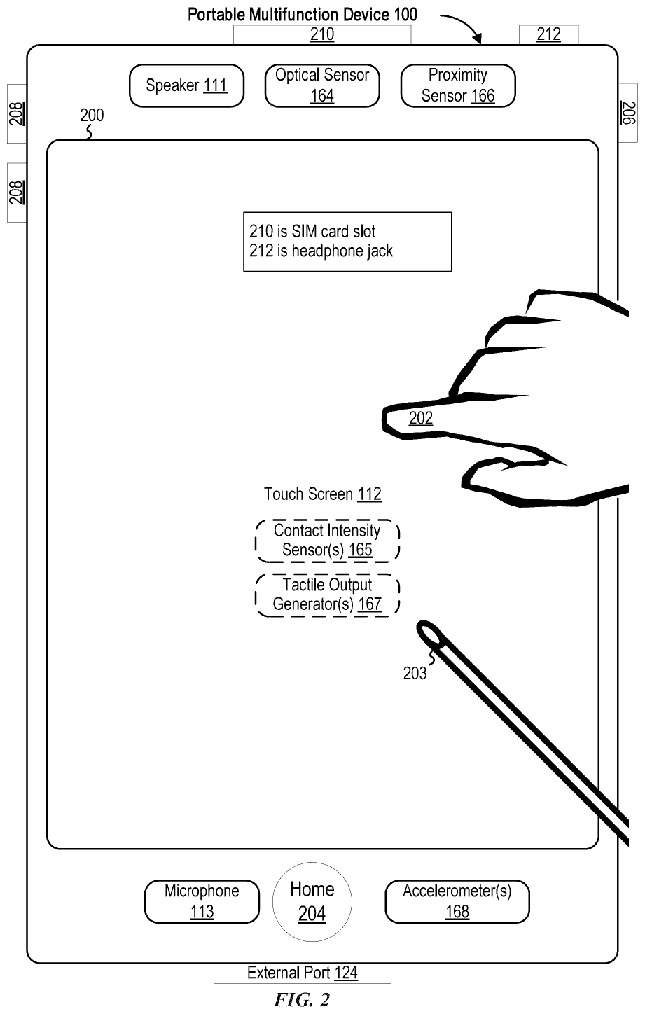

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

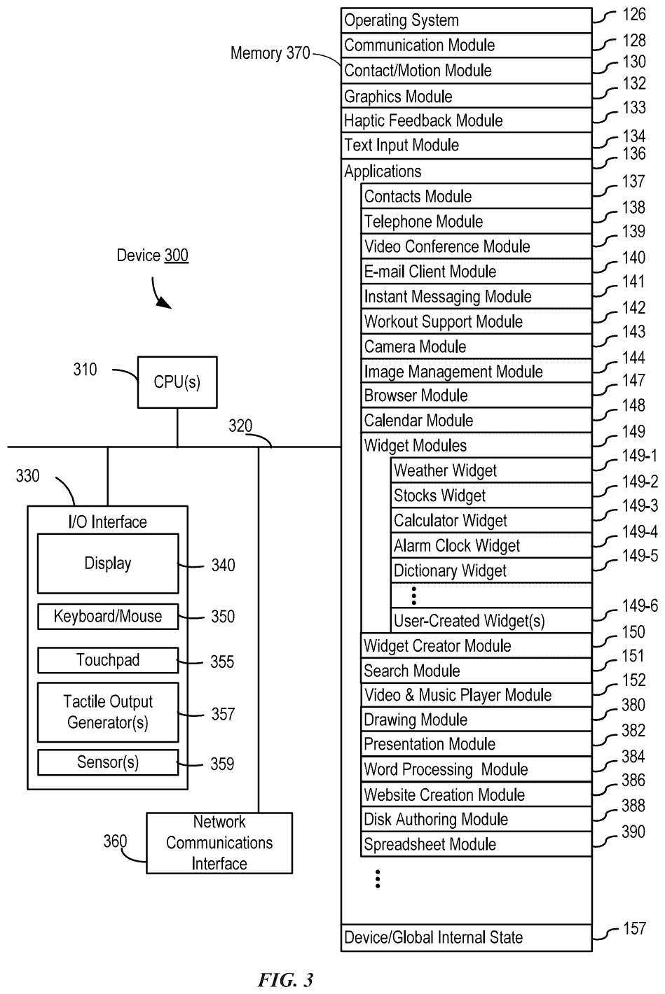

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

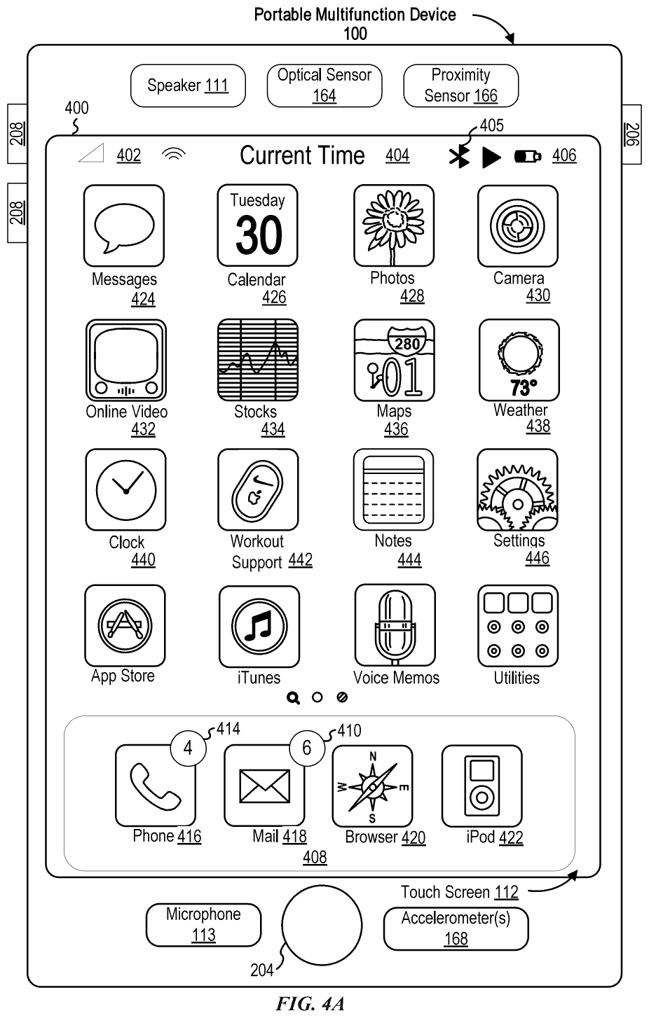

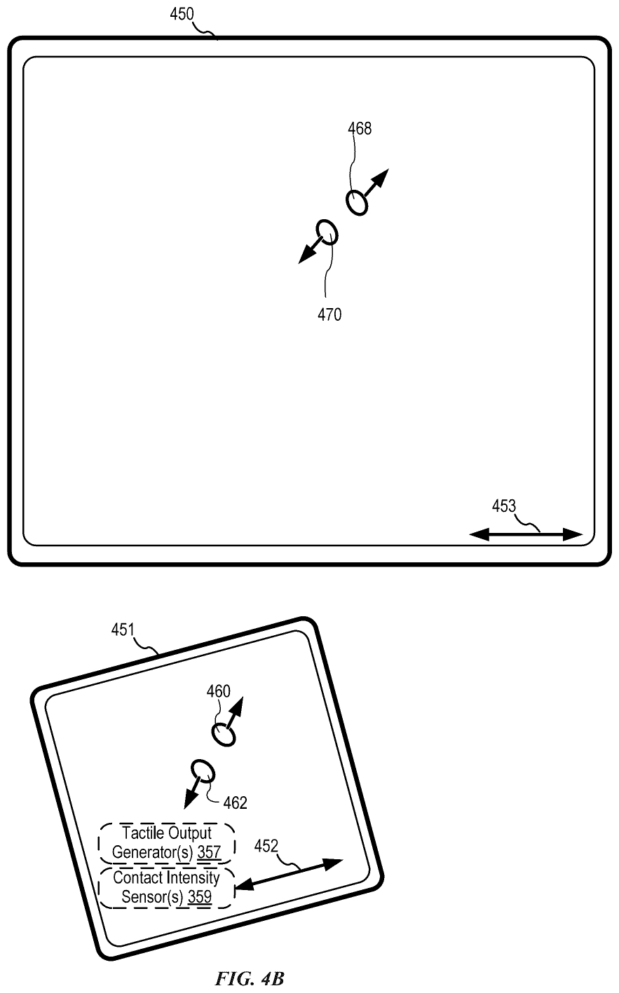

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

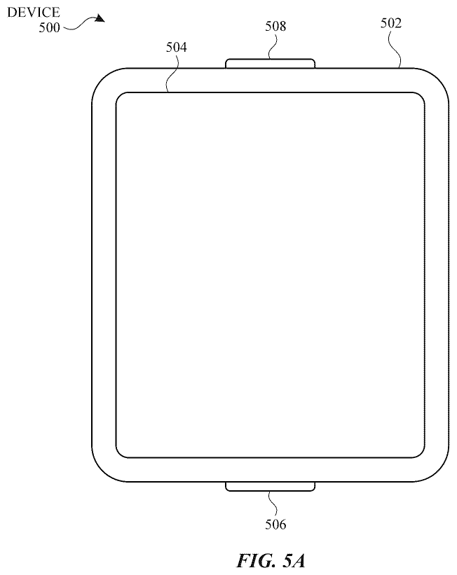

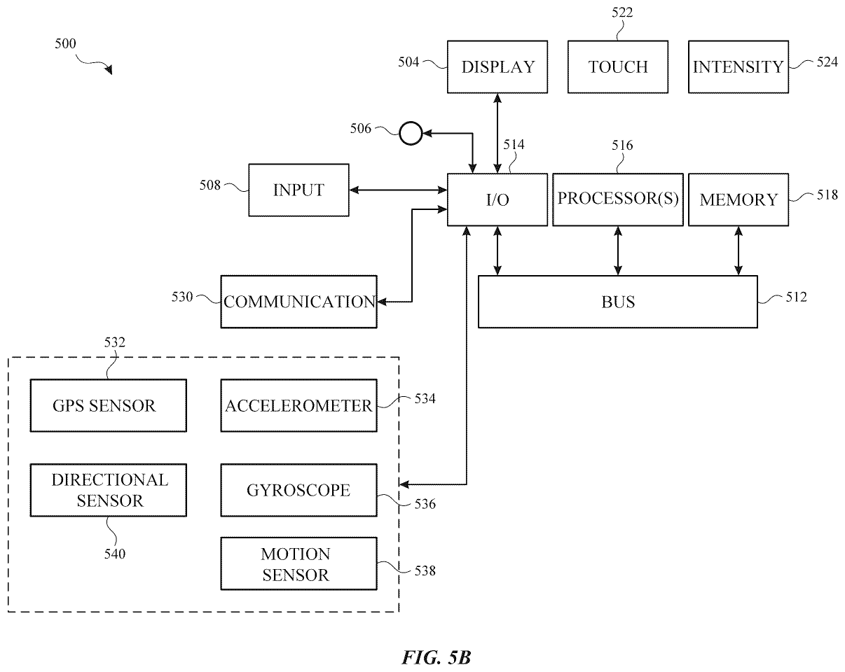

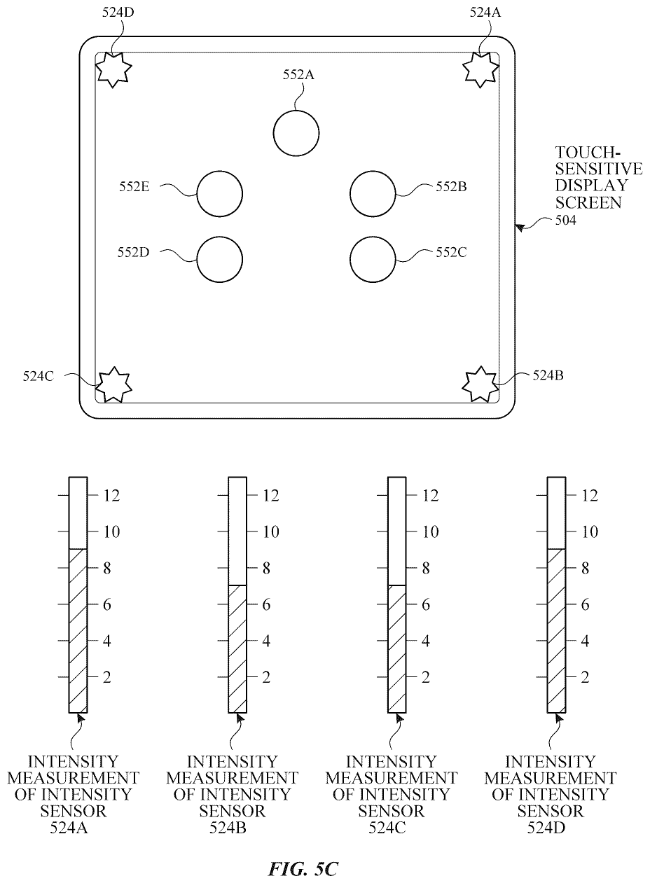

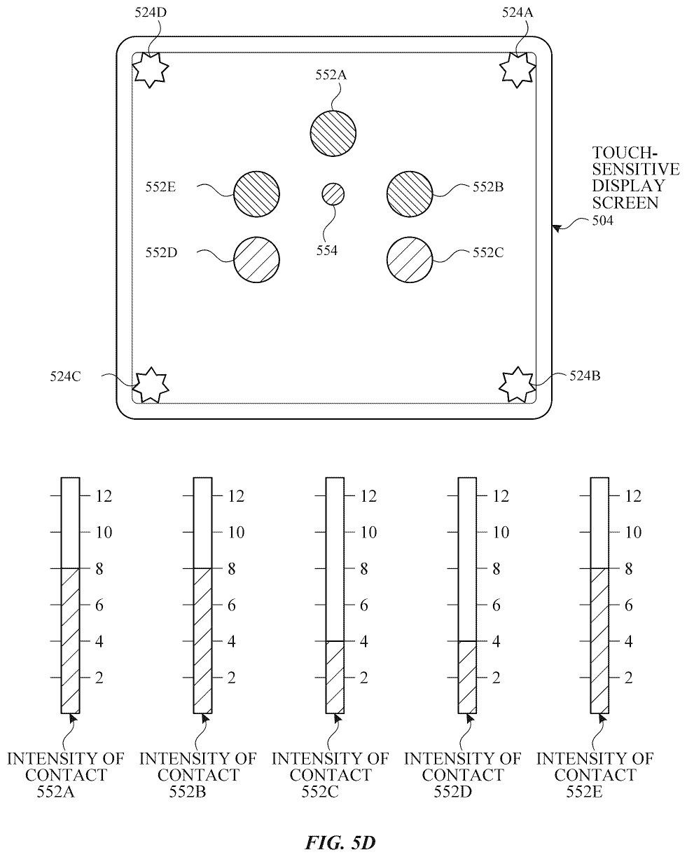

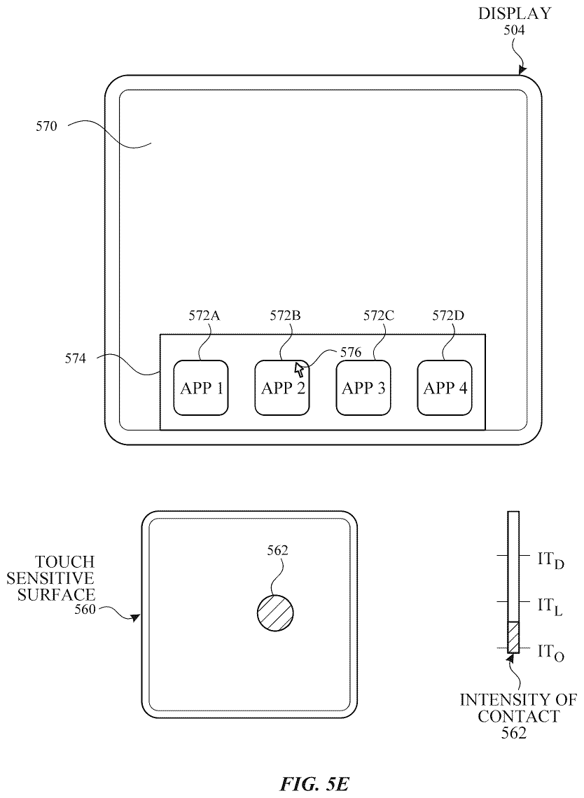

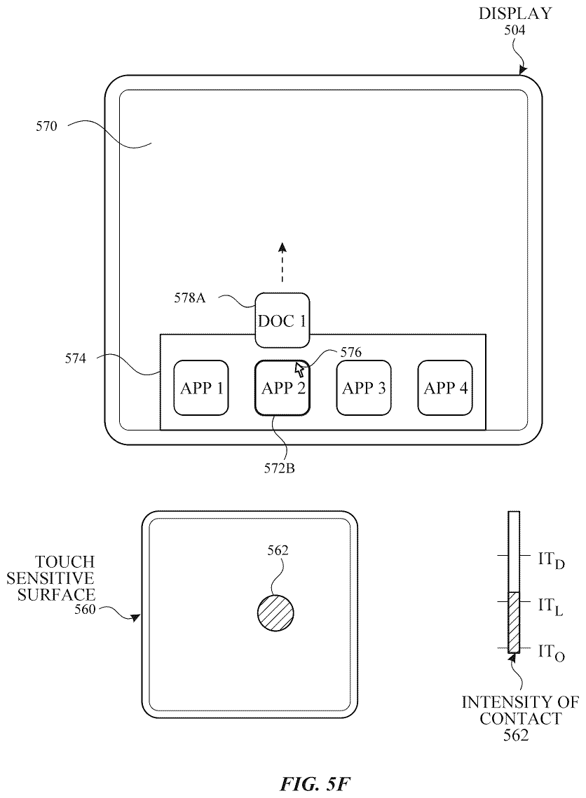

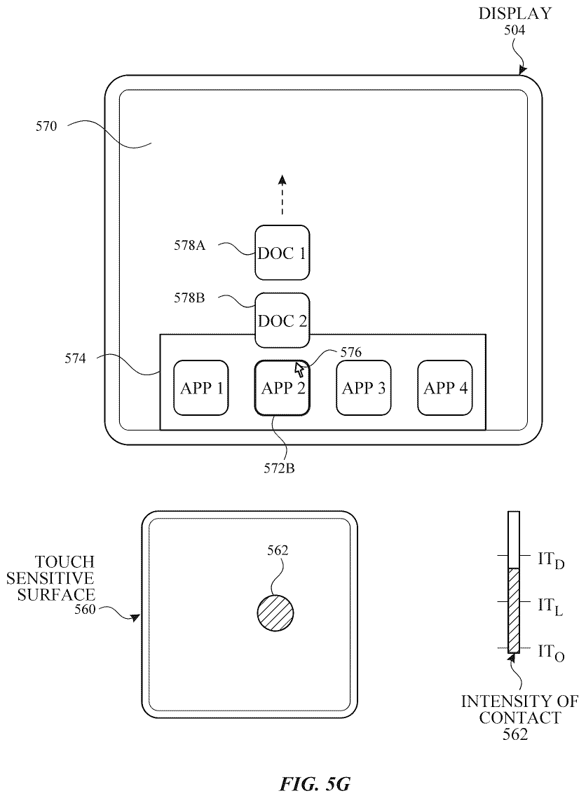

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700-900, 1100-1200, 1400-1500, and 1700-1800 (FIGS. 7-9, 11-12, 14-15, and 17-18). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6L illustrate exemplary user interfaces for navigating in a physical environment using computer system 600 in accordance with some embodiments. The user interfaces in these figures are used to illustrate the processes described below, including the processes in 700, 800, and 900. Through the exemplary user interfaces, user input is illustrated using a circular shape with dotted lines (e.g., user input 625a in FIG. 6A). It should be recognized that the user input can be any type of user input, including a tap on touch-sensitive screen, a button press, a gaze toward a control, a voice request with an identification of a control, a gesture made by a user and captured by a camera, and/or any other affirmative action performed by a user. In some examples, a single representation of a user input in a FIG. 1) includes one or more different types of user input and/or (2) represents different types of user input to result in different operations. For example, a single illustrated user input can be a tap input, a tap-and-hold input, and/or a swipe gesture.

FIG. 6A illustrates exemplary user interface 610 for navigating to a destination using computer system 600 in accordance with some embodiments. User interface 610 includes multiple portions, including instruction portion 620, navigation portion 622, and options portion 624. It should be recognized that user interface 610 can include more or fewer user interface elements than illustrated in FIG. 6A. For example, user interface 610 can include additional portions for providing additional information and/or controls and/or not include one or more portions.

Instructions portion 620 can provide a navigation instruction while navigating to the destination. For example, the navigation instruction illustrated in FIG. 6A is “proceed forward,” indicating that a user of computer system 600 should proceed forward to continue on a current path to the destination.

In some examples, a navigation instruction in instructions portion 620 is informative to a user and is intended to be used by the user to navigate computer system 600 and/or a mode of transportation being used by the user (e.g., a vehicle, walking, swimming, or taking public transportation). In other examples, the navigation instruction is used by computer system (or sent to another computer system as a request to perform an action) to navigate a physical environment without user input.

Navigation portion 622 can include a live camera feed and/or a map of a physical environment. In some examples, the map includes one or more objects in the physical environment. For example, the map illustrated in FIG. 6A includes road 622a, representing a road in the physical environment. In some examples, the one or more objects are included in the map and determined to be displayed based on a location determined for computer system 600. For example, computer system 600 can identify a current location of computer system 600 (e.g., via a GPS or other location service) and select a portion of a map corresponding to the current location. In such an example, the map includes objects that are determined to be located in the portion of the map. In some examples, one or more objects included in the map and/or navigation portion 622 are detected via one or more sensors in communication with computer system 600. For example, a camera, lidar, radar, and/or one or more other sensors that are capturing data with respect to a physical environment can identify a nearby object and computer system 600 can place the nearby object in the map and/or navigation portion 622 in a position determined by the sensors. In some examples, representations of objects are computer-generated to look different from the actual objects (e.g., are generalized and/or generated with less detail) and added to the map. In some examples, the objects can be navigated to by a user of computer system 600. For example, a building can be detected using a camera and a user of computer system 600 can navigate to the building based on instructions displayed by computer system 600. For another example, a vehicle can be detected using a camera and a user of computer system 600 can navigate to the vehicle based on instructions displayed by computer system 600 even as the vehicle moves (e.g., navigation can be updated as the vehicle moves).

As illustrated in FIG. 6A, navigation portion 622 includes representation 622c of computer system 600, representing a current location of computer system 600. In some examples, the current location is determined by computer system 600 or by a device communicating with computer system 600 (e.g., via a GPS or other location service). In addition to representation 622c, navigation portion 622 includes path 622b, representing a path for a user of computer system 600 to take to reach the destination. The path can be distinguished from other parts of the map, such as other areas for which a user of computer system 600 should not or will not follow to get to the destination (as shown by the portion of road 622a that is behind representation 622c).

Options portion 624 can include information and/or selectable user interface elements to aid in navigation to the destination. In FIG. 6A, options portion 624 includes an estimated arrival time and multiple controls to provide additional functionality. For example, options portion 624 includes parking control 624a that, when selected via user input, causes display of possible parking options (e.g., as illustrated in FIG. 6K) and/or automatic selection of a parking spot to navigate to (e.g., as illustrated in FIG. 6L). For another example, options portion 624 includes more control 624b that, when selected via user input, causes display of additional controls. FIG. 6A illustrates user input 625a selecting more control 624b, resulting in computer system 600 causing a transition to the user interface illustrated in FIG. 6B.

FIG. 6B illustrates exemplary user interface 610 for viewing additional options while navigating to a destination using computer system 600 in accordance with some embodiments. In some examples, user interface 610 of FIG. 6B is the user interface depicted in FIG. 6A after selection of more control 624b. In other examples, user interface 610 of FIG. 6B is a different user interface that is displayed in response to selection of more control 624b.

As illustrated in FIG. 6B, options portion 624 has expanded from the bottom of user interface 610 and is now overlapping a portion of navigation portion 622. In addition, a portion of user interface 610 has been deemphasized (e.g., shaded such that it is no longer a focus of user interface 610) as illustrated with respect to a remaining portion of navigation portion 622 and instruction portion 620.

Such expansion of options portion 624 allows for one or more additional controls to be displayed. For example, options portion 624 in FIG. 6B includes add-stop control 624b1 and end-route affordance 624b2. In some examples, add-stop control 624b1, when selected via user input, causes a user interface to be displayed for modifying a current navigation (e.g., adding an additional stop to occur before reaching the destination and/or changing the destination to a different location), as discussed more below. It should be recognized that add-stop control 624b1 can be displayed in other portions of user interface 610, such as concurrently with navigation portion 622 and/or instruction portion 620 so that add-stop affordance can be selected while viewing the map and/or the navigation instruction. FIG. 6B illustrates user input 625b selecting add-stop control 624b1, resulting in computer system 600 causing a transition to the user interface illustrated in FIG. 6C.

FIG. 6C illustrates exemplary user interface 626 for adding a stop while navigating to a destination using computer system 600 in accordance with some embodiments. In some examples, user interface 626 is displayed after selection of add-stop control 624b1 in FIG. 6B.

User interface 626 includes multiple controls for adding different types of stops to a current navigation. In some examples, adding a stop causes a current destination to be removed from a current plan and a new destination to be added. In other examples, a stop is added as an intermediate destination such that the destination before adding a new stop is still the final destination after adding the new stop with the new stop as a destination before the final destination.

As illustrated, user interface 626 categorizes different types of stops with different controls to choose between which category of stop is wanted. Examples of categories of stops include gas stations, coffee stops, lanes, people, and parking spots. For example, selection of gas stations can cause a user of computer system 600 to navigate to a gas station. In some examples, selection of different controls cause objects corresponding to the category to be highlighted in a map. For example, computer-generated representations of objects, where the objects are detected by a camera can be included in the map with emphasis on such objects. For another example, selection of a first type of object causes objects of a different type to not be included in a map. Such filtering reduces what a user sees when attempting to select an object.

FIG. 6C illustrates multiple user inputs selecting different categories of stops. For example, user input 627a is selecting lanes control 626a, user input 627b is selecting people control 626b, and user input 627c is selecting spots control 626c. It should be recognized that all three controls were shown selected for brevity and that user interface 626 can be configured to only allow a single category of stop to be selected at a time. In some examples, computer system 600 detecting user input 627a causes computer system 600 to cause a transition to the user interface illustrated in FIGS. 6D or 6E, computer system 600 detecting user input 627b causes computer system 600 to cause a transition to the user interface illustrated in FIGS. 6F, 6H, 6I. or 6K, and computer system 600 detecting user input 627c causes computer system 600 to cause a transition to the user interface illustrated in FIGS. 6K or 6L, as further discussed below.

FIG. 6D illustrates exemplary user interface 628 for selecting a different lane while navigating to a destination using computer system 600 in accordance with some embodiments. In some examples, user interface 628 is displayed after selection of lanes control 626a in FIG. 6C. In other examples, portions of user interface 628 (e.g., portions allowing to change a current lane used for navigation) are incorporated in user interfaces discussed above, such as navigation portion 622 in FIG. 6A such that a user can change a lane being used while viewing a current path to a destination. In such examples, navigation portion 622 would include representations of different lanes for a current road instead of a representation of a single lane (e.g., road). In some examples, the representations of different lanes are computer generated such that each lane is a computer-generated representation. In other examples, the representations of different lanes are part of a live camera feed (e.g., the live camera feed is of the different lanes) and user input is detected with respect to the live camera feed for selecting a lane.

User interface 628 includes lane-selection portion 630 (as mentioned above, lane-selection portion 630 can be integrated into navigation portion 622 of FIG. 6A to allow for a user to change a lane currently being used). As illustrated in FIG. 6D, lane-selection portion 630 includes representations for multiple lanes (e.g., left lane 630a, middle lane 630b, and right lane 630c). In some examples, lane-selection portion 630 includes more or fewer lanes (e.g., a number of lanes that a current location has), and each individual lane can appear different (e.g., lanes that not currently being used can be smaller (e.g., thinner) than a lane currently being used).

As illustrated in FIG. 6D, lane-selection portion 630 includes representation 632 of computer system 600, representing a current location of computer system 600. Similar to above, the current location can be determined by computer system 600 or by a device communicating with computer system 600 (e.g., via a GPS or other location service). In addition to representation 632, lane-selection portion 630 includes a portion of middle lane 630b emphasized, representing a path for a user of computer system 600 to take to reach the destination. The path is distinguished from other lanes for which a user of computer system 600 should not follow to get to the destination (as shown by left lane 630a and right lane 630c).

FIG. 6D illustrates user input 633 selecting right lane 630c, resulting in computer system 600 causing a transition to the user interface illustrated in FIG. 6E. In some examples, user input 633 is a tap input and can be located at any location within right lane 630c. In other examples, user input 633 is a swipe gesture going from either left to right or right to left and can be located at one or more locations within lane-selection portion 630. For example, user input 633 can begin in left lane 630a and end in right lane 630c to represent changing the lane to the right. While illustrated as selecting right lane 630c, it should be recognized that any lane can be selected in FIG. 6D, such as left lane 630a.

FIG. 6E illustrates exemplary user interface 610 for changing lanes while navigating to a destination using computer system 600 in accordance with some embodiments. In some examples, user interface 628 is displayed after selection of right lane 630c in FIG. 6D. In other examples, user interface 628 is displayed in response to selection of lanes control 626a in FIG. 6C, such as when (1) there is only one other possible lane or (2) a next navigation instruction is within a threshold distance away and the next navigation instruction will require to be in a particular lane (e.g., changing lanes early). In other words, a particular lane does not always need to be selected and instead can be automatically selected without user input when there is only a single other lane or when there is an upcoming navigation instruction and a particular lane can be used for the upcoming navigation instruction.

User interface 610 in FIG. 6E includes a navigation instruction in navigation portion 622 indicating a next driving maneuver (e.g., “change lane”). The navigation instruction of FIG. 6E is different from the navigation instruction of FIG. 6A. User interface 610 in FIG. 6E also includes navigation portion 622, which has a map corresponding to a current location. In some examples, the map in FIG. 6E is the same as the map illustrated in FIG. 6D with an update to a path to the destination (e.g., the path is no longer in middle lane 634b and is now in right lane 634c. In other examples, the map in FIG. 6E is the same as the map illustrated in FIG. 6A without displaying that the path has changed within the map (e.g., navigation portion 622 or an audio instruction would be what indicates what to do).

FIG. 6F-6G illustrate exemplary user interfaces for selecting a person while navigating to a destination using computer system 600 in accordance with some embodiments. For example, FIG. 6F illustrates user interface 636 with person-selecting portion 638. In some examples, person-selection portion 638 is displayed in response to selection of people control 626b in FIG. 6C. In other examples, person-selection portion 638 is incorporated in user interfaces discussed above, including navigation portion 622 in FIG. 6A such that a user can select a person while viewing a current path to a destination. In such examples, navigation portion 622 includes representations of different people.

In some examples, person-selecting portion 638 is a map of a physical environment. The map includes representations of one or more objects (e.g., a person, a parking spot, a building, a sign, or a vehicle) detected via one or more sensors in communication with computer system 600. In such examples, computer system 600 can be in communication with a camera, lidar, radar, and/or other sensor that can detect an object in the physical environment. After detection, a representation of the object is placed into the map to represent the object. In some examples, the representation of the object is a computer-generated representation of the object based on data detected by the one or more sensors. In such examples, the representation can include less detail than the actual object such that the representation is a generalized representation of the object. In other examples, the representation of the object is included in a live camera feed (e.g., the live camera feed is of the object) and user input is detected with respect to the live camera feed for selecting a person.

In some examples, the map emphasizes objects that are determined to be able to be navigated to by a user of computer system 600. The determination can be based on a number of factors, such as distance from a particular object, direction of the particular object relative to computer system 600, speed of computer system 600, speed of the particular object, type of the particular object (e.g., whether the object is stationary or non-stationary), and/or maneuvers that a user of computer system 600 would need to perform to arrive at a particular object. As illustrated in FIG. 6F, a group of people including person 646 and person 648 is emphasized using circle 646a. In addition, person 650 is also emphasized via circle 650a while person 652 is not emphasized. In some examples, the group of people and person 650 are determined to be able to be navigated to by a user of computer system 600 while person 652 is determined to not be able to be navigated to by a user of computer system 600. For example, person 652 can be determined to not be able to be navigated to because a user of computer system 600 would need to turn around to navigate to person 652. On the other hand, a user of computer system 600 would not need to turn around to navigate to the group of people and person 650, and so both sets of people are emphasized. It should be recognized that more or fewer people can be included in a group of people and treated as a single object. In some examples, people are grouped together when the people are determined to be within a threshold distance from each other. In some examples, a representation displayed in the map indicates more than two people and does not include separate representations for each person in a group. For example, a representation can depict three people but actually include more people.

In some examples, the map filters by a particular type of object, such that only objects of a particular type are included or emphasized in the map. In some examples, objects of the particular type and one or more other objects to provide context are included in the map. In such examples, some representations of other types of objects are included but other representations of the other types of objects are not included (e.g., a representation of a first object of a particular type is included in person-selecting portion 638 but a representation of a second object of the particular type is not included). As illustrated, the map in FIG. 6F includes road 640 and the people mentioned above. The map also includes representation 644 of computer system 600 and path 642 from representation 644 to the destination. It should be recognized that the map can include more or fewer elements.

FIG. 6G illustrates exemplary user interface 636 with person 648 breaking away from person 646. As previously illustrated in FIG. 6F, person 646 and person 648 were grouped together and emphasized together. FIG. 6G illustrates that as objects spread out and get further from each other, the map can represent the objects as separate objects and emphasize each object separately. For example, person 646 is emphasized by circle 646a1 and person 648 is emphasized by circle 648a. It should be recognized that people can join together and no longer be emphasized separately. For example, multiple people can be within a threshold distance from each other and be treated as a single object for navigation. In some examples, representations for people continue to be updated even after navigating to one or more of the people. For example, a person being navigated to can join a group and then the group can be navigated to.

FIG. 6G further illustrates user input 647 selecting person 646, resulting in computer system 600 causing a transition to the user interface illustrated in FIG. 6H or 6I. In some examples, user input selecting a person without emphasis (e.g., person 652) would not result in changing navigation. For example, nothing can occur or an error or warning message can be displayed when selecting a person without emphasis.

FIG. 6H illustrates exemplary user interface 656 for selecting how to navigate with respect to a person using computer system 600 in accordance with some embodiments. In some examples, user interface 656 is displayed after selection of a person (e.g., person 646 in FIG. 6G). In some examples, user interface 656 is displayed when the person is selected with a particular type of user input (e.g., a tap-and-hold gesture as opposed to a tap gesture). In such examples, a different type of gesture (e.g., a tap) causes different functionality to occur, such as navigating to the person (as depicted in FIG. 6I) and not displaying user interface 656. The different functionality can be a default operation and/or user configurable.

User interface 656 includes choice portion 658 with multiple different ways to navigate with respect to a person. For example, choice portion 658 includes pick-up control 660 and wait control 662.

In some examples, selection of pick-up control 660 causes computer system to determine a location to navigate for picking up the person and navigating to the location. The location can be a place that is near the person and/or a place that is available. In some examples, selection of wait control 662 causes computer system to determine a location near the person and cause a user to navigate to the location. In such examples, the location can move as the person moves such that the navigation is updated to ensure that the location is near the person. In some examples, a location corresponding to pick-up control 660 is closer to the person than a location corresponding to wait control 662.

FIG. 6H illustrates multiple user inputs selecting different controls. For example, user input 661 is selecting pick-up control 660 and user input 663 is selecting wait control 662. It should be recognized that both controls were shown selected for brevity and that user interface 656 can be configured to only allow a single control to be selected at a time. In some examples, computer system 600 detecting user input 661 causes computer system 600 to cause a transition to the user interface illustrated in FIG. 6I and computer system 600 detecting user input 663 causes computer system 600 to cause a transition to the user interface illustrated in FIG. 6J, as further discussed below.

FIG. 6I illustrates exemplary user interface 610 for navigating to pick up person 646 using computer system 600 in accordance with some embodiments. In some examples, user interface 610 in FIG. 6I is displayed in response to selection of (1) person 646 in FIG. 6G or (2) pick-up control 660 in FIG. 6H. As illustrated, path 642 from representation 644 of computer system 600 is updated to arrive near person 646. In some examples, before being updated, path 642 was leading to a different destination (as illustrated in FIG. 6G). In navigation portion 622 of user interface 610 in FIG. 6I, person 646 is emphasized but other people in the map are not emphasized. In some examples, selecting a person to navigate to causes other people to no longer be emphasized (e.g., FIG. 6G illustrates person 648 and person 650 emphasized). In some examples, once a person is selected as a destination, an emphasis of the person changes to be a different emphasis than before the person is selected. For example, a color of the emphasis can change once it is determined to navigate to the person.

FIG. 6J illustrates exemplary user interface 610 for navigating to wait for person 646 using computer system 600 in accordance with some embodiments. In some examples, user interface 656 is displayed in response to selection wait control 662 in FIG. 6H. As illustrated, path 642 from representation 644 of computer system 600 is updated to arrive near person 646. In some examples, before being updated, path 642 was leading to a different destination (as illustrated in FIG. 6G). In navigation portion 622 of user interface 610 in FIG. 6J, person 646 is emphasized but other people in the map are not emphasized. In some examples, selecting a person to navigate to causes other people to no longer be emphasized (e.g., FIG. 6G illustrates person 648 and person 650 emphasized). It should be recognized that navigating to wait in FIG. 6J illustrates that computer system 600 causes display of a location that is further away from person 646 than in FIG. 6I. Such navigation is meant to indicate that waiting for a person does not need to be as close to the person as when picking them up.

FIG. 6K illustrates exemplary user interface 670 for selecting a parking spot while navigating to a destination using computer system 600 in accordance with some embodiments. In some examples, user interface 670 is displayed in response to selection of spots control 626c in FIG. 6C. In other examples, a portion of user interface 670 is incorporated in user interfaces discussed above, including navigation portion 622 in FIG. 6A such that a user can select a parking spot while viewing a current path to a destination. In such examples, navigation portion 622 would include representations of different parking spots as further discussed below.

In some examples, user interface 670 includes a map of a physical environment, the map including representations of one or more parking spots detected via one or more sensors in communication with computer system 600. In such examples, computer system 600 can be in communication with a camera, lidar, radar, and/or other sensor that is capable of detecting a parking spot in the physical environment. After detection of a parking spot, a representation of the parking spot is placed into the map to represent the parking spot. In some examples, the representation of the parking spot is a computer-generated representation of the parking spot based on data detected by the one or more sensors. In other examples, the representation of the parking spot is included in a live camera feed (e.g., the live camera feed is of the parking spot) and user input is detected with respect to the live camera feed for selecting a parking spot.

In some examples, the map emphasizes parking spots that are determined to be able to be navigated to by a user of computer system 600. The determination can be based on a number of factors, such as distance from a parking spot, direction of the parking spot relative to computer system 600, speed of computer system 600, type of the parking spot, maneuvers that computer system 600 would need to perform to arrive at a particular parking spot, and/or whether a parking spot is currently taken. As illustrated, user interface 670 includes four representations of parking spots (e.g., parking spots 672, 674, 676, and 678). Of the parking spots, two of the parking spots (e.g., parking spots 672 and 676) are emphasized via rectangle 672a and 676a, indicating that two of the parking spots are able to be navigated to by a user of computer system 600. The remaining parking spots either have a car already parked in the parking spot (e.g., parking spot 674) or are determined to be in a location that a user of computer system 600 cannot navigate to (e.g., parking spot 678). For example, parking spot 678 can be determined to not be able to be navigated to because person 652 is in the way and/or a user of computer system 600 would need to turn around to navigate to parking spot 678. On the other hand, a user of computer system 600 would not need to turn around to navigate to parking spots 672 and 676, and so those parking spots are emphasized.

FIG. 6K further illustrates user input 673 selecting parking spot 672, resulting in computer system 600 causing a transition to the user interface illustrated in FIG. 6L. In some examples, user input selecting a parking spot without emphasis (e.g., parking spot 678) would not result in changing navigation. For example, nothing can occur or an error or warning message can be displayed when selecting a parking spot without emphasis.

FIG. 6L illustrates exemplary user interface 610 for navigating to parking spot 672 using computer system 600 in accordance with some embodiments. In some examples, user interface 610 in FIG. 6L is displayed in response to selection of (1) parking control 624a in FIG. 6A, spots control 626c in FIG. 6C, or (3) parking spot 672 in FIG. 6K. As illustrated in FIG. 6L, path 642 from representation 644 of computer system 600 is updated to arrive at parking spot 672. In some examples, before being updated, path 642 was leading to a different destination (as illustrated in FIG. 6K). In navigation portion 622 of user interface 610 in FIG. 6L, parking spot 672 is emphasized but other parking spots in the map are not emphasized (e.g., parking spot 676). In some examples, selecting a parking spot to navigate to causes other parking spots to no longer be emphasized.

In some examples, navigating to a parking spot is based on one or more other vehicles detected in proximity to the parking spot. For example, car 674a can be detected as being parked with the front of car 674a first. In such an example, navigating to parking spot 672 can be such that a user of computer system 600 navigates in a similar direction as car 674a. In other examples, navigating to a parking spot is based on a user preference when parking, such as a user preference when parking a particular type of parking spot as opposed to another type of parking spot. For example, computer system 600 can identify a user preference to park backwards into a spot. In such an example, navigating to parking spot 672 can be such that a user of computer system 600 navigates backwards in the parking spot.

FIG. 7 is a flow diagram illustrating a method 700 for navigating to an object using a computer system in accordance with some embodiments. Method 700 is performed at a computer system (e.g., 100, 300, 500) that is in communication with a display generation component (e.g., display screen and/or a touch-sensitive display) and one or more sensors (e.g., a microphone, a camera, a radar, a lidar, a touch-sensitive display, a rotatable input mechanism, and/or a physical button). In some examples, the computer system is a watch, a fitness tracking device, a phone, a tablet, a processor, a head-mounted display (HMD) device, and/or a personal computing device. In some examples, a sensor of the one more sensor is the display generation component, such as a touch-sensitive display. Some operations in method 700 are, optionally, combined, the orders of some operations are, optionally, changed, and some operations are, optionally, omitted.

As described below, method 700 provides an intuitive way for navigating to an object. The method reduces the cognitive burden on a user for navigating to an object, thereby creating a more efficient human-machine interface. For battery-operated computing devices, enabling a user to navigate to an object faster and more efficiently conserves power and increases the time between battery charges.

At 710 of method 700, the computer system displays, via the display generation component, a representation (622, 630, 638) (e.g., a map, an image, a video, a three-dimensional representation, a two-dimensional representation, and/or a computer-generated representation) of a physical environment, wherein the representation includes one or more objects (622a, 630a, 630b, 630c, 634a, 634b, 634c, 640, 646, 648, 650, 652, 672, 674, 676, 678, 674a) (e.g., one or more people, a device such as a car, or parking spot) detected via at least one sensor of the one or more sensors.

At 720 of method 700, the computer system receives (e.g., and/or detecting) (e.g., while displaying the representation of the physical environment), via at least one sensor of the one or more sensors, a set of one or more inputs that includes an input (633, 646, 673) corresponding to (e.g., an input directed to, an input on, an input detected at a location corresponds to, and/or an input overlaid on a location corresponds to) selection (e.g., in the representation) of an object of the one or more objects. In some examples, as a part of receiving the input, the computer system detects, via a microphone of the one or more sensors, an audio instruction. In some examples, as a part of receiving the input, the computer system detects, via the display generation component, a touch input, such a tap input and/or a tap-and-hold put. In some examples, as a part of receiving the input, the computer system detects, via a camera of the one or more sensors, a gesture (e.g., an air gesture and/or air input, such as an air tap input and/or a finger pointing input) performed by a user and/or a gaze of the user. In some examples, as a part of receiving the input, the computer system detects, via a hardware component (e.g., a button and/or a rotatable input mechanism), the input.

At 730 of method 700, the computer system, in response to receiving the set of one or more user inputs (e.g., and/or the input corresponding to selection of the object), displays, via the display generation component, a path (FIG. 6E, 642 in FIG. 6I, 6J, or 6L) (e.g., a navigation and/or route path) to a location (e.g., relative to, directly to, near, and/or adjacent to) corresponding to the object in the representation of the physical environment (e.g., that was not previously displayed before the set of one or more user inputs were received). In some examples, one or more directions (620) (e.g., maneuvers) are displayed concurrently with the path. In some examples, the path is displayed in response to receiving confirmation to navigate to the object, where the confirmation is the same as or different from the user input corresponding to selection of the object). In some examples, in response to receiving the set of one or more user inputs, the computer system does not display, via the display generation component, a path to a different object in the representation of the physical environment.

Displaying a path to a location corresponding to an object detected via at least one sensor of one or more sensors in response to detecting an input provides a user with control over a computer system to choose which object for which a path should be generated, which provides additional control options without cluttering the user interface with additional displayed controls.

In some examples, the object is at a predefined location in the physical environment. In some examples, the object is a stationary object (672) (e.g., statute, a monument, a business, a tire shop, a store, a parking spot, a bus stop, a building, a school, and/or a street corner) that is at a predefined location in the environment. In some examples, the object is a non-stationary object (e.g., an object that is capable of moving) in the physical environment (646). In some examples, a non-stationary object is not at a predefined location in the environment.

Displaying a path to a location corresponding to an object at a predefined location in a physical environment in response to detecting an input provides a user with control over a computer system to choose which predefined location for which a path should be generated, which provides additional control options without cluttering the user interface with additional displayed controls.

In some examples, the computer system: navigates to the predefined location in the physical environment, wherein the navigating includes: in accordance with a determination that the computer system is configured to navigate to the predefined location based on a first preference (e.g., a preference that has been set by a user and/or a preference that is determined based on one or more other user preferences and/or user activity), navigating (e.g., obtaining (e.g., determining, acquiring, and/or making) a navigation plan that indicates that the computer system is configured to navigate in a first direction while traveling a first portion of the path (e.g., the computer system navigates in a first direction while traveling a first portion of the path) and/or moving in) in a first direction along a first portion of the path (e.g., while the computer system is traveling along the path); and in accordance with a determination that the computer system is configured to navigate to the predefined location based on a second preference that is different from the first preference, navigating (e.g. obtaining (e.g., determining, acquiring, and/or making) a navigation plan that indicates that the computer system is configured to navigate in a second direction while traveling the first portion of the path (e.g., the computer system navigates in the second direction (and not the first direction) while traveling the first portion of the path) and/or moving in) in a second direction along the first portion of the path, wherein the second direction is different from the first direction. In some examples, the computer system displays the navigation plan in relation to the path and/or displays an indication of the navigation plan (e.g., go backwards, go forwards, go left, and/or go right).

Navigating to a predefined location in a physical environment based on different preferences based on a set of criteria provides a user with control over a computer system to choose how to navigate, which provides additional control options without cluttering the user interface with additional displayed controls, reduces the number of inputs needed to perform an operation, and performs an operation when a set of conditions has been met without requiring further user input.

In some examples, the computer system navigates to the predefined location in the physical environment, wherein the navigating includes: in accordance with a determination a second object in the physical environment in the physical environment is oriented in a first direction, navigating (e.g., obtaining a navigation plan that indicates that the computer system is configured to be oriented in a second direction while traveling along a second portion of the path and/or moving) with a second direction of orientation; and in accordance with a determination the second object in the physical environment in the physical environment is oriented in a third direction that is different from the first direction, navigating (e.g., obtaining a navigation plan that indicates that the computer system is configured to be oriented in a fourth direction while traveling along a fourth portion of the path and/or moving) with a fourth direction of orientation that is different from the second direction of orientation.

Navigating to a predefined location in a physical environment based on how objects are oriented in the physical environment based on a set of criteria provides a user with control over a computer system to choose how to navigate, which provides additional control options without cluttering the user interface with additional displayed controls, reduces the number of inputs needed to perform an operation, and performs an operation when a set of conditions has been met without requiring further user input.

In some examples, the object includes (e.g., represents and/or indicative of) one or more people (646) (e.g., detected in the field-of-view of one or more cameras).

Displaying a path to one or more people in a physical environment in response to detecting an input provides a user with control over a computer system to choose which object for which a path should be generated, which provides additional control options without cluttering the user interface with additional displayed controls.

In some examples, the computer system: while displaying the object (and/or a representation of the object) that includes one or more people (and before, while, and/or after detecting a second input corresponding to selection of the object), detects movement of a first subset of the one or more people in relation to a second subset of the one or more people (646, 648); and in response to detecting movement of the first subset of the one or more people from the second subset of the one or more people (and in accordance with a determination that the first subset of the one or more people is further than a predetermined distance away from the second subset of the one or more people): ceases to display the object; and displays a first object corresponding to the first group of the one or more people; and displays a second object corresponding to the second group of the one or more people, wherein the second object is different from the first object.

In some examples, in response to detecting movement of the first subset of the one or more people from the second subset of the one or more people and in accordance with a determination that the first subset of the one or more people is not further than a predetermined distance away from the second subset of the one or more people, the computer system continues to display the object and does not display the object corresponding to the first group of the one or more people and the object corresponding to the second group of the one or more people. In some examples, while displaying the first object and the second object, in accordance with a determination that the first group of the one or more people is less than a predetermined distance away from the second group of the one or more people, the computer system: (1) ceases to display the first object and the second object and (2) displays a third object corresponding to a group including the first group and the second group.

Displaying different objects corresponding to different subsets of people in response to detecting movement of the first subset from the second subset allows a user more control when navigating to particular objects, which provides additional control options without cluttering the user interface with additional displayed controls.

In some examples, the computer system: while displaying the object including the one or more people, detects a second input corresponding to selection of the object (e.g., an input corresponding to a long press, a press-and-hold, a gaze for predetermine period of time at one location, and/or an air gesture, such as a long tap air gesture and/or a pointing gesture); in response to detecting the second input corresponding to selection of the object, displays a plurality of options (660, 662); while displaying the plurality of options, detects an input (661, 663) corresponding to selection of a first option of the plurality of options (e.g., an input corresponding to a long press, a press-and-hold, a gaze for predetermine period of time at one location, and/or an air gesture, such as a long tap air gesture and/or a pointing gesture); and in response to detecting the input corresponding to selection of a respective option of the plurality of options: in accordance with a determination that the respective option is a first option of the plurality of options, navigates (e.g., obtaining a navigation plan that indicates that the computer system is configured to follow the one or more people and/or moving) to follow the one or more people (662); and in accordance with a determination that the respective option is a second option of the plurality of options, navigates (e.g., obtaining a navigation plan that indicates that the computer system is configured to navigate to a predefined location relative to the one or more people and/or moving) (e.g., without navigating to follow the one or more people) to the predefined location (e.g., a location that corresponds to a location of a business, a tire shop, a store, a parking spot, a bus stop, a building, a school, and/or a street corner) relative to the one or more people (660), wherein the second option is different from the first option.

Providing options to either follow one or more people or navigate to a predefined location relative to the one or more people in response to detecting an input provides a user with control over a computer system to choose how to navigate to an object, which provides additional control options without cluttering the user interface with additional displayed controls and performs an operation when a set of conditions has been met without requiring further user input.

In some examples, the object includes a second computer system that is different from the computer system. In some examples, a location of the object is detected by communicating with the second computer system. In some examples, a location of the object is detected by analyzing an image.

Displaying a path to a second computer system in a physical environment in response to detecting an input provides a user with control over a computer system to choose which object that a path should be generated for, which provides additional control options without cluttering the user interface with additional displayed controls.

In some examples, the object includes one or more markings (672) in the physical environment (e.g., a caution lane, a passing lane, one or more signs, and/or a sidewalk) (e.g., that the computer system is not within). In some examples, a location of the object is detected by analyzing an image.

Displaying a path to one or more markings in a physical environment in response to detecting an input provides a user with control over a computer system to choose which object that a path should be generated for, which provides additional control options without cluttering the user interface with additional displayed controls.

In some examples, displaying the path (e.g., a navigation and/or route path) to the object in the representation of the physical environment includes: detecting movement of the object; and in response to detecting movement of the object: in accordance with a determination that movement of the object includes first movement, updating the path relative to the first movement; and in accordance with a determination that movement of the object includes second movement that is different from (and, in some embodiments, does not include) the first movement, updating the path relative to the second movement (e.g., without updating the path relative to the first movement), wherein the path that is updated relative to the first movement is different from the path that is updated relative to the second movement.

Updating a path to an object relative to movement of the object allows a user more control when navigating to particular objects, which provides additional control options without cluttering the user interface with additional displayed controls.

In some examples, the computer system: receives (e.g., and/or detecting) (e.g., while displaying the representation of the physical environment that includes the one or more objects), via at least one sensor of the one or more sensors, a second set of one or more inputs that includes an input corresponding to (e.g., corresponding to selection (e.g., in the representation) of) selection of e.g., an input corresponding to a long press, a press-and-hold, a gaze for predetermine period of time at one location, and/or an air gesture, such as a long tap air gesture and/or a pointing gesture) a second object of the one or more objects; and in response to detecting the input corresponding to selection of the second object of the one or more objects, forgoes display of a path to a location corresponding to the second object.

Only displaying a path to particular objects in response to detecting an input provides a user with control over a computer system to choose which object that a path should be generated for, which provides additional control options without cluttering the user interface with additional displayed controls.

In some examples, displaying the representation of the physical environment includes: displaying a representation of the object; before receiving the set of one or more user inputs, the representation of the object is displayed with a first appearance; in response to receiving the set of one or more user inputs, displaying, via the display generation component, the representation of the object with a second appearance that is different from the first appearance. In some examples, in response to receiving the set of one or more user inputs, displaying, via the display generation, the representation of the object is emphasized (e.g., highlighted, bolded, gets larger, and/or pops-out).

After selecting an object, changing an appearance of a representation of an object provides a user with feedback on a state of a computer system and which object is selected, which provides improved visual feedback to the user.

In some examples, the computer system: in response to receiving the set of one or more user inputs, navigates to the object via the path. In some examples, the computer system navigates to the object in response to detecting the input corresponding to selection (e.g., in the representation) of the object of the one or more objects and/or in response to detecting an input that is different from the input corresponding to selection of the object (e.g., a confirmation input, such as tap input, a voice input, and/or a gaze input).

Navigating to an object in a physical environment in response to detecting an input provides a user with control over a computer system to choose how to navigate, which provides additional control options without cluttering the user interface with additional displayed controls.

In some examples, navigating to the object via the path includes ceasing to perform a previous navigation process that was initiated before the set of one or more inputs were received.

Navigating to an object via a path by ceasing to perform a previous navigation process that was initiated before the set of one or more inputs were received provides a user with control over a computer system to choose how to navigate, which provides additional control options without cluttering the user interface with additional displayed controls.

In some examples, the representation of the physical environment includes a computer-generated representation of one or more non-stationary objects (e.g., temporary objects (e.g., vehicles, people, animals, bikes, balls, bats, and/or clothing) and/or objects that are not fixed to a location in the physical environment). In some examples, the computer-generated representation of an object includes less details concerning the object than the details of the actual object. In some examples, the computer-generated representation of the object is a proxy object (e.g., a representation of an object that includes details of the object than the details that were captured by the one or more sensors).

Displaying a computer-generated representation of one or more non-stationary objects in response to detecting an input provides a user with control over a computer system to choose which object that a path should be generated for, which provides additional control options without cluttering the user interface with additional displayed controls.

In some examples, the representation of the physical environment includes a computer-generated representation of one or more stationary objects (e.g., temporary objects (e.g., buildings, the ground, a road, a tree, a monument, a mountain, and/or a hill) and/or objects that are fixed (e.g., reasonably fixed and/or not reasonably movable by a person having no tools) to a location in the physical environment).

Displaying a computer-generated representation of one or more stationary objects in response to detecting an input provides a user with context when controlling a computer system to choose which object that a path should be generated for, which provides improved visual feedback to the user.

In some examples, the one or more sensors include one or more cameras, and wherein the representation of the physical environment is a live feed that is captured by the one or more cameras.

Displaying a live feed that is captured by one or more cameras in response to detecting an input provides a user with control over a computer system to choose which object that a path should be generated for, which provides additional control options without cluttering the user interface with additional displayed controls.

Note that details of the processes described above with respect to method 700 (e.g., FIG. 7) are also applicable in an analogous manner to the methods described below. For example, method 800 optionally includes one or more of the characteristics of the various methods described above with reference to method 700. For example, the emphasized first object of method 800 can be the object selected in method 700. For brevity, these details are not repeated below.

FIG. 8 is a flow diagram illustrating a method 800 for navigating to an object using a computer system in accordance with some embodiments. Method 800 is performed at a computer system (e.g., 100, 300, 500) that is in communication with a display generation component (e.g., display screen and/or a touch-sensitive display) and one or more sensors (e.g., a microphone, a camera, a radar, a lidar, a touch-sensitive display, a rotatable input mechanism, and/or a physical button). In some examples, the computer system is a watch, a fitness tracking device, a phone, a tablet, a processor, a head-mounted display (HMD) device, and/or a personal computing device. In some examples, a sensor of the one more sensor is the display generation component, such as a touch-sensitive display. Some operations in method 800 are, optionally, combined, the orders of some operations are, optionally, changed, and some operations are, optionally, omitted.

As described below, method 800 provides an intuitive way for navigating to an object. The method reduces the cognitive burden on a user for navigating to an object, thereby creating a more efficient human-machine interface. For battery-operated computing devices, enabling a user to navigate to an object faster and more efficiently conserves power and increases the time between battery charges.

At 810 of method 800, the computer system displays, via the display generation component, a representation (622, 638) (e.g., as described above in relation to method 700) of a physical environment.

At 820 of method 800, the computer system, while displaying the representation of the physical environment, detects, via at least one sensor of the one or more sensors, a first object (e.g., as described above in relation to method 700) in the physical environment.

At 830 of method 800, the computer system, in conjunction with (e.g., after and/or in response to) detecting the first object in the physical environment and in accordance with a determination that a path to the first object is a first type of path (e.g., a safe path, a path that does not include a particular maneuver (or a particular type of maneuver), such as a U-turn and/or a sharp turn, and/or a path that does not include a maneuver for at least a threshold amount of distance or time), emphasizes (646a) (e.g., highlighting, bolding, enlarged, popping-out, and/or displaying a shape around) the first object. In some examples, in accordance with a determination that the path to the first object is the first type of path, the computer system displays an indication that the path to the first object is the first type.

At 840 of method 800, the computer system, in conjunction with (e.g., after and/or in response to) detecting the first object in the physical environment and in accordance with a determination that the path to the first object is a second type of path that is different from the first type of path, forgoes emphasis (652) of the first object. In some examples, in accordance with a determination that the path to the first object is the first type of path, the computer system does not display the indication that the path to the first object is the first type.

Conditionally emphasizing a first object based on a type of path to the first object provides a user with control over a computer system to choose which object that a path should be generated for, which provides additional control options without cluttering the user interface with additional displayed controls and performs an operation when a set of conditions has been met without requiring further user input.

In some examples, the path to the first object is determined to be the first type of path or the second type of path based on at least a distance between the computer system and the first object. In some examples, in accordance with a determination that a distance between the computer system and the first object is a first distance, the path to the first object is determined to be the first type of path; and in accordance with a determination that the distance between the computer system and the first object is a second distance that is different from the first distance, the path to the first object is determined to be the second type of path.

Determining a type of path of a path to a first object based on at least a distance between a computer system and the first object provides a user with control over a computer system to choose which object that a path should be generated for, which provides additional control options without cluttering the user interface with additional displayed controls and performs an operation when a set of conditions has been met without requiring further user input.

In some examples, the path to the first object is determined to be the first type of path or the second type of path based on at least a speed of the first object. In some examples, in accordance with a determination that the speed of the object is a first speed, the path to the first object is determined to be the first type of path; and in accordance with a determination that the speed of the object is a second speed that is different from the first speed, the path to the first object is determined to be the second type of path.

Determining a type of path of a path to a first object based on at least a speed of the first object provides a user with control over a computer system to choose which object that a path should be generated for, which provides additional control options without cluttering the user interface with additional displayed controls and performs an operation when a set of conditions has been met without requiring further user input.

In some examples, the path to the first object is determined to be the first type of path or the second type of path based on at least a speed of the computer system. In some examples, in accordance with a determination that a speed of the computer system is a third speed, the path to the first object is determined to be the first type of path; and in accordance with a determination that the speed of the computer system is a fourth speed that is different from the third speed, the path to the first object is determined to be the second type of path.

Determining a type of path of a path to a first object based on at least a speed of a computer system provides a user with control over the computer system to choose which object that a path should be generated for, which provides additional control options without cluttering the user interface with additional displayed controls and performs an operation when a set of conditions has been met without requiring further user input.

In some examples, the path to the first object is determined to be the first type of path or the second type of path based on at least a determination of whether the first object is stationary (e.g., whether the object is stationary object or a non-stationary object (e.g., as described above in relation to method 700)). In some examples, in accordance with a determination that the first object is a stationary object, the path to the first object is determined to be the first type of path; and in accordance with a determination that the path to the first object is a non-stationary object, the path to the first object is determined to be the second type of path.

Determining a type of path of a path to a first object based on at least a determination of whether the first object is stationary provides a user with control over a computer system to choose which object that a path should be generated for, which provides additional control options without cluttering the user interface with additional displayed controls and performs an operation when a set of conditions has been met without requiring further user input.

In some examples, the path to the first object is determined to be the first type of path or the second type of path based on at least a direction of the first object from the computer system (or a direction of the computer system from the object). In some examples, in accordance with a determination that a direction from the computer system to the first object is a first direction, the path to the first object is determined to be the first type of path; and in accordance with a determination that a direction from the computer system to the first object is a second direction that is different from the first direction, the path to the first object is determined to be the second type of path. In some examples, the path to the first object is determined to be the first type of path or the second type of path based on whether or not the first object is selectable.

Determining a type of path of a path to a first object based on at least a direction of the object from a computer system provides a user with control over the computer system to choose which object that a path should be generated for, which provides additional control options without cluttering the user interface with additional displayed controls and performs an operation when a set of conditions has been met without requiring further user input.

In some examples, the computer system: while displaying the representation of the first object, detecting an input directed to the first object; and in response to detecting the input directed to the first object: in accordance with a determination that the first object is selectable (e.g., and/or that the first object is emphasized and/or is the first object type), initiates navigation to the first object (e.g., as described above in relation to method 700); and in accordance with a determination that the first object is not selectable, forgoing navigation to the first object.

Conditionally navigating to a first object based on whether the first object is selectable provides a user with control over the computer system to choose which object that a path should be generated for, which provides additional control options without cluttering the user interface with additional displayed controls and performs an operation when a set of conditions has been met without requiring further user input.

In some examples, initiating navigation to the first object includes displaying a path to the first object (e.g., as described above in relation to method 700) (e.g., on and/or overlaying a map). In some examples, in accordance with a determination that the first object is not selectable, the computer system does not display the path to the first object.

Displaying a path to a first object when navigating to the first object provides a user with feedback on a state of a computer system and which object is selected, which provides improved visual feedback to the user.

Note that details of the processes described above with respect to method 800 (e.g., FIG. 8) are also applicable in an analogous manner to the methods described above and below. For example, method 700 optionally includes one or more of the characteristics of the various methods described above with reference to method 800. For example, objects that are selectable in method 700 can be objects that are emphasized in method 800. For brevity, these details are not repeated below.

FIG. 9 is a flow diagram illustrating a method 900 for navigating to an object using a computer system in accordance with some embodiments. Method 900 is performed at a computer system (e.g., 100, 300, 500) that is in communication with a display generation component (e.g., display screen and/or a touch-sensitive display) and one or more sensors (e.g., a microphone, a camera, a radar, a lidar, a touch-sensitive display, a rotatable input mechanism, and/or a physical button). In some examples, the computer system is a watch, a fitness tracking device, a phone, a tablet, a processor, a head-mounted display (HMD) device, and/or a personal computing device. In some examples, a sensor of the one more sensor is the display generation component, such as a touch-sensitive display. Some operations in method 900 are, optionally, combined, the orders of some operations are, optionally, changed, and some operations are, optionally, omitted.

As described below, method 900 provides an intuitive way for navigating to an object. The method reduces the cognitive burden on a user for navigating to an object, thereby creating a more efficient human-machine interface. For battery-operated computing devices, enabling a user to navigate to an object faster and more efficiently conserves power and increases the time between battery charges.

At 910 of method 900, the computer system detects, via at least one sensor of the one or more sensors, a plurality of objects (e.g., as described above in relation to method 700) in a physical environment.

At 920 of method 900, the computer system displays, via the display generation component, a representation of the physical environment including the plurality of objects.

At 930 of method 900, the computer system, after displaying the representation of the physical environment including the plurality objects, displays, via the display generation component, a plurality of user interface objects (e.g., selectable user interface objects and/or affordances) including: a first user interface object (626a, 626b, 626c) corresponding to a first object type (e.g., people, animals, police officers, electronic devices, lanes, buildings, shops, restaurants, and/or parking spots); and a second user interface object (626a, 626b, 626c) corresponding to a second object type different from the first object type;

At 940 of method 900, the computer system receives, via at least one sensor of the one or more sensors, a set of one or more user inputs, the set of one or more user inputs including an input (627a, 627b. 627c) directed to the plurality of user interface objects. In some examples, receiving the user input corresponding to selection of the first affordance or the second affordance includes detecting, via a microphone of the one or more sensors components, an audio instruction. In some examples, receiving the user input corresponding to selection of the first affordance or the second affordance includes detecting, via the display generation component, a touch input. In some examples, receiving the user input corresponding to selection of the first affordance or the second affordance includes detecting, via a camera of the one or more sensors, a gesture performed by a user. In some examples, receiving the user input corresponding to selection of the first affordance or the second affordance included detecting, via a hardware component (e.g., a button and/or a rotatable input mechanism), user input).

At 950 of method 900, the computer system, while displaying the representation of the physical environment including the plurality of objects, in response to receiving the set of one or more user inputs, and in accordance with a determination that the input was directed to the first user interface object, emphasizes (650a, 630a, 672a) (e.g., as described above in relation to method 700) a first set of one or more objects in the plurality of objects (e.g., without emphasizing a set of objects in the plurality of objects that have a different object type than the first object type), wherein the first set of one or more objects are the first object type. In some examples, in accordance with a determination that the input was directed to the first user interface object, the computer system displays an indication that a particular object (e.g., in the first set of objects) is of the first object type.

At 960 of method 900, the computer system, while displaying the representation of the physical environment including the plurality of objects, in response to receiving the set of one or more user inputs, and in accordance with a determination that the input was directed to the second user interface object, emphasizes (e.g., as described above in relation to method 700) a second set of one or more objects in the plurality of objects (e.g., without emphasizing a set of objects in the plurality of objects that have a different object type than the second object type), wherein the second set of one or more objects are the second object type. In some examples, in accordance with a determination that the input was directed to the second user interface object, the computer system displays an indication that a particular object (e.g., in the second set of objects) is of the second object type.

Selecting a type of object and then emphasizing detected objects of the type provides a user with control over a computer system to see which objects are in proximity, which provides additional control options without cluttering the user interface with additional displayed controls.

In some examples, the representation of the physical environment is a computer-generated representation, and wherein the computer-generated representation is generated based on data detected via at least one sensor of the one or more sensors. In some examples, the representation of the physical environment is not a live feed and/or has been augmented by the computer system to show less details than a live feed of the physical environment (e.g., detected by a camera sensor and/or another sensor) would include.

Displaying a computer-generated representation that is generated based on data detected via at least one sensor of one or more sensors provides a user with a representation of what is near a computer system, which provides additional control options without cluttering the user interface with additional displayed controls.

In some examples, the plurality of objects includes a third set of objects that are a third object type. In such examples, the computer system: in response to detecting the set of one or more inputs: in accordance with a determination that the input was directed to the first user interface object, ceases to display the third set of one or more objects in the plurality of objects while emphasizing the first set of one or more objects in the plurality of objects.

Ceasing to display a third set of one or more objects in a plurality of objects while emphasizing a first set of one or more objects in the plurality of objects in response to detecting an input provides a user with less distractions when viewing objects of a particular type, which provides additional control options without cluttering the user interface with additional displayed controls.

In some examples, the plurality of objects includes a fourth set of objects that are a fourth object type. In such examples, the computer system: in response to detecting the set of one or more inputs: in accordance with a determination that the input was directed to the first user interface object, continues to display the fourth set of one or more objects in the plurality of objects while emphasizing the first set of one or more objects in the plurality of objects. In some examples, the fourth set of one or more objects are de-emphasized relative to the first set of one or more objects in accordance with a determination that the input was directed to the first user interface object.

Continuing to display a fourth set of one or more objects in the plurality of objects while emphasizing a first set of one or more objects in the plurality of objects in response to detecting an input provides a user with less distractions when viewing objects of a particular type, which provides additional control options without cluttering the user interface with additional displayed controls.

In some examples, the first object type or the second object type corresponds to a predefined location in the physical environment (e.g., as described above in relation to method 700).

Emphasizing detected objects corresponding to predefined locations in response to detecting an input provides a user with control over a computer system to see which objects are in proximity, which provides additional control options without cluttering the user interface with additional displayed controls.

In some examples, the first object type or the second object type corresponds to one or more people (e.g., as described above in relation to method 700).

Emphasizing detected people in response to detecting an input provides a user with control over a computer system to see which people are in proximity, which provides additional control options without cluttering the user interface with additional displayed controls.

In some examples, the first object type or the second object type corresponds to a type of electronic device (e.g., as described above in relation to method 700).

Emphasizing detected electronic devices of a particular type in response to detecting an input provides a user with control over a computer system to see which electronic devices of the particular type are in proximity, which provides additional control options without cluttering the user interface with additional displayed controls.

In some examples, the first object type or the second object type corresponds to a type of symbol (e.g., a sign, a marking, such as a lane, boundary, and/or crosswalk, a hazardous materials symbol, a recycling symbol, and/or a utility symbol) in the physical environment (e.g., as described above in relation to method 700).

Emphasizing detected symbols of a particular type in response to detecting an input provides a user with control over a computer system to see which symbols of the particular type are in proximity, which provides additional control options without cluttering the user interface with additional displayed controls.

In some examples, the computer system: after receiving the set of one or more user inputs and while displaying the representation of the physical environment including the plurality of objects, detects a respective input directed to a first object in plurality of objects; and in response to detecting the respective input: in accordance with a determination that the first object was emphasized when the respective input was detected, performs an operation corresponding to the first object (e.g., navigating to and/or following the selected object (e.g., as described above in relation to method 700) and/or displaying a selectable user interface object for navigating to the object and a selectable user interface for following the selected object e.g., as described above in relation to method 700)); and in accordance with a determination that the first object was not emphasized when the respective input was detected, forgoes performance of the operation.

Performing an operation corresponding to an emphasized object in response to detecting an input provides a user with control over a computer system to conditionally perform operations, which provides additional control options without cluttering the user interface with additional displayed controls and performs an operation when a set of conditions has been met without requiring further user input.

Note that details of the processes described above with respect to method 900 (e.g., FIG. 9) are also applicable in an analogous manner to the methods described above. For example, method 700 optionally includes one or more of the characteristics of the various methods described above with reference to method 800. For example, the first set of one or more objects of method 900 can include the object emphasized in method 800. For brevity, these details are not repeated below.

FIGS. 10A-10C illustrate exemplary user interfaces for manipulating a physical input mechanism using computer system 1000 in accordance with some embodiments. The user interfaces in these figures are used to illustrate the processes described below, including the processes in FIGS. 11 and 12. Such user interfaces illustrate a user performing gestures and causing rotatable input mechanism 1002 of computer system 1000 to rotate. In some examples, such gestures do not make physical contact with rotatable input mechanism 1002 but instead are made in the air as illustrated on the right side of FIG. 10A. For example, person 1030 can make a downward gesture, and computer system 1000 can detect the downward gesture to cause rotatable input mechanism 1002 to rotate in a direction corresponding to the downward gesture. In such an example, the downward gesture can be detected though an electronic device worn by person 1030 and/or a camera capturing a field of view including person 1030.

As illustrated in FIG. 10A, computer system 1000 is displaying user interface 1010 with a scrollable list. To view more items in the scrollable list, person 1030 performs a downward gesture and rotatable input mechanism 1002 responds to person 1030 by scrolling the list, as illustrated in FIG. 10B. In some examples, person 1030 is only allowed to reposition rotatable input mechanism 1002 by a particular amount with such air gestures and would need to physically touch rotatable input mechanism 1002 to scroll more than the particular amount. In other examples, computer system 1000 can interpret a magnitude corresponding to a gesture to determine how much to reposition rotatable input mechanism 1002. For example, a swift gesture can be interpreted as requiring more movement than a slow or short gesture.

In some examples, other people in the physical environment are unable to control rotatable input mechanism 1002 similar to person 1030. For example, person 1040 in FIG. 10A can be attempting to scroll the list up but computer system 1000 responds to person 1030 instead of person 1040. In such an example, computer system 1000 identifies person 1030 as a particular type of person, such as a privileged user, and person 1040 as a different type of person, such as a non-privileged person. In some examples, the identification is performed based on one or more electronic devices local to person 1030 and/or 1040. For example, computer system 1000 can identify that person 1030 has a device on them that is registered to a privileged user while computer system 1000 is unable to identify person 1040.

In some examples, different people are able to control rotatable input mechanism 1002 different amounts. For example, person 1030 can have privileges to control rotatable input mechanism 1002 as much as they like while person 1040 can be limited to what they are able to do with respect to rotatable input mechanism 1002, such as limited to certain movements and/or to certain amounts of movements. In some examples, an amount of movement performed due to air gestures is measured from a point in which there was movement of another type, such as manual movement. In some examples, person 1040 can cause rotatable input mechanism 1002 to move less in a direction than person 1030. In such examples, person 1040 can cause rotatable input mechanism 1002 to rotate only 180 degrees while person 1030 can cause rotatable input mechanism 1002 to rotate more than 360 degrees. Thus, in some examples, person 1040 can be limited to causing rotatable input mechanism 1002 to rotate within only certain degrees of rotation and/or a boundary.

In some examples, computer system 1000 can detect different gestures being performed. For example, computer system 1000 can distinguish between an up and a down gesture to cause the list to either scroll up or down. In such an example, certain people that are identified by computer system 1000 might not be given permission to all gestures and instead only be able to control rotatable input mechanism 1002 in particular ways (or different gestures might have the same effect for certain users while other users would have different effects with different gestures, such as moving more or even entirely different operations such as turning off).

For another example, computer system 1000 can distinguish between a finger pointing (as illustrated in FIG. 10B) and a first (as illustrated in FIG. 10C. In such an example, a different user can have different permissions to use different gestures for controlling rotatable input mechanism 1002. As illustrated in FIG. 10C, person 1030 is performing a first gesture, which causes the button on side of computer system 1000 to be pressed.

In some examples, some gestures are not recognized by computer system 1000 and do not result in any movement. In some examples, distance from rotatable input mechanism 1002 is taken into account for whether movement is made based on a gesture. For example, a gesture can be detected but computer system 1000 chooses not to move rotatable input mechanism 1002 because the gesture occurred too far away from computer system 1000. In some examples, a context of rotatable input mechanism 1002 and/or computer system 1000 determines whether a gesture is able to cause movement. For example, computer system 1000 can be worn on a person's wrist while they are moving. In such an example, non-physical user input detected to move rotatable input mechanism 1002 would not be processed while the person is moving.

While the above discusses with respect to a rotatable input mechanism, it should be recognized that other devices can be manipulated with user inputs that do not make physical contact. For example, a window in the home, an autonomous device such as a vacuum, a vehicle, or any other device capable of moving on its own.

FIG. 11 is a flow diagram illustrating a method for gesture-based repositioning using a computer system in accordance with some embodiments. Method 1100 is performed at a computer system (e.g., 100, 300, 500, 600, and/or 1000) that is in communication with a display generation component (e.g., display screen, a touch-sensitive display) (in some examples, the computer system is a watch, a fitness tracking device, a phone, a tablet, a processor, a head-mounted display (HMD) device, and/or a personal computing device) and one or more sensors (e.g., a microphone, a camera, a radar, a lidar, a touch-sensitive display, and/or a physical button) (in some examples, a sensor of the one more sensors is the display generation component, such as a touch-sensitive display). Some operations in method 1100 are, optionally, combined, the orders of some operations are, optionally, changed, and some operations are, optionally, omitted.

As described below, method 1100 provides an intuitive way for gesture-based repositioning. The method reduces the cognitive burden on a user for repositioning a physical component, thereby creating a more efficient human-machine interface. For battery-operated computing devices, enabling a user to reposition a physical component faster and more efficiently conserves power and increases the time between battery charges.

At 1110 of method 1100, the computer system (e.g., 1000) detects, via the one or more sensors (e.g., a camera of the computer system and/or a component of a device separate from the computer system (e.g., a wearable device, such as a wrist-worn device, watch, and/or fitness-tracking device) that is being worn by a user)), a gesture (e.g., an air gesture, a point air gesture, a waiving air gesture, a pushing motion gesture, a sweeping motion gesture, a gesture where the hands of a user are coming together or going apart, a flicking air gesture, a twisting air gesture, and/or an gesture that provides a direction (e.g. left to right, up to down, and/or front to back) and/or a non-air gesture, such as a mouse click, a gaze gesture, a voice input, and/or a touch input).

At 1120 of method 1100, the computer system, in response to detecting the gesture and in accordance with a determination that a first set of one or more criteria is met, wherein the set of criteria includes a criterion that is met when a determination is made that the gesture is a particular type of gesture, causes a portion (e.g., 1002) (e.g., one or more physical components or all of the computer system) of the computer system (e.g., 1000) to move (e.g., from a first position (e.g., a first location and/or orientation) to a second position (e.g., a second location and/or orientation)) in the physical environment. In some examples, as a part of causing the computer system to move, the computer system is moved by an actuator, an arm, a level, wheels, and/or a lift and/or the computer system traverses the physical environment in a direction that is parallel to the ground.

At 1130 of method 1100, the computer system, in response to detecting the gesture and in accordance with a determination that a second set of one or more criteria is met, forgoes causing the portion of the computer system to move in the physical environment, wherein the second set of one or more criteria is different from the first set of one or more criteria. In some examples, in accordance with a determination that the second set of one or more criteria is met, the computer system stays at the same location and/or does not move in the physical environment.

Conditionally causing a portion of the computer system to move in the physical environment in response to input provides a user control of the computer system, which provides additional control options without cluttering the user interface with additional displayed controls and performs an operation when a set of conditions has been met without requiring further user input.

In some examples, the first set of one or more criteria includes a criterion that is met when a determination is made that the gesture is within a predetermined threshold distance (e.g., 0.1-10 meters) from the computer system.

Conditionally causing a portion of the computer system to move in the physical environment when within a predetermined threshold in response to input provides a user control of the computer system, which provides additional control options without cluttering the user interface with additional displayed controls and performs an operation when a set of conditions has been met without requiring further user input.

In some examples, the first set of one or more criteria includes a criterion that is met when a determination is made that the computer system is in a particular context (e.g., a particular state (e.g., the computer system is not moving and/or caused to be moved) and/or the computer system is in a particular mode (e.g., a sleep mode, a hibernate mode, a reduced power mode, a high power mode, and/or in a low power mode)).

Conditionally causing a portion of the computer system to move in the physical environment when in a particular context in response to input provides a user control of the computer system, which provides additional control options without cluttering the user interface with additional displayed controls and performs an operation when a set of conditions has been met without requiring further user input.

In some examples, detecting the gesture includes detecting a user who made the gesture, and wherein the first set of one or more criteria includes a criterion that is met when a determination is made that the user is a particular type of user (e.g., a user with permission to cause the computer system to move, an owner of the computer system, a family member and/or friend of the owner of the computer system, and/or an emergency responder, such as a police office, a fireman, and/or a medical care professional).

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, the first set of one or more criteria includes a criterion that is met when a determination is made that the portion of the computer system has moved (e.g., already moved) less than a predefined amount (e.g., a geo-fence is established surrounding an original position of the computer system (e.g., a position where the computer system is at for a predetermined period of time (e.g., 1-10 minutes), a position to which the computer system navigated and/or was placed at, and/or a position at which the computed system was located before being moved based on an air gesture) (e.g., an area surrounding the computer system and/or a bounding box, where the computer system can move no more than a predetermined distance (e.g., 1-5 meters)). In some examples, the size of the geo-fence is based on the location at which the computer system was in before the air gesture was detected. In some examples, the size of the geo-fence is based on the time that the air gesture was detected (e.g., computer system could be caused to move more in the day than at night).

Conditionally causing a portion of the computer system to move in the physical environment a predefined amount in response to input provides a user control of the computer system, which provides additional control options without cluttering the user interface with additional displayed controls and performs an operation when a set of conditions has been met without requiring further user input.

In some examples, in response to detecting the gesture: in accordance with a determination that a third set of one or more criteria is met, wherein the third set of one or more criteria is different from the first and second set of one or more criteria: in accordance with a determination that the gesture corresponds to a first direction, causing the portion of the computer system to move in the first direction; and in accordance with determination that the gesture corresponds to a second direction that is different from the first direction, causing the portion of the computer system to move in the second direction. In some examples, the second direction is opposite to the first direction.

Conditionally causing a portion of the computer system to move in the physical environment in response to input in the direction of the input provides a user control of the computer system, which provides additional control options without cluttering the user interface with additional displayed controls and performs an operation when a set of conditions has been met without requiring further user input.

In some examples, in response to detecting the gesture: in accordance with a determination that the third set of one or more criteria is met and in accordance with a determination that the gesture corresponds to a third direction, forgoing causing the portion of the computer system to move (e.g., in the third direction) (e.g., not front and back, side to side, or some combination thereof).

Conditionally causing a portion of the computer system to move in the physical environment in a subset of directions in response to input provides a user control of the computer system, which provides additional control options without cluttering the user interface with additional displayed controls and performs an operation when a set of conditions has been met without requiring further user input.

In some examples, in response to detecting the gesture: in accordance with a determination that a fourth set of one or more criteria is met, wherein the fourth set of one or more criteria is different from the first, second, and third set of one or more criteria: in accordance with a determination that the gesture was detected for a first period of time, causing the portion of the computer system to move by a first amount (e.g., of distance and/or an amount of speed); and in accordance with a determination that the gesture was detected for a second period of time that is different from the first period of time, causing the portion of the computer system to move by a second amount (e.g., of distance and/or an amount of speed) that is different from the first amount.

Conditionally causing a portion of the computer system to move in the physical environment based on time in response to input provides a user control of the computer system, which provides additional control options without cluttering the user interface with additional displayed controls and performs an operation when a set of conditions has been met without requiring further user input.

In some examples, the computer system, in response to detecting the gesture: in accordance with a determination that a fifth set of one or more criteria is met, wherein the fifth set of one or more criteria is different from the first, second, third, and fourth set of one or more criteria: in accordance with a determination that the gesture is a first type of gesture (e.g., a pushing motion air gesture, a sweeping motion air gesture, and/or an air gesture that increase and/or decreases the distance between a user's hands), causes the portion of the computer system to move (e.g., moved laterally (e.g., along the ground, along a floor, and/or along a table) from a respective position) to a first position in the physical environment; and in accordance with a determination that the gesture is a second type of gesture that is different from the first type of gesture, causes the portion of the computer system to move to a second position (e.g., and/or location) in the physical environment that is different from the first position.

Conditionally causing a portion of the computer system to move in the physical environment based on type of gesture in response to input provides a user control of the computer system, which provides additional control options without cluttering the user interface with additional displayed controls and performs an operation when a set of conditions has been met without requiring further user input.

In some examples, the computer system is in communication with a wearable device, and wherein the gesture is detected by one or more sensors (e.g., via one or more sensors (e.g., accelerometers, gyroscopes, and/or heart rate sensors) of the wearable device.

In some examples, the computer system is in communication with a camera (e.g., a telephoto, wide-angel, ultra-wide-angle camera), and wherein the gesture is detected via the camera (e.g., detected in the field-of-view of the camera).

Note that details of the processes described above with respect to method 1100 (e.g., FIG. 11) are also applicable in an analogous manner to the methods described below. For example, method 1200 optionally includes one or more of the characteristics of the various methods described above with reference to method 1100. For example, the criterion of method 1200 can be included in the set of criteria of method 1100. For brevity, these details are not repeated below.

FIG. 12 is a flow diagram illustrating a method for identity-based repositioning using a computer system in accordance with some embodiments. Method 1200 is performed at a computer system (e.g., 100, 300, 500, 600, and/or 1000) that is in communication with a display generation component (e.g., display screen, a touch-sensitive display) (in some examples, the computer system is a watch, a fitness tracking device, a phone, a tablet, a processor, a head-mounted display (HMD) device, and/or a personal computing device) and one or more sensors (e.g., a microphone, a camera, a radar, a lidar, a touch-sensitive display, and/or a physical button) (in some examples, a sensor of the one more sensors is the display generation component, such as a touch-sensitive display). Some operations in method 1200 are, optionally, combined, the orders of some operations are, optionally, changed, and some operations are, optionally, omitted.

As described below, method 1200 provides an intuitive way for identity-based repositioning. The method reduces the cognitive burden on a user for repositioning a physical component, thereby creating a more efficient human-machine interface. For battery-operated computing devices, enabling a user to reposition a physical component faster and more efficiently conserves power and increases the time between battery charges.

At 1210 of method 1200, the computer system, while the computer system is at a first position in a physical environment, detects, via the one or more sensors (e.g., a camera of the computer system and/or a component of a device separate from the computer system (e.g., a wearable device, such as a wrist-worn device, watch, and/or fitness-tracking device) that is being worn by a user)), a gesture (e.g., gesture discussed above in relation to FIG. 10C) (e.g., an air gesture, a point air gesture, a waiving air gesture, a pushing motion gesture, a sweeping motion gesture, a gesture where the hands of a user are coming together or going a part, a flicking air gesture, a twisting air gesture, and/or an gesture that provides a direction (e.g. left to right, up to down, and/or front to back) and/or a non-air gesture, such as a tap input, a mouse click, a touch input, and/or a voice input).

At 1220 of method 1200, the computer system, in response to detecting the gesture and in accordance with a determination that a first set of one or more criteria is met, causes a portion (e.g., 1002) of the computer system (e.g., 1000) to move from the first position (e.g., a first location and/or orientation) to a second position (e.g., a second location and/or orientation) within the physical environment, wherein the second position is different from the first position, and wherein the first set of one or more criteria includes a criterion that is met when a determination is made that a first user (e.g., 1030 and/or 1040) is detected (e.g., to perform the gesture and/or detected within a predetermined distance from the computer system).

At 1230 of method 1200, the computer system, in response to detecting the gesture and in accordance with a determination that a second set of one or more criteria is met, forgoes causing the portion (e.g., 1002) of the computer system (e.g., 1000) to move from the first position to the second position, wherein the second set of one or more criteria includes a criterion that is met when a determination is made that a second user (e.g., 1030 and/or 1040) is detected (e.g., to perform the gesture and/or detected within a predetermined distance from the computer system), wherein the second user (e.g., 1040) is different from the first user (e.g., 1030), and wherein the second set of one or more criteria is different from the first set of one or more criteria. In some examples, in accordance with a determination that the second set of one or more criteria is met, the computer system is caused to be moved from the first position to a third position (e.g., a third location and/or orientation) within the physical environment (e.g., without being caused to move to the second position). In some examples, the third position is less distant (or more distant) (e.g., angular distance and/or straight-line distance) from the first position than the second position). In some examples, in accordance with a determination that the second set of one or more criteria is met, the computer system is not caused to be moved at all.

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, the computer system, in response to detecting the gesture: in accordance with a determination that a third set of one or more criteria is met, causes the portion of the computer system to move from the first position (e.g., a first location and/or orientation) to a third position (e.g., a second location and/or orientation) within the physical environment, wherein the distance between the third position and the first position is less than the distance between the second position and the first position, wherein the third set of one or more criteria includes a criterion that is met when a determination is made that the second user is a first type of user, and wherein the third set of one or more criteria is different from the first and second set of one or more criteria.

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, the computer system, in response to detecting the gesture: in accordance with a determination that a fourth set of one or more criteria is met, forgoes causing the computer system to move (e.g., to be moved at all), wherein the fourth set of one or more criteria includes a criterion that is met when a determination is made that the second user is a second type of user that is different from the first type of user, and wherein the fourth set of one or more criteria is different from the first, second, and third set of one or more criteria.

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, the second position is in a first direction from the first position, and wherein the first direction was selected from a subset of predefined directions (e.g., only front to back, back to front, side to side, or some combination thereof).

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, the second position is in a second direction from the first position, and wherein: in response to detecting the gesture: in accordance with a determination that a fifth set of one or more criteria is met, the second direction was selected from a first set of one or more predefined directions, wherein the fifth set of criteria includes a criterion that is met when a determination is made that the first user is a third type of user (e.g., has a first set of permission, an owner, a family member, friend, and/or associated of an owner and/or as described in relation to method 1100), and wherein the fifth set of one or more criteria is different from the first, second, third, and fourth set of one or more criteria; and in accordance with a determination that a sixth set of one or more criteria is met, the second direction was selected from a second set of one or more predefined directions, wherein the second set of one or more predefined directions is smaller than the first set of one or more predefined directions, wherein the fifth set of criteria includes a criterion that is met when a determination is made that the first user is a fourth type of user (e.g., has a first set of permission, an owner, a family member, friend, and/or associated of an owner and/or as described in relation to method 1100) that is different from the third type of user, and wherein the sixth set of one or more criteria is different from the first, second, third, fourth, and fifth set of one or more criteria.

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, the computer system, while the computer system is at the first position in the physical environment, detects, via the one or more sensors, a second gesture (e.g., an air gesture, a point air gesture, a waiving air gesture, a pushing motion gesture, a sweeping motion gesture, a gesture where the hands of a user are coming together or going a part, a flicking air gesture, a twisting air gesture, and/or an gesture that provides a direction (e.g. left to right, up to down, and/or front to back)); and in response to detecting the second gesture, causes the computer system to move from the first position to a fourth position, irrespective of whether the second gesture was detected to be performed by the first user or the second user. In some examples, the fourth position is different from the first position, second position, and/or third position.

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, the computer system, while the computer system is at the first position in the physical environment, detects, via the one or more sensors, a third gesture (e.g., an air gesture, a point air gesture, a waiving air gesture, a pushing motion gesture, a sweeping motion gesture, a gesture where the hands of a user are coming together or going a part, a flicking air gesture, a twisting air gesture, and/or an gesture that provides a direction (e.g. left to right, up to down, and/or front to back)) that is a different type of gesture than the gesture; and in response to detecting the third gesture: in accordance with a determination that a seventh set of one or more criteria is met, causes the computer system to move from the first position to the second position, wherein the seventh set of one or more criteria includes a criterion that is met when a determination is made that the first user is a fifth type of user, and wherein the seventh set of one or more criteria is different from the first, second, third, fourth, fifth, and sixth set of one or more criteria; and in accordance with a determination that an eighth set of one or more criteria is met, causes the computer system to move from the first position to a fifth position, wherein the fifth position is different from the second position, wherein the eighth set of one or more criteria includes a criterion that is met when a determination is made that the first user is a sixth type of user that is different from the fifth type of user, and wherein the eighth set of one or more criteria is different from the first, second, third, fourth, fifth, sixth, and seventh set of one or more criteria.

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, one or more of the first user and the second user was detected based on an electronic device (e.g., a wearable device, a smartphone, a smartwatch, a fitness tracking device, and/or a finger-worn device) being detected in a direction of the gesture.

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, in response to detecting the third gesture: in accordance with a determination that a ninth set of one or more criteria is met, the second position is a first distance away from the first position, wherein the ninth set of one or more criteria includes a criterion that is met when a determination is made that a respective type of electronic device is within a predetermined distance from the first user, and wherein the ninth set of one or more criteria is different from the first, second, third, fourth, fifth, sixth, seventh, and eighth set of one or more criteria; and in accordance with a determination that a tenth set of one or more criteria is met, the second position is a second distance away from the first position, wherein the first distance away from the first position is greater than the second distance away from the second position, wherein the tenth set of one or more criteria includes a criterion that is met when a determination is made that the respective type of electronic device is not within a predetermined distance from the first user, and wherein the tenth set of one or more criteria is different from the first, second, third, fourth, fifth, sixth, seventh, eighth, and ninth set of one or more criteria.

Conditionally causing a portion of the computer system to move in the physical environment in response to input from particular person provides a user control of the computer system, which provides additional control options without cluttering the user interface with additional displayed controls and performs an operation when a set of conditions has been met without requiring further user input.

In some examples, the computer system is in communication with a wearable device (e.g., a fitness tracking device, a wrist-worn device, a finger-worn device), and wherein the gesture is detected by one or more sensors (e.g., via one or more sensors (e.g., accelerometers, gyroscopes, and/or heart rate sensors) of the wearable device.

In some examples, the computer system is in communication with a camera, and wherein the gesture is detected via the camera.

Note that details of the processes described above with respect to method 1200 (e.g., FIG. 12) are also applicable in an analogous manner to the methods described above. For example, method 1100 optionally includes one or more of the characteristics of the various methods described above with reference to method 1200. For example, the criterion of method 1100 can be included in the set of criteria of method 1200. For brevity, these details are not repeated above.

FIGS. 13A-13G illustrate exemplary user interfaces for navigating in a physical environment in accordance with some embodiments. The user interfaces in these figures are used to illustrate the processes described below, including the processes in FIGS. 14 and 15. Through the user interfaces, user input is illustrated using a circular shape with dotted lines (e.g., user input 1317a in FIG. 13A). It should be recognized that the user input can be any type of user input, including a tap on touch-sensitive screen, a button press, a gaze toward a control, a voice request with an identification of a control, a gesture made by a user and captured by a camera, and/or any other affirmative action performed by a user. In some examples, a single representation of a user input in a FIG. 1) includes one or more different types of user input and/or (2) represents different types of user input to result in different operations. For example, a single illustrated user input can be a tap input, a tap-and-hold input, and/or a swipe gesture.

FIG. 13A illustrates exemplary user interface 1310 for navigating to a destination using computer system 600 in accordance with some embodiments. User interface 1310 includes multiple portions, including instruction portion 1312, map portion 1314, and options portion 1316. It should be recognized that user interface 1310 can include more or fewer user interface elements than illustrated in FIG. 13A. For example, user interface 1310 can include additional portions for providing additional information and/or controls and/or not include one or more portions.

Instructions portion 1312 can provide a navigation instruction while navigating to the destination. For example, the navigation instruction illustrated in FIG. 13A is “proceed forward,” indicating that computer system 600 should proceed forward to continue on a current path to the destination.

In some examples, a navigation instruction in instructions portion 1312 is informative to a user and is intended to be used by the user to navigate computer system 600 and/or a mode of transportation being used by the user (e.g., a vehicle, walking, swimming, or taking public transportation). In other examples, the navigation instruction is used by computer system (or sent to another computer system as a request to perform an action) to navigate a physical environment without user input.

Maps portion 1322 can include a live camera feed and/or a map of a physical environment. In some examples, the map includes one or more objects in the physical environment. For example, the map illustrated in FIG. 13A includes road 1322a, representing a road in the physical environment. In some examples, the one or more objects are included in the map and determined to be displayed based on a location determined for computer system 600. For example, computer system 600 can identify a current location of computer system 600 (e.g., via a GPS or other location service) and select a portion of a map corresponding to the current location. In such an example, the map includes objects that are determined to be located in a portion of the physical environment that corresponds to the portion of the map. In some examples, one or more objects included in the map and/or maps portion 1322 are detected via one or more sensors in communication with computer system 600. For example, a camera, lidar, radar, and/or one or more other sensors that are capturing data with respect to a physical environment can identify a nearby object and computer system 600 can place the nearby object in the map and/or maps portion 1322 in a position determined by the sensors. In some examples, representations of objects are computer-generated to look different from the actual objects (e.g., are generalized and/or generated with less detail) and added to the map. In some examples, the objects can be navigated to by a user of computer system 600. For example, a building can be detected using a camera and a user of computer system 600 can navigate to the building based on instructions displayed by computer system 600. For another example, a vehicle can be detected using a camera and a user of computer system 600 can navigate to the vehicle based on instructions displayed by computer system 600 even as the vehicle moves (e.g., navigation can be updated as the vehicle moves).

As illustrated in FIG. 13A, maps portion 1322 includes representation 1322c of computer system 600, representing a current location of computer system 600. In some examples, the current location is determined by computer system 600 or by a device communicating with computer system 600 (e.g., via a GPS or other location service). In addition to representation 1322c, maps portion 1322 includes path 1322b, representing a path for a user of computer system 600 to take to reach the destination. The path can be distinguished from other parts of the map, such as other areas for which a user of computer system 600 should not or will not follow to get to the destination (e.g., as shown by the portion of road 1322a that is behind representation 1322c).

Options portion 1316 can include information and/or selectable user interface elements to aid in navigation to the destination. As illustrated in FIG. 13A, options portion 1316 includes an estimated arrival time and multiple controls to provide additional functionality (e.g., parking control 1316a and pause control 1316b).

In some examples, selection of parking control 1316a either causes display of different predefined location options (e.g., as illustrated in FIG. 13B) and/or navigation to a predefined location without user input needing to select a particular predefined location (e.g., as illustrated in FIG. 13C). Example of predefined locations include parking spots, structures (e.g., a building or other permanent structure), roads, intersections, and/or locations in which are included in a destination database as a possible destination before receiving user input with respect to options portion 1316. It should be recognized that navigation to a predefined location can include identifying an area for which computer system 1300 is located, identifying one or more predefined locations in the area, detecting a current state of the one or more predefined locations using one or more sensors in communication with computer system 1300, and selecting a predefined location from the one or more predefined locations to navigate to based on the current state of the physical environment.

In some examples, selection of pause control 1316b causes navigation to a non-predefined location in the physical environment. Example of non-predefined locations include portions of a road, temporary parking areas, areas not corresponding to a defined location to stop, and/or locations in which are not included in a destination database as a destination before receiving user input with respect to pause control 1316b. It should be recognized that navigation to a non-predefined location includes detecting a current state of a physical environment using one or more sensors in communication with computer system 1300 and identifying a location within the current state.

In some examples, a difference between a predefined location and a non-predefined location is that the predefined location is designated as a first type of area (e.g., a parking area) whereas a non-predefined location is designated as a second type of area (e.g., a place to temporarily stop). In some examples, selecting a predefined location starts with a list of possible predefined locations based on a location where computer system is located (e.g., the list is not determined using one or more sensors detecting objects in the physical environment but rather from a map or other data structure that includes predefined locations that are nearby). In such examples, designating a non-predefined location starts with detecting objects in the physical environment to identify a list of possible non-predefined locations with respect to the objects detected in the physical environment.

FIG. 13A illustrates multiple user inputs selecting different controls in options portion 1316. For example, user input 1317a is selecting parking control 1316a and user input 1317b is selecting pause control 1316b. It should be recognized that both controls were shown selected for brevity and that user interface 1310 can be configured to only allow a single control to be selected at a time. In some examples, computer system 1300 detecting user input 1317a causes computer system 600 to transition to display of the user interface illustrated in FIGS. 13B or 13C and computer system 600 detecting user input 1317b causes computer system 600 to transition to display of the user interface illustrated in FIG. 13D, as further discussed below. In some examples, detecting a first type of user input to select parking control 1316a causes transition to the user interface illustrated in FIG. 13B. An example of the first type of user input is a gesture to view more information (e.g., a tap-and-hold gesture). In such examples, detecting a second type of user input to select parking control 1316a causes transition to the user interface illustrated in FIG. 13C. An example of the second type of user input is a selection gesture (e.g., a tap). In some examples, pause control 1316b responds the same way to any type of input directed to pause control 1316b (e.g., whether the input is the first type or the second type).

FIG. 13B illustrates exemplary user interface 1310 for viewing available parking spots while navigating to a destination using computer system 600 in accordance with some embodiments. In some examples, user interface 1310 of FIG. 13B is the user interface depicted in FIG. 13A after selection of parking control 1316a. In other examples, user interface 1310 of FIG. 13B is a different user interface that is displayed in response to selection of parking control 1316a.

As illustrated in FIG. 13B, parking control 1316a has been replaced by stop control 1316c. In some examples, selection of stop control 1316c causes user interface 1310 to revert back to the state in FIG. 13A, such that parking spots are no longer emphasized.

In addition to stop control 1316c, the map in map portion 1314 has been updated in FIG. 13B to include representations of parking spots detected via one or more sensors in communication with computer system 600. In such examples, computer system 600 can be in communication with a camera, lidar, radar, and/or other sensor that is capable of detecting a parking spot in the physical environment. After detection, a representation of the parking spot is placed into the map to represent the parking spot. In some examples, the representation of the parking spot is a computer-generated representation of the parking spot based on data detected by the one or more sensors. In such examples, the representation can include less detail than the actual parking spot such that the representation is a generalized representation of the parking spot. In other examples, the representation of the parking spot is included in a live camera feed (e.g., the live camera feed is of the parking spot) and user input is detected with respect to the live camera feed for selecting a parking spot.

In some examples, the map emphasizes parking spots that are not currently taken by another vehicle. As illustrated, user interface 1310 in FIG. 13B includes two representations of parking spots (e.g., parking spots 1318 and 1320) that are available. Such parking spots are emphasized via rectangles 1354a and 1358a, indicating that they are able to be navigated to by computer system 600. It should be recognized that objects can be emphasized in other ways, including different colors, patterns, and/or sizes.

FIG. 13B further illustrates user input 1321 selecting parking spot 1320, resulting in computer system 600 causing a transition to the user interface illustrated in FIG. 13C. In some examples, user input selecting a parking spot without emphasis (e.g., parking spot 1360) would not result in changing navigation. For example, nothing can occur or an error or warning message can be displayed when selecting a parking spot without emphasis.

FIG. 13C illustrates exemplary user interface 1310 for navigating to parking spot 1320 using computer system 600 in accordance with some embodiments. In some examples, user interface 1310 in FIG. 13C is displayed in response to selection of parking control 1316a in FIG. 13A or parking spot 1320 in FIG. 13B.

As illustrated in FIG. 13C, stop control 1316c is displayed at a location where parking control 1316a was displayed in FIG. 13A. In some examples, selection of stop control 1316c causes navigation to parking spot 1320 to be canceled. In some examples, selection of stop control 1316c also causes navigation to begin again to the destination at the time that parking control 1316a was selected.

As illustrated in FIG. 13C, path 1314c from representation 1314b of computer system 600 is updated to navigate to parking spot 1320. In some examples, before being updated, path 1314c was leading to a different destination (e.g., as illustrated in FIG. 13B). In some examples, path 1314c in FIG. 13C includes a different visual characteristic (e.g., color, pattern, or other visual characteristic not related to an area of the map that includes path 1314c) than path 1314c in FIGS. 13A-13B. For example, path 1314c in FIGS. 13A-13B can be a first color and path 1314c in FIG. 13C can be a second color different from the first color.

As illustrated in FIG. 13C, parking spot 1320 is emphasized but other parking spots are not emphasized (e.g., parking spot 1318 is not emphasized). In some examples, selecting a parking spot causes other parking spots to no longer be emphasized.

In some examples, navigating to a parking spot is based on one or more other vehicles detected in proximity to the parking spot. For example, a vehicle can be detected as being parked forward in the parking spot. In such an example, navigating to a parking spot can be such that a user of computer system 600 navigates in a similar direction as the vehicle. In other examples, navigating to a parking spot is based on a user preference when parking, such as a user preference when parking a particular type of parking spot as opposed to another type of parking spot. For example, computer system 600 can identify a user preference to park backwards into a spot. In such an example, navigating to parking spot 1354 can be such that a user of computer system 600 navigates backwards in the parking spot.

FIG. 13D illustrates exemplary user interface 1310 for navigating to a non-predefined location (e.g., a location next to road 1314a) using computer system 600 in accordance with some embodiments. In some examples, user interface 1310 in FIG. 13D is displayed in response to selection of pause control 1316b in FIG. 13A.

As discussed above, the non-predefined location can be selected based on a number of factors. In some examples, the non-predefined location is the closest safe area to temporarily stop for computer system 600. In such examples, objects in the physical environment are detected and the non-predefined location is identified based on the detected objects.

As illustrated in FIG. 13D, pause control 1316b is replaced with start control 1316d (e.g., start control 1316d is displayed at a location where pause control 1316b was displayed in FIG. 13A). In some examples, selection of start control 1316d causes navigation to begin again to the destination at the time that pause control 1316b was selected.

As illustrated in FIG. 13D, path 1314c from representation 1314b of computer system 600 is updated to arrive at the location next to road 1314a. In some examples, before being updated, path 1314c was leading to a different destination (e.g., as illustrated in FIG. 13A). In some examples, path 1314c in FIG. 13D includes a different visual characteristic (e.g., color, pattern, or other visual characteristic not related to an area of the map that includes path 1314c) than path 1314c in FIGS. 13A-13B. For example, path 1314c in FIGS. 13A-13B can be a first color and path 1314c in FIG. 13D can be a second color different from the first color. In such examples, the different visual characteristic for path 1314c in FIG. 13D can be the same visual characteristic that is different for path 1314c in FIG. 13C.

FIG. 13E illustrates exemplary user interface 1310 for requesting to change lanes while navigating to a destination using computer system 600 in accordance with some embodiments. In some examples, user interface 1310 in FIG. 13E is the same user interface illustrated in FIG. 13A.

While not illustrated, maps portion 1314 in FIG. 13E can include representations of different lanes for a current road (e.g., similar to the multiple lanes illustrated in FIG. 13F) instead of a representation of a single lane. It should be recognized that the map can include more or fewer lanes (e.g., a number of lanes that a current location has) and each individual lane can appear different (e.g., lanes that not currently being used can be smaller (e.g., thinner) than a lane currently being used). In some examples, the representations of different lanes are computer generated such that each lane is a computer-generated representation. In other examples, the representations of different lanes are a part of a live camera feed (e.g., the live camera feed is of the different lanes) and user input is detected with respect to the live camera feed for selecting a lane.

FIG. 13E illustrates user input 1315, starting at a location on left side of maps portion 1314 and going to the right. For example, user input 1315 is can be a swipe gesture (e.g., a tap-and-hold gesture) going from left to right. In some examples, user input 1315 corresponds to a request to change lanes for a current navigation to a lane to the right. In some examples, user input in the opposite direction (e.g., from right to left) corresponds to a request to change lanes for a current navigation to a lane to the left. In some examples, user input 1315 begins at a different location that illustrated and still goes to the right, indicating a request to change to a lane to the right.

When there is an acceptable lane in the direction of user input, computer system 600 updates a navigation to use the acceptable lane, as further discussed below with respect to FIG. 13F. In examples where there is not an acceptable lane in the direction of user input, computer system 600 determines whether there is another acceptable maneuver (e.g., a turn) in that direction. If there is an acceptable maneuver, the user input corresponds to a request to change a current navigation to take the acceptable maneuver instead of continuing to go straight, as further discussed below with respect to FIG. 13G. In some examples, other gestures can be used to control navigation, such as a U-shaped gesture can cause a U-turn to be added to the navigation in response to detecting the U-shaped gesture.

FIG. 13F illustrates exemplary user interface 1310 for changing lanes while navigating to a destination using computer system 600 in accordance with some embodiments. In some examples, user interface 1310 in FIG. 13F is the same user interface illustrated in FIG. 13E and is displayed in response to computer system 600 detecting user input 1315 in FIG. 13E.

As illustrated in FIG. 13F, maps portion 1314 includes representations of different lanes for a current road instead of a representation of a single lane. It should be recognized that the map can include more or fewer lanes (e.g., a number of lanes that a current location has) and each individual lane can appear different (e.g., lanes that not currently being used can be smaller (e.g., thinner) than a lane currently being used). In some examples, the representations of different lanes are computer generated such that each lane is a computer-generated representation. In other examples, the representations of different lanes are a part of a live camera feed (e.g., the live camera feed is of the different lanes) and user input is detected with respect to the live camera feed for selecting a lane.

FIG. 13F illustrates path 1314c changing from left lane 1314a1 to right lane 1314a2. In some examples, the change occurs in response to detecting user input 1315. In such examples, computer system 600 determines that there is an acceptable lane to the right and changes the navigation accordingly. In some examples, user input 1315 not only causes the navigation to change but also causes maps portion 1314 to include representations of multiple lanes in the map (e.g., left lane 1314a1 and right lane 1314a2. In such examples only a current road is expanded to display different lanes and other roads (e.g., road 1314a3) are not expanded to display different lanes even other road 1314a3 has other lanes.

In some examples, changing lanes does not change the destination being navigated to but rather how to get to the destination. For example, path 1314c changing from left lane 1314a1 to right lane 1314a2 can change navigation to take a different route to the destination.

FIG. 13F illustrates user input 1317, starting at a location on left side of maps portion 1314 and going to the right. For example, user input 1317 can be a swipe gesture (e.g., a tap-and-hold gesture) going from left to right. In some examples, user input 1317 corresponds to a request to change lanes for a current navigation to a lane to the right. In some examples, user input in the opposite direction (e.g., from right to left) corresponds to a request to change lanes for a current navigation to a lane to the left (e.g., changing back to left lane 1314a1).

When there is an acceptable lane in the direction of user input 1317, computer system 600 updates a navigation to use the acceptable lane. In the case of FIG. 13F, representation 1314b is already located in far right lane. Accordingly, there is not an acceptable lane in the direction of user input 1317 and computer system 600 instead determines whether there is an acceptable turn in that direction. If there is an acceptable turn, user input 1317 corresponds to a request to change a current navigation to take the acceptable turn instead of continuing on road 1314a. As depicted in FIG. 13F, other road 1314a3 is an acceptable turn that is not currently included in the navigation. In response to detecting user input 1317, computer system 600 updates the navigation to take other road 1314a3, as further discussed below with respect to FIG. 13G.

FIG. 13G illustrates exemplary user interface 1310 for turning right while navigating to a destination using computer system 600 in accordance with some embodiments. In some examples, user interface 1310 in FIG. 13G is the same user interface illustrated in FIG. 13F and is displayed in response to computer system 600 detecting user input 1317 in FIG. 13G.

As illustrated in FIG. 13G, maps portion 1314 no longer includes representations of different lanes for a current road (e.g., as illustrated in FIG. 13F) in the map and instead includes a representation of a single lane (e.g., road 1314a). In some examples, such change occurs after changing lanes and/or after determining to navigate to a different road. It should be recognized that the map can include more or fewer lanes (e.g., a number of lanes that a current location has) and each individual lane can appear different (e.g., lanes that not currently being used can be smaller (e.g., thinner) than a lane currently being used).

FIG. 13G illustrates path 1314c including a right turn into other road 1314a3. In some examples, the change occurs in response to detecting user input 1317. In such examples, computer system 600 determines that there is an acceptable turn to the right and changes the navigation accordingly. In some examples, adding a right turn does not change the destination being navigated to but rather how to get to the destination. For example, path 1314c changing from road 1314a to other road 1314a3 can change the navigation to take a different route to the destination.

FIG. 14 is a flow diagram illustrating a method for changing a destination using a computer system in accordance with some embodiments. Method 1400 is performed at a computer system (e.g., 100, 300, 500, 600, and/or 1000) that is in communication with a display generation component (e.g., display screen, a touch-sensitive display) (in some examples, the computer system is a watch, a fitness tracking device, a phone, a tablet, a processor, a head-mounted display (HMD) device, and/or a personal computing device) and one or more sensor components (e.g., a microphone, a camera, a radar, a lidar, a touch-sensitive display, and/or a physical button) (in some examples, a sensor component of the one more sensor components is the display generation component, such as a touch-sensitive display). Some operations in method 1400 are, optionally, combined, the orders of some operations are, optionally, changed, and some operations are, optionally, omitted.

As described below, method 1400 provides an intuitive way for changing a destination. The method reduces the cognitive burden on a user for changing a destination, thereby creating a more efficient human-machine interface. For battery-operated computing devices, enabling a user to change a destination faster and more efficiently conserves power and increases the time between battery charges.

At 1410 of method 1400, the computer system, while navigating to a destination (e.g., providing instructions (e.g., 1312) to the destination and/or a map (e.g., 1314) with a path to the destination) (and, in some examples, navigating to the destination includes causing the computer system to be moved toward the destination), displays, via the display generation component, a first user interface (e.g., 1310) that includes a representation (e.g., 1314) of a physical environment (e.g., a map, an image, a video, a three-dimensional representation, a two-dimensional representation, and/or a computer-generated representation).

At 1420 of method 1400, the computer system, while at the destination (e.g., while displaying or not displaying the representation) (e.g., while approaching the destination and/or at a location determined to be the destination), displays, via the display generation component, a plurality of user interface objects (e.g., 1316a and/or 1316b) (e.g., concurrently with the representation of the physical environment) (in some examples, the plurality of user interface objects are displayed before at the destination), including: a first user interface object (e.g., 1316a) (e.g., a selectable user interface object and/or an affordance) to navigate to a predefined location (e.g., a parking spot, a parking area, and/or a designated area) for the destination (in some examples, the predefined location is based on a current state of the physical environment, such as which predefined locations are currently occupied); and a second user interface object (e.g., 1316b) to navigate to a non-predefined location, wherein the non-predefined location (e.g., a safe area or an area that is not currently occupied) (e.g., that is different from the predefined location) is determined based on a current state of the physical environment (e.g., the number of objects/subjects in the physical environment, the number of objects/subjects in an area in the physical environment, and/or the movement of objects/subjects in the physical environment).

At 1430 of method 1400, the computer system receives, via at least one sensor component of the one or more sensor components, a set of one or more user inputs, the set of one or more user inputs including a first input (e.g., 1316a) directed to the plurality of user interface objects (in some examples, receiving the user input includes detecting, via a microphone of the one or more sensors components, an audio instruction; in some examples, receiving the user input includes detecting, via the display generation component, a touch input; in some examples, receiving the user input includes detecting, via a camera of the one or more sensor components, a gesture (e.g., an air gesture and/or input) performed by a user, in some examples, receiving the user input included detecting, via a hardware component (e.g., a button and/or a rotatable input mechanism), user input).

At 1440 of method 1400, the computer system, while displaying the representation of the physical environment, in response to receiving the set of one or more user inputs (e.g., and/or input response to detecting the first input), and in accordance with a determination that the first input was directed to the first user interface object, displays, via the display generation component, a path (e.g., 1314c in FIG. 13C) to the predefined location (e.g., without displaying a path to the non-predefined location when the first user interface object was selected). In some examples, while displaying, via the display generation component, the path to the predefined location, the first user interface object and/or the second user interface object (e.g., 1316 in FIG. 13C) continues to be displayed in accordance with a determination that the first input was directed to the first user interface object. In some examples, while displaying, via the display generation component, the path to the predefined location, the first user interface object and/or the second user interface object ceases to be displayed in accordance with a determination that the first input was directed to the first user interface object.

At 1450 of method 1400, the computer system, while displaying the representation of the physical environment, in response to receiving the set of one or more user inputs (e.g., and/or input response to detecting the first input), and in accordance with a determination that the first input was directed to the second user interface object (e.g., 1316b), displays, via the display generation component, a path to the non-predefined location (e.g., 1314c in FIG. 13D) (e.g., without displaying a path to the predefined location when the second affordance was selected). In some examples, while displaying, via the display generation component, the path to the predefined location, the first user interface object and/or the second user interface object continues to be displayed (e.g., 1316 in FIG. 13D) in accordance with a determination that the first input was directed to the second user interface object. In some examples, while displaying, via the display generation component, the path to the predefined location, the first user interface object and/or the second user interface object ceases to be displayed in accordance with a determination that the first input was directed to the second user interface object.

Displaying a first user interface object to navigate to a predefined location for a destination and a second user interface object to navigate to a non-predefined location provides a user with control over a computer system to choose to which location to navigate, which provides additional control options without cluttering the user interface with additional displayed controls.

In some examples, in accordance with a determination that the first input was directed to the first user interface object (e.g., 1316a), the path to the predefined location is displayed concurrently with the representation (e.g., 1314) of the physical environment and a representation (e.g., 1314b)) (e.g., a shape, such an arrow, a triangle, and/or a shaping having the shape (e.g., , a square and/or a circle) of the computer system) of the computer system.

In some examples, in accordance with a determination that the first input was directed to the second user interface object (e.g., 1316b), the path to the non-predefined location is displayed concurrently with the representation (e.g., 1314) of the physical environment and the representation of the computer system. In some examples, a location of the representation of the computer system is updated as the computer system changes locations and/or is moved in the physical environment. In some examples, the representation of the computer system is located at a location (e.g., a current location as detected by a sensor (e.g., GPS) of the computer system) within the representation of the physical environment.

Displaying a path to the predefined or non-predefined location with a representation of the physical environment and computer system in response to user input provides a user with over a computer system to see outcome of a choice of the user, which provides additional control options without cluttering the user interface with additional displayed controls.

In some examples, the computer system: before detecting the first input and while navigating to the destination, displays, via the display generation component, a path to the destination that is not a path to the predefined location (e.g., 1314c in FIG. 13A); and in response to detecting the first input and in accordance with a determination that the first input was directed to the first user interface object, replaces display of the path to the destination that is not a path to the predefined location with display of the path to the predefined location (e.g., 1314c in FIG. 13C), wherein the path to the destination that is not a path to the predefined location has a first visual characteristic (e.g., a set of one or more colors, highlighting, and/or a first amount of shading) (e.g., the first visual characteristic is not related to a location or position of the path) and the path to the predefined location has a second visual characteristic that is different from the first visual characteristic.

Replacing display of the path to the destination with a path to the predefined location in response to user input provides a user with control over a computer system to choose which location to navigate, which provides additional control options without cluttering the user interface with additional displayed controls. In addition, ensuring that the new path has a different visual characteristic than the old path provides a user with an understanding that there has been a change to the route, thereby performing an operation when a set of conditions has been met without requiring further user input.

In some examples, in accordance with a determination that a user of the device has a first preference (e.g., move in backwards and/or move in forwards) (e.g., a user preference is set within an application (e.g., a map application) executing by the computer system), the path to the predefined location is a first path.

In some examples, in accordance with a determination that a user of the device has a second preference that is different from the first preference (e.g., move in backwards and/or move in forwards), the path to the predefined location is a second path that is different from the first path.

Choosing a path to the predefined location based on different preferences provides a user with control over a computer system to choose which location to navigate, which provides additional control options without cluttering the user interface with additional displayed controls.

In some examples, in accordance with a determination that a set of one or more devices at the destination are in a first position (e.g., a location and/or orientation), the path to the predefined location is a third path (e.g., the same path as the first path or a different path).

In some examples, in accordance with a determination that a set of one or more devices at the destination are in a second position (e.g., a location and/or orientation) that is different from the first position, the path to the predefined location is a fourth path that is different from the third path (e.g., the same path as the second path or a different path).

Choosing a path to the predefined location based on positions of devices provides a user with control over a computer system to choose which location to navigate, which provides additional control options without cluttering the user interface with additional displayed controls.

In some examples, the computer system, before detecting the first input and while navigating to the destination, displays, via the display generation component, a path to the destination that is not a path to the non-predefined location (e.g., 1314c in FIG. 13A) (e.g., and not a path to the predefined location); and in response to detecting the first input and in accordance with a determination that the first input was directed to the second user interface object, replaces display of the path to the destination that is not a path to the non-predefined location with display of the path to the non-predefined location, wherein the path to the destination that is not a path to the non-predefined location has a third visual characteristic (e.g., a set of one or more colors and/or a first amount of shading) (e.g., the same or different visual characteristic as the first visual characteristic) and the path to the non-predefined location has a fourth visual characteristic (e.g., the same or different visual characteristic as the second visual characteristic) that is different from the third visual characteristic.

Replacing display of the path to the destination with a path to the non-predefined location in response to user input provides a user with control over a computer system to choose which location to navigate, which provides additional control options without cluttering the user interface with additional displayed controls. In addition, ensuring that the new path has a different visual characteristic than the old path provides the user with an understanding that there has been a change to the route, thereby performing an operation when a set of conditions has been met without requiring further user input.

In some examples, the computer system, while displaying the path to the non-predefined location, displays, via the display generation component, a third user interface object (e.g., 1316d). In some examples, the third user interface object is displayed in response to detecting the first input. In some examples, the third user interface object replaces the second user interface object in response to detecting the first user input. In some examples, the third user interface object has a different appearance than the second user interface object. In some examples, the computer system: while displaying the third user interface object, detects an input directed to the third user interface object; and in response to detecting the input directed to the third user interface object, replaces display of the path to the non-predefined location with display of the path to the destination that is not a path to the non-predefined location. In some examples, the second user interface object replaces the third user interface object in response to detecting the input directed to the third user interface object.

Providing the third user interface object to go back to a previous destination in response to user input provides a user with control over a computer system to choose which location to navigate, which provides additional control options without cluttering the user interface with additional displayed controls.

In some examples, the current state of the physical environment is based on a sensor of the computer system.

Determining a state of the physical environment based on a sensor of the computer system provides a user with accurate data to make a decision, thereby providing improved visual feedback to the user.

In some examples, the predefined location is selected from a group consisting of a plurality of predefined locations corresponding to the destination. In some examples, the plurality of predefined locations includes same types of predefined locations. In some examples, the plurality of predefined locations includes different types of predefined locations. In some examples, the predefined location is selected from a group consisting of a plurality of predefined location in proximity to the computer system.

Selecting the predefined location from predefined locations for a destination in response to user input provides a user with control over a computer system to choose which location to navigate, which provides additional control options without cluttering the user interface with additional displayed controls.

In some examples, the computer system, while displaying the path to the predefined location, displays, via the display generation component, a fourth user interface object (e.g., 1316c). In some examples, the fourth user interface object is displayed in response to detecting the first input. In some examples, the fourth user interface object replaces the first user interface object in response to detecting the first input. In some examples, the fourth user interface object has a different appearance than the first user interface object. In some examples, the computer system: while displaying the fourth user interface object, detects an input directed to the fourth user interface object; and in response to detecting the input directed to the fourth user interface object, ceases to display the path to the predefined location. In some examples, in response to detecting the input directed to the fourth user interface object, the computer system ceases navigation with respect to the destination. In some examples, the first user interface object replaces the fourth user interface object in response to detecting the input directed to the fourth user interface object. In some examples, in response to detecting the input directed to the fourth user interface object, re-displaying a path to a previous destination (e.g., a destination selected before detecting the first input).

Providing the fourth user interface object to cease display of the path to the predefined location in response to user input provides a user with control over a computer system to choose which location to navigate, which provides additional control options without cluttering the user interface with additional displayed controls.

In some examples, the computer system: while displaying the plurality of user interface objects, detects a second input (e.g., 1316a) directed to the plurality of user interface objects, wherein the second input corresponds to (e.g., a long-press input, a press-and-hold input, a gaze input that is detected at a location for longer than a predetermined period of time (e.g., 1-5 seconds), and/or an air gesture (e.g., a double tap air gesture and/or a pinch-and-hold air gesture) a different type of input than the first input; and in response to detecting the second input directed to the plurality of selectable user interface object: in accordance with a determination that the second input is directed to the first user interface object, displays a second plurality of user interface objects, including: a user interface object (e.g., 1318a) for a first predefined location that, when selected, causes the computer system to display a path to the first predefined location (e.g., without displaying the path to another predefined location); and a user interface object (e.g., 1320a) for a second predefined location that, when selected, causes the computer system to display a path to a second predefined location that is different from the first predefined location. In some examples, the user interface object for the first predefined location and the user interface object for the second predefined location are displayed at locations within the representation.

Providing multiple predefined locations to choose from in response to user input provides a user with control over a computer system to choose which location to navigate, which provides additional control options without cluttering the user interface with additional displayed controls.

Note that details of the processes described above with respect to method 1400 (e.g., FIG. 14) are also applicable in an analogous manner to the methods described below. For example, method 1500 optionally includes one or more of the characteristics of the various methods described above with reference to method 1400. For example, the plurality of user interface objects of method 1400 can be displayed concurrently with the representation of the physical environment of method 1500. For brevity, these details are not repeated below.

FIG. 15 is a flow diagram illustrating a method for modifying navigation to a destination using a computer system in accordance with some embodiments. Method 1500 is performed at a computer system (e.g., 100, 300, 500, 600, and/or 1000) that is in communication with a display generation component (e.g., display screen, a touch-sensitive display) (in some examples, the computer system is a watch, a fitness tracking device, a phone, a tablet, a processor, a head-mounted display (HMD) device, and/or a personal computing device) and one or more sensor components (e.g., a microphone, a camera, a radar, a lidar, a touch-sensitive display, and/or a physical button) (in some examples, a sensor component of the one more sensor components is the display generation component, such as a touch-sensitive display). Some operations in method 1500 are, optionally, combined, the orders of some operations are, optionally, changed, and some operations are, optionally, omitted.

As described below, method 1500 provides an intuitive way for modifying navigation to a destination. The method reduces the cognitive burden on a user for modifying navigation to a destination, thereby creating a more efficient human-machine interface. For battery-operated computing devices, enabling a user to modify navigation to a destination faster and more efficiently conserves power and increases the time between battery charges.

At 1510 of method 1500, the computer system, while navigating to a destination (e.g., providing instructions (e.g., 1312) to the destination and/or a map (e.g., 1314) with a path to the destination) (in some examples, navigating to the destination includes causing the computer system to be moved toward the destination), displays, via the display generation component, a representation of a physical environment (e.g., a map, an image, a video, a three-dimensional representation, a two-dimensional representation, and/or a computer-generated representation).

At 1520 of method 1500, the computer system, while displaying the representation, detects, via at least one sensor component of the one or more sensor components, an input (e.g., 1315, 1317) corresponding to the representation.

At 1530 of method 1500, the computer system, in response to detecting the input and in accordance with a determination that a first set of one or more criteria are met (e.g., the input is a certain type of input (e.g., a swipe input, a flicking input and/or air gesture, a pushing motion air gesture, a swiping motion air gesture), the input move across and/or to a selectable predefined lateral area), changes a lateral position (e.g., 1314c in FIG. 13F) within the navigation from a first predefined lateral area (e.g., predefined by markings in the physical environment and/or predefined by a computer system) to a second predefined lateral area.

At 1540 of method 1500, the computer system, in response to detecting the input and in accordance with a determination that a second set of one or more criteria are met, wherein the second set of one or more criteria includes a criterion that is met when a determination is made that the first set of one or more criteria are not met, forgoes change of the lateral position within the navigation (e.g., from the first predefined lateral area to the second predefined lateral area).

Changing a lateral position within a navigation in response to user input provides a user with control over a computer system to choose how to navigate, which provides additional control options without cluttering the user interface with additional displayed controls.

In some examples, in response to detecting the input: in accordance with a determination that the first set of one or more criteria are met and in accordance with a determination that the input moved in a first direction (e.g., right, left, up, and/or down), the second predefined lateral area is a second direction from the first predefined lateral area; and in accordance with a determination that the first set of one or more criteria are met and in accordance with a determination that the input moved in a third direction (e.g., right, left, up, and/or down) that is different from the second direction, the second predefined lateral area is a fourth direction from the first predefined lateral area, wherein the first direction is different from the third direction, and wherein the second direction is different from the fourth direction.

Allowing a user to change a navigation in different directions in response to user input provides a user with control over a computer system to choose how to navigate, which provides additional control options without cluttering the user interface with additional displayed controls.

In some examples, before detecting the input, displaying a first potion of a path to a destination. In such examples, the computer system: in response to detecting the input and in accordance with a determination that the first set of one or more criteria are met, replaces the first portion (e.g., FIG. 13F) of the path with a portion of the path that indicates the changing of the lateral position within the navigation from the first predefined lateral area to the second predefined lateral area.

Replacing the first portion of the path with a portion of the path that indicates the changing of the lateral position within the navigation in response to user input provides a user with control over a computer system to choose how to navigate, which provides additional control options without cluttering the user interface with additional displayed controls.

In some examples, the first predefined lateral area and the second predefined lateral area are parallel (e.g., reasonably and/or approximately parallel (e.g., parallel for at least a first portion of the first area and the second area)).

Having the first predefined lateral area and the second predefined lateral area be parallel allows for directional user input to differentiate which way to go, which provides additional control options without cluttering the user interface with additional displayed controls.

In some examples, the computer system: after changing the lateral position within the navigation from the first predefined lateral area to the second predefined lateral area, detects a second input (e.g., 1317) corresponding to the representation; and in response to detecting the second input corresponding the representation and in accordance with a determination that the first set of one or more criteria are met, changes the lateral position within the navigation from the second predefined lateral area to a third predefined lateral area (e.g., different from the predefined lateral area) (e.g., where the second predefined lateral area is parallel (e.g., reasonably parallel) to the third predefined lateral area), wherein the second input is in the same direction as the input.

Changing the lateral position within the navigation from the second predefined lateral area to a third predefined lateral area in response to user input provides a user with control over a computer system to choose how to navigate, which provides additional control options without cluttering the user interface with additional displayed controls.

In some examples, the computer system, after changing the lateral position within the navigation from the first predefined lateral area to the second predefined lateral area, detects a third input corresponding to the representation; and in response to detecting the third input corresponding the representation and in accordance with a determination that a third set of one or more criteria are met, performs a navigation (e.g., FIG. 13G) operation to navigate differently than changing only a lateral position (e.g., performing a turn and/or changing the orientation of the computer system from being in one direction to another direction), wherein the third input is in the same direction as the input. In some examples, third set of one or more criteria is different form the first set or one or more criteria and/or the second set of one or more criteria.

Performing a navigation operation to navigate differently than changing only a lateral position in response to user input provides a user with control over a computer system to choose how to navigate, which provides additional control options without cluttering the user interface with additional displayed controls.

In some examples, the computer system, after changing the lateral position within the navigation from the first predefined lateral area to the second predefined lateral area, detects a fourth input corresponding to the representation, wherein the fourth input is in a direction that is different from a direction of the input; and in response to detecting the fourth input and in accordance with a determination that a fourth set of one or more criteria are met, changes the lateral position within the navigation from the second predefined lateral area to the first predefined lateral area. In some examples, the fourth set of one or more criteria are different from the first set of one or more criteria.

Changing the lateral position within the navigation from the second predefined lateral area to the first predefined lateral area in response to user input provides a user with control over a computer system to choose how to navigate, which provides additional control options without cluttering the user interface with additional displayed controls.

In some examples, the first set of criteria includes a criterion that is met when at least one predefined lateral area is available (e.g., not occupied, exists (e.g., too far right and/or too far left in an area, such as a sidewalk, a hallway, a road, and/or a yard)) in a respective direction of movement of the input.

Using criteria based on at least one predefined lateral area being available in a respective direction of movement of the input provides a user with control over a computer system to choose how to navigate, which provides additional control options without cluttering the user interface with additional displayed controls and performs an operation when a set of conditions has been met without requiring further user input.

Note that details of the processes described above with respect to method 1500 (e.g., FIG. 15) are also applicable in an analogous manner to the methods described above. For example, method 1400 optionally includes one or more of the characteristics of the various methods described above with reference to method 1500. For example, the input of method 1500 can be used to modify navigation to a predefined or non-predefined location of method 1400. For brevity, these details are not repeated above.

FIGS. 16A-16E illustrate exemplary user interfaces for navigating in a physical environment using computer system 600 in accordance with some embodiments. In particular, the user interfaces walk through an example of a user navigating to a destination and stopping at different locations within the destination. The user interfaces in these figures are used to illustrate the processes described below, including the processes in 700 and 800. Through the user interfaces, user input is illustrated using a circular shape with dotted lines (e.g., user input 1623 in FIG. 16A). It should be recognized that the user input can be any type of user input, including a tap on touch-sensitive screen, a button press, a gaze toward a control, a voice request with an identification of a control, a gesture made by a user and captured by a camera, and/or any other affirmative action performed by a user. In some examples, a single representation of a user input in a FIG. 1) includes one or more different types of user input and/or (2) represents different types of user input to result in different operations. For example, a single illustrated user input can be a tap input, a tap-and-hold input, and/or a swipe gesture.

In some examples, the navigation begins with a user requesting that computer system 600 navigate to the destination. For example, the user can verbally ask a personal assistant installed on computer system 600 to navigate to a fast-food restaurant. In response to the request, computer system 600 identifies a location corresponding to the fast-food restaurant and initiates navigation.

In some examples, the user request for the fast-food restaurant does not specify more than that the user wants to navigate to the fast-food restaurant. For example, the user might not specify where to go once at the fast-food restaurant or what the user would like to do. In some examples, such additional information (e.g., where to go or what to do) is determined by computer system 600 and computer system 600 automatically creates a path to take that will arrive at one or more different locations of the fast-food restaurant. Examples of such locations can include for picking up or dropping off a person or object, stopping or waiting for an event to occur, viewing a visible item, speaking with a person, and/or numerous other tasks that can occur at different locations of a destination.

Referring to FIG. 16A, user interface 1610 is displayed as computer system 600 arrives at the fast-food restaurant. User interface 1601 includes map portion 1614 with a live camera feed and/or a map of a physical environment. In some examples, the map includes one or more objects in the physical environment. For example, the map illustrated in FIG. 16A includes road 1614a (e.g., a road in the physical environment), current locator 1620 (e.g., a current location of computer system 600), and one or more locations at the fast-food restaurant (e.g., menu 1622, speaker 1624, pick up 1626). In such an example, computer system 600 can be navigating to menu 1622 with or without an explicit request from a user. In some examples, a user can explicitly request to navigate to menu through user input (e.g., user input 1623). In other examples, computer system 600 can identify a current context and determine, based on the context, a most likely location within the destination wanted by the user.

As illustrated in FIG. 16B, user navigates to menu 1622 via computer system 600. In some examples, once at menu 1622, computer system 600 surfaces (e.g., displays) information and/or a control to provide additional functionality related to menu 1622. For example, bottom portion 1616 of user interface 1610 includes menu control 1616a that is selectable (e.g., via user input 1616a) to display a digital copy of a menu (illustrated as digital menu 1632 of user interface 1630 in FIG. 16C). In some examples, arriving at menu 1622 causes computer system 600 to initiate camera capture of a physical menu located outside such that the physical menu can be displayed by computer system 600. In other words, arriving at menu 1622 triggers computer system 600 to activate a camera to capture the physical environment. It should be recognized that computer system 600 can activate other types of sensors or cause one or more actuators to affect a change, such as opening a window. In addition, in some examples, one or more sensors in communication with computer system 600 capture data to identify objects nearby. In response to identifying objects, computer system 600 can activate one or more other sensors to interact with an identified object.

As illustrated in FIG. 16B, computer system 600 detects user input 1625 to select speaker 1624, causing navigation to speaker 1624. In some examples, user input 1625 also causes computer system 600 to stop capturing data from a sensor (e.g., a camera) and/or reverse an action performed by an actuator, such an opening a door. In such examples, computer system 600 determines that such actions are no longer needed before reversing a previously performed action.

FIG. 16D illustrates current locator 1614b arriving at speaker 1624. In some examples, computer system 600 causes menu 1622 to no longer be displayed as current locator 1614b leaves menu 222 and, instead, causes a microphone in communication with computer system 600 to capture audio. Such audio can be to capture something said by the user and/or capture something said in the physical environment, such as a person located in the physical environment. In some examples, one or more speakers are also activated to convey audio captured by the microphone to the user and/or the person located in the physical environment.

As illustrated in FIG. 16D, computer system 600 detects user input 1627 to select pick up 1626, causing navigation to pick up 1626. Similar to FIG. 16B for user input 1625, user input 1627 causes computer system 600 to stop capturing data from a sensor (e.g., a microphone) and/or reverse an action performed by another device (e.g., turns off the one or more speakers). In such examples, computer system 600 determines that such actions are no longer needed.

FIG. 16E illustrates current locator 1614b arriving at pick up 1626. In some examples, computer system 600 causes an output device in communication with computer system 600 to activate. The output device, for example, can cause a window or other surface to open to be able to receive items from pick up 1626.

While the above example goes linearly through locations of the destination, it should be recognized that a user can choose any of the locations at the fast-food restaurant to get instructions to navigate to the respective location.

FIG. 17 is a flow diagram illustrating a method for navigating to different locations of a destination using a computer system in accordance with some embodiments. Method 1700 is performed at a computer system (e.g., 100, 300, 500, 600, and/or 1000) that is in communication with a first set of one or more devices (e.g., a display generation component (such as a display screen or a touch-sensitive display), a microphone, a camera, a radar sensor, a lidar sensor, an actuator, a window and/or a speaker) and a second set of one or more devices (e.g., includes different type (e.g., a display generation component (such as a display screen or a touch-sensitive display), a microphone, a camera, a radar sensor, a lidar sensor, an actuator, a window and/or a speaker) of devices) that is different from the first set of one or more devices. In some examples, the computer system is a watch, a fitness tracking device, a phone, a tablet, a processor, a head-mounted display (HMD) device, and/or a personal computing device. Some operations in method 1700 are, optionally, combined, the orders of some operations are, optionally, changed, and some operations are, optionally, omitted.

As described below, method 1700 provides an intuitive way for navigating to different locations of a destination. The method reduces the cognitive burden on a user for navigating to different locations of a destination, thereby creating a more efficient human-machine interface. For battery-operated computing devices, enabling a user to navigate to different locations of a destination faster and more efficiently conserves power and increases the time between battery charges.

At 1710 of method 1700, the computer system detects a request to navigate to a destination that includes a plurality of locations (e.g., a predetermined location, a predefined location, and/or location at destination, such as drive-thru is the destination and the drive-thru has a menu location, a location for ordering, and a location for receiving an order). In some examples, the user request does not specify one or more of the plurality of locations and the computer system navigates to the destination and automatically performs method 1700 without a user specifying one or more of the plurality of locations. In some examples, the plurality of locations are predetermined and/or determined before navigating to the destination. In some examples, the plurality of locations are determined after initiating navigation to the destination based on data detected by one or more sensors, such as a camera, radar, and/or lidar.

At 1720 of method 1700, the computer system (e.g., 600), in response to detecting the request, navigates to the destination (e.g., the fast food restaurant in FIG. 16A) (e.g., providing instructions (e.g., 1612) to go to the destination and/or a map (e.g., 1614) with a path (e.g., 1618) to the destination) (e.g., in an environment that is not within the computer system (e.g., a physical environment and/or a virtual environment) (e.g., an environment that is outside of and/or external to a housing of the computer system)). In some examples, as a part of navigating to the destination, the computer system is caused to be moved toward the destination.

At 1730 of method 1700, the computer system, in conjunction with (e.g., while, within a predetermined time after (e.g., 0-5 minutes), or within the predetermined time before) arriving at the destination (e.g., approaching the destination and/or at a location determined to be the destination) (e.g., after navigating to the destination), navigates to a first location (e.g., menu 1622) (e.g., a location that has information (e.g., a sign, a billboard, a menu, and/or instructions), a location that has a receiver and/or microphone (e.g., a place to order tickets and/or a menu), and/or a location that has things to be received (e.g., a pick-up window, a delivery person, and/or a ticket counter) of the plurality of locations.

At 1740 of method 1700, the computer system, in conjunction with (e.g., while, within a predetermined time after (e.g., 0-5 minutes), or within the predetermined time before) navigating to the first location, activates, automatically and without intervening user input, the first set of one or more devices without activating (e.g., without automatically activating) the second set of one or more devices (e.g., without a user input to navigate to the first location and without a user input to activate the first set of one or more devices).

At 1750 of method 1700, the computer system, after navigating to the first location, navigates to a second location (e.g., 1624) (e.g., a location that has information (e.g., a sign, a billboard, a menu, and/or instructions), a location that has a receiver and/or microphone (e.g., a place to order tickets and/or a menu), and/or a location that has things to be received (e.g., a pick-up window, a delivery person, and/or a ticket counter) of the plurality of locations, wherein the second location is different from the first location. In some examples, the computer system navigates to the first location and the second location without user input.

At 1760 of method 1700, the computer system, in conjunction with navigating to the second location, activates, automatically and without intervening user input, the second set of one or more devices without activating (e.g., without automatically activating) the first set of one or more devices (e.g., without a user input to navigate to the second location and without a user input to activate the second set of one or more devices). In some examples, the computer system navigates to a location of a destination. In some examples, in response to navigating to the location and in accordance with a determination that the location is or corresponds to a first type of location, the computer system activates the first set of one or more devices without activating the second set of one or more devices. In some examples, in response to navigating to the location and in accordance with a determination that the location is or corresponds to a second type of location that is different from the first type of location, the computer system activates the second set of one or more devices without activating the first set of one or more devices.

Activating, automatically and without intervening user input, different sets of devices at different locations performs operations for a user without their input, which performs an operation when a set of conditions has been met without requiring further user input.

In some examples, in conjunction with navigating to the first location: in accordance with a determination that the first location corresponds to a first type of location, wherein the first type of location is a location for viewing information related to the destination: activating (e.g., automatically and without intervening user input) the first set of one or more devices includes displaying, via a display generation component (e.g., automatically and without intervening user input), the information (e.g., 1616a, 1628) related to the destination, wherein the first set of one or more devices includes the display generation component when the first location corresponds to the first type of location; and in accordance with a determination that the first location does not correspond to the first type of location: activating the first set of one or more devices does not include displaying. via the display generation component, information from the environment (e.g., automatically and without intervening user input), wherein the first set of one or more devices does not include the display generation component when the first location does not correspond to the first type of location (and, in some embodiments, the second set of one or more devices includes the display generation component).

Activating, automatically and without intervening user input, different sets of devices at different locations performs operations for a user without their input, which performs an operation when a set of conditions has been met without requiring further user input.

In some examples, in conjunction with navigating to the first location: in accordance with a determination that the first location corresponds to a second type of location, wherein the second type of location is a location for viewing information in an environment (e.g., a physical environment): activating (e.g., automatically and without intervening user input) the first set of one or more devices includes initiating capture of an environment via one or more cameras (e.g., automatically and without intervening user input) (e.g., one or more telephoto, wide-angle, and/or ultra-wide-angle cameras) (e.g., one or more cameras that are external to the computer system (e.g., a field of view of the one or more cameras is primarily outside of a housing of the computer system) and/or one or more cameras that are not within the computer system), wherein the first set of one or more devices includes the one or more cameras (e.g., one or more external-facing cameras) when the first location corresponds to the second type of location; and in accordance with a determination that the first location does not correspond to the second type of location: activating the first set of one or more devices does not include initiating capture of the environment via the one or more cameras (e.g., automatically and without intervening user input), wherein the first set of one or more devices does not include the one or more cameras when the first location does not correspond to the second type of location (and, in some embodiments, the second set of one or more devices includes the one or more cameras). In some examples, the one or more cameras are internal cameras (e.g., when information about an area inside of the computer system needs to be conveyed to the environment).

Activating, automatically and without intervening user input, different sets of devices at different locations performs operations for a user without their input, which performs an operation when a set of conditions has been met without requiring further user input.

In some examples, in conjunction with navigating to the first location: in accordance with a determination that the first location corresponds to a third type of location, wherein the third type of location is a location for outputting visual information to an area external to a housing (e.g., to an area not inside of the housing) of the computer system: activating (e.g., automatically and without intervening user input) the first set of one or more devices includes initiating capture of an internal portion of the computer system via one or more cameras (e.g., automatically and without intervening user input) (e.g., one or more telephoto, wide-angle, and/or ultra-wide-angle cameras), wherein the first set of one or more devices includes the one or more cameras (e.g., one or more internal-facing cameras) when the first location corresponds to the third type of location; and in accordance with a determination that the first location does not correspond to the third type of location: activating the first set of one or more devices does not include initiating capture of the internal portion of the computer system via the one or more cameras (e.g., automatically and without intervening user input), wherein the first set of one or more devices does not include the one or more cameras when the first location does not correspond to the third type of location (and, in some embodiments, the second set of one or more devices includes the one or more internal cameras).

Activating, automatically and without intervening user input, different sets of devices at different locations performs operations for a user without their input, which performs an operation when a set of conditions has been met without requiring further user input.

In some examples, in conjunction with navigating to the first location: in accordance with a determination that the first location corresponds to a fourth type of location, wherein the fourth type of location is a location to output audio information (e.g., audio and/or sound information): activating (e.g., automatically and without intervening user input) the first set of one or more devices includes outputting, via a respective speaker, audio information (e.g., audio information from the environment and/or audio information to the environment) (e.g., and at the first location and/or audio information associated with the first location), wherein the first set of one or more devices includes the respective speaker when the first location corresponds to the fourth type of location; and in accordance with a determination that the first location does not correspond to the fourth type of location: activating the first set of one or more devices does not include outputting, via the respective speaker, audio information from the environment (e.g., automatically and without intervening user input), wherein the first set of one or more devices does not include the respective speaker when the first location does not correspond to the fourth type of location (and, in some embodiments, the second set of one or more devices includes the respective speaker).

Activating, automatically and without intervening user input, different sets of devices at different locations performs operations for a user without their input, which performs an operation when a set of conditions has been met without requiring further user input.

In some examples, the computer system is in communication with an external speaker (e.g., a speaker configured to output audio external to (or outside of) the computer system) and an internal speaker (e.g., a speaker configured to output audio internal to (or inside of) the computer system) (e.g., that is different from the external speaker), and wherein: in accordance with a determination that the first location corresponds to the fourth type of location and in accordance with a determination that the audio information is to be provided to the environment (e.g. from the computer system to the environment) (e.g., and, in some embodiments, during a first period of time or another period of time while at the first location), the respective speaker is the external speaker (e.g., a speaker that is positioned on the outside of and/or external to a housing of the computer system) (and, in some embodiments, includes or does not includes the internal speaker). In some examples, the first set of one or more devices does not include the internal speaker in accordance with a determination that the first location corresponds to the fourth type of location and in accordance with a determination that the audio information should be provided to the environment; in other embodiments, the first set of one or more devices includes the internal speaker.

In some examples, in accordance with a determination that the first location corresponds to the fourth type of location and in accordance with a determination that the audio information is to be provided from the environment (and, in some embodiments, to the computer system) (e.g., and, in some embodiments, during the first period of time or another period of time while at the first location), the respective speaker is the internal speaker (and, in some embodiments, includes or does not includes the external speaker) (e.g., a speaker that is positioned on the inside of and/or internal to the housing of the computer system). In some examples, the first set of one or more devices does not include the external speaker in accordance with a determination that the first location corresponds to the fourth type of location and in accordance with a determination that the audio information should be provided from the environment; in other embodiments, the first set of one or more devices includes the external speaker.

Activating, automatically and without intervening user input, different sets of devices at different locations performs operations for a user without their input, which performs an operation when a set of conditions has been met without requiring further user input.

In some examples, in conjunction with navigating to the first location: in accordance with a determination that the first location corresponds to a fifth type of location, wherein the fifth type of location is a location for providing audio information (e.g., sound information) to the environment: activating (e.g., automatically and without intervening user input) the first set of one or more devices includes capturing, via a first microphone, audio information from the computer system (e.g., from a user of), wherein the first set of one or more devices includes the first microphone when the first location corresponds to the fifth type of location; and in accordance with a determination that the first location does not correspond to the fifth type of location: activating the first set of one or more devices does not include capturing, via the first microphone, audio information from the computer system (e.g., automatically and without intervening user input), wherein the first set of one or more devices does not include the first microphone when the first location does not correspond to the fifth type of location (and, in some embodiments, the second set of one or more devices includes the microphone).

Activating, automatically and without intervening user input, different sets of devices at different locations performs operations for a user without their input, which performs an operation when a set of conditions has been met without requiring further user input.

In some examples, the computer system is in communication with an external microphone and an internal microphone (e.g., that is different from the external microphone), and wherein: in accordance with a determination that the first location corresponds to the fifth type of location and in accordance with a determination that the audio information should be provided to the environment (e.g., and, in some embodiments, during a second period of time or another period of time while at the first location), the first microphone is the internal microphone (e.g., a microphone that is positioned on the inside of and/or internal to a housing of the computer system) (e.g., a microphone configured to capture sound in a housing of the computer system). In some examples, the first set of one or more devices does not include the external microphone in accordance with a determination that the first location corresponds to the fifth type of location and in accordance with a determination that the audio information should be provided to the environment; in other embodiments, the first set of one or more devices includes the external microphone.

In some examples, in accordance with a determination that the first location corresponds to the fifth type of location and in accordance with a determination that the audio information should be provided from the environment (e.g., and, in some embodiments, during second period of time or another period of time while at the first location), the first microphone is the external microphone (e.g., a microphone that is positioned on the outside of and/or external to the housing of the computer system) (e.g., a microphone configured to capture sound outside of a housing of the computer system). In some examples, the first set of one or more devices does not include the internal microphone in accordance with a determination that the first location corresponds to the fifth type of location and in accordance with a determination that the audio information should be provided from the environment; in other embodiments, the first set of one or more devices includes the internal microphone.

Activating, automatically and without intervening user input, different sets of devices at different locations performs operations for a user without their input, which performs an operation when a set of conditions has been met without requiring further user input.

In some examples, in conjunction with navigating to the first location: in accordance with a determination that the first location corresponds to a sixth type of location (e.g., pick up 1626), wherein the sixth type of location corresponds a location for sending or receiving objects (e.g., a package, food, a ticket, a ball, a bat, and/or a pencil): activating (e.g., automatically and without intervening user input) the first set of one or more devices includes causing, via a first actuator (e.g., a lever, a lift, a pulley, and/or a movable arm), a first portion (e.g., a display generation component, a window, a screen, and/or a display) of the computer system to move (e.g., be lowered and/or be raised) from a first position (e.g., 0-100% opened and/or closed) to a second position that is different from the first position, where the first set of one or more devices include the first actuator when the first location corresponds to the sixth type of location; and in accordance with a determination that the first location does not correspond to the sixth type of location: activating the first set of one or more devices does not include causing, via the first actuator, to move, where the first set of one or more devices does not include the first actuator when the first location does not correspond to the sixth type of location.

Activating, automatically and without intervening user input, different sets of devices at different locations performs operations for a user without their input, which performs an operation when a set of conditions has been met without requiring further user input.

In some examples, after causing the first portion of the computer system to move from the first position to the second position and in conjunction with navigating away from the first location (e.g., leaving the first location and/or navigating to a different location of the plurality of locations and/or to a different destination), causing, via the first actuator, the first portion to be moved (e.g., from a third position (e.g., the second position and/or another position)) back to the first position. In some examples, the third position is different from the first position.

Activating, automatically and without intervening user input, different sets of devices at different locations performs operations for a user without their input, which performs an operation when a set of conditions has been met without requiring further user input.

In some examples, in accordance with a determination that the first location corresponds to the sixth type of location and in accordance with a determination that an object is to be received or sent from a first side of the computer system, the first actuator is an actuator that is on the first side of the computer system and the first portion is on the first side of the computer system.

In some examples, in accordance with a determination that the first location corresponds to the sixth type of location and in accordance with a determination that an object is to be received or sent from a second side of the computer system, the first actuator is an actuator that is on the second side of the computer system and the first portion is on the second side of the computer system, wherein the first side is different from the second side.

Activating, automatically and without intervening user input, different sets of devices at different locations performs operations for a user without their input, which performs an operation when a set of conditions has been met without requiring further user input.

In some examples, the computer system, in conjunction with navigating away from the first location (e.g., leaving the first location and/or navigating to a different location of the plurality of locations and/or to a different destination), deactivates the first set of one or more devices; and in conjunction with navigating away from the second location (e.g., leaving the second location and/or navigating to a different location of the plurality of locations and/or to a different destination), deactivates the second set of one or more devices.

Activating, automatically and without intervening user input, different sets of devices at different locations performs operations for a user without their input, which performs an operation when a set of conditions has been met without requiring further user input.

Note that details of the processes described above with respect to method 1700 (e.g., FIG. 17) are also applicable in an analogous manner to the methods described below. For example, method 1800 optionally includes one or more of the characteristics of the various methods described above with reference to method 1700. For example, after arriving at the second location of method 1700, the plurality of user interface of objects of method 900 can be displayed. For brevity, these details are not repeated below.

FIG. 18 is a flow diagram illustrating a method for displaying different predefined activities for a destination using a computer system in accordance with some embodiments. Method 1800 is performed at a computer system (e.g., 100, 300, 500, 600, and/or 1000) that is in communication with a first set of one or more devices (e.g., a display generation component (such as a display screen or a touch-sensitive display), a microphone, a camera, a radar, a lidar sensor, an actuator, a window and/or a speaker) and a second set of one or more devices that is different from (e.g., includes different devices or at least one device of a different type (e.g., a display generation component (such as a display screen or a touch-sensitive display), a microphone, a camera, a radar, a lidar sensor, an actuator, a window and/or a speaker)) the first set of one or more devices. In some examples, the computer system is a watch, a fitness tracking device, a phone, a tablet, a processor, a head-mounted display (HMD) device, and/or a personal computing device. Some operations in method 1800 are, optionally, combined, the orders of some operations are, optionally, changed, and some operations are, optionally, omitted.

As described below, method 1800 provides an intuitive way for navigating to different locations of a destination. The method reduces the cognitive burden on a user for navigating to different locations of a destination, thereby creating a more efficient human-machine interface. For battery-operated computing devices, enabling a user to navigate to different locations of a destination faster and more efficiently conserves power and increases the time between battery charges.

At 1810 of method 1800, the computer system navigates to a destination (as described above in relation to method 1700), wherein the destination includes a plurality of predefined activities (e.g., transmitting information and/or objects, ordering information and/or objects, viewing information and/or objects, listening to information and/or objects, receiving information and/or objects, and/or speaking information) and a plurality of predefined locations (as described above in relation to method 1700). In some examples, different predefined activities correspond (e.g., are located at) different predefined locations, such as a first predefined activity corresponds to a first predefined location and a second predefined activity corresponds to a second predefined location.

At 1820 of method 1800, the computer system, while navigating to the destination (e.g., and in conjunction with (e.g., while, within a predetermined time after (e.g., 0-2 minutes), or within the predetermined time before (e.g., 0-5 minutes) arriving at the destination (e.g., approaching the destination and/or at a location determined to be the destination)), displays (e.g., via a display generation component that is in communication with the computer system) a plurality of user interface objects, including: a first user interface object (e.g., a selectable user interface object and/or an affordance) corresponding to a first predefined activity of the plurality of predefined activities; and a second user interface object corresponding to a second predefined activity of the plurality of predefined activities, wherein the second user interface object is different from the first user interface object, and wherein the second predefined activity is different from the first predefined activity.

At 1830 of method 1800, the computer system receives a set of one or more user inputs that includes a respective input that is directed to (e.g., corresponding to, at a location corresponding to, on, and/or that overlays a location corresponding to) the plurality of user interface objects. In some examples, receiving the respective input includes detecting, via a microphone, an audio instruction. In some examples, receiving the respective input includes detecting, via the display generation component, a touch input. In some examples, receiving the respective input includes detecting, via a camera, a gesture performed by a user (e.g., an air gesture and/or air input), in some examples, receiving the respective input includes detecting, via a hardware component (e.g., a button and/or a rotatable input mechanism), the respective input.

At 1840 of method 1800, the computer system, in response to receiving the set of one or more user inputs (or in response to receiving the respective input) and in accordance with a determination that the respective input was directed to the first user interface object, navigates to a first predefined location of the plurality of predefined locations, wherein the first predefined location corresponds to the first predefined activity (e.g., providing instructions to the first predefined location and/or a map with a path to the first predefined location) (in some examples, navigating to the first predefined location includes causing the computer system to be moved toward the first predefined location).

At 1850 of method 1800, the computer system, in response to receiving the set of one or more user inputs (or in response to receiving the respective input), in accordance with a determination that the respective input was directed to the first user interface object, and in conjunction with being at the first predefined location, activates the first set of one or more devices (and, in some embodiments, without activating the second set of one or more devices).

At 1860 of method 1800, the computer system, in response to receiving the set of one or more user inputs (or in response to receiving the respective input) and in accordance with a determination that the respective input was directed to the second user interface object, navigates to a second predefined location of the plurality of predefined locations (e.g., providing instructions to the second predefined location and/or a map with a path to the second predefined location) (in some examples, navigating to the second predefined location includes causing the computer system to be moved toward the second predefined location), wherein the second predefined location corresponds to the second predefined activity, and wherein the second predefined location is different from the first predefined location.

At 1870 of method 1800, the computer system, in response to receiving the set of one or more user inputs (or in response to receiving the respective input), in accordance with a determination that the respective input was directed to the second user interface object, and in conjunction with being at the second predefined location, activates the second set of one or more devices (and, in some embodiments, without activating the first set of one or more devices). In some examples, in response to receiving the set of one or more user inputs, the computer system ceases to display the plurality of selectable user interface objects and/or one or more of the plurality of user interface objects (e.g., the user interface objects that were not selected by the input or the user interface object that was selected by the input).

Displaying different user interface objects that, when selected, navigate to a particular location and activate a particular set of sensors, performs operations for a user without their input, which performs an operation when a set of conditions has been met without requiring further user input.

In some examples, the computer system, in response to receiving the set of one or more user inputs: in accordance with a determination that the respective input was directed to the first user interface object and in conjunction with being at the first predefined location, forgoes activation of the second set of one or more devices; and in accordance with a determination that the respective input was directed to the second user interface object and in conjunction with being at the second predefined location, forgoes activation of the first set of one or more devices.

Displaying different user interface objects that, when selected, navigate to a particular location and activate a particular set of sensors, performs operations for a user without their input, which performs an operation when a set of conditions has been met without requiring further user input.

In some examples, the computer system is in communication with a third set of one or more devices that is different from the first set of one or more devices and the second set of one or more devices. In some examples, the computer system, in response to receiving the set of one or more user inputs: in accordance with a determination that the respective input was directed to the first user interface object and in conjunction with being at the first predefined location, activates the third set of one or more devices; and in accordance with a determination that the respective input was directed to the second user interface object and in conjunction with being at the second predefined location, activates the third set of one or more devices.

Displaying different user interface objects that, when selected, navigate to a particular location and activate a particular set of sensors, performs operations for a user without their input, which performs an operation when a set of conditions has been met without requiring further user input.

In some examples, the computer system is in communication with a fourth set of one or more devices that is different from the first set of one or more devices and the second set of one or more devices. In some examples, the computer system, in response to receiving the set of one or more user inputs: in accordance with a determination that the respective input was directed to the first user interface object and in conjunction with being at the first predefined location, forgoes activation of the fourth set of one or more devices; and in accordance with a determination that the respective input was directed to the second user interface object and in conjunction with being at the second predefined location, forgoes activation of the fourth set of one or more devices.

Displaying different user interface objects that, when selected, navigate to a particular location and activate a particular set of sensors, performs operations for a user without their input, which performs an operation when a set of conditions has been met without requiring further user input.

In some examples, the first set of one or more devices includes a first device and a second device that is different from the first device, and wherein activating the first set of one or more devices includes: during a first period of time and in conjunction with being at the first predefined location, activating the first device without activating the second device; and after the first period of time, during a second period of time (e.g., the first period of time is different from the second period of time), and in conjunction with being at the second predefined location, deactivating the first device and activating the second device.

Displaying different user interface objects that, when selected, navigate to a particular location and activate a particular set of sensors, performs operations for a user without their input, which performs an operation when a set of conditions has been met without requiring further user input.

In some examples, in conjunction with being at the first predefined location: in accordance with a determination that the first predefined location corresponds to a first type (e.g., 1622) (e.g., a type, such as a location that has information (e.g., a sign, a billboard, a menu, and/or instructions), a location that has a receiver and/or microphone (e.g., a place to order tickets and/or a menu), and/or a location that has things to be received (e.g., a pick-up window, a delivery person, and/or a ticket counter) of location, activating (e.g., automatically and without intervening user input) the first set of one or more devices includes displaying, via a second display generation component (e.g., automatically and without intervening user input), information (e.g., 1616a, 1622) related to the environment (e.g., as described above in relation to method 1700), wherein the first set of one or more devices includes the second display generation component when the first predefined location corresponds to the first type of location; and in accordance with a determination that the first predefined location does not correspond to the first type of location, activating (e.g., automatically and without intervening user input) the first set of one or more devices does not include displaying, via the second display generation component, information from the environment (e.g., as described above in relation to method 1700), wherein the first set of one or more devices does not include the second display generation component when the first predefined location does not correspond to the first type of location. In some examples, the second display generation component is the same as the display generation component. In some examples, the second display generation component is not the same as the display generation component.

Displaying different user interface objects that, when selected, navigate to a particular location and activate a particular set of sensors, performs operations for a user without their input, which performs an operation when a set of conditions has been met without requiring further user input.

In some examples, the information related to the environment is a representation of a field of view of one or more cameras that are captured the environment (e.g., as described above in relation to method 1700), and wherein the first set of one or more devices includes the one or more cameras when the information is displayed.

Displaying a representation of a field of view of one or more cameras that are captured the environment in response to user input provides a user information about an environment, which provides improved visual feedback to the user and reduces the number of inputs needed to perform an operation.

In some examples, in conjunction with being at the first predefined location: in accordance with a determination that the first predefined location corresponds to a second type of location, activating (e.g., automatically and without intervening user input) the first set of one or more devices includes capturing, via a first sensor (e.g., a microphone and/or a camera), data (e.g., audio data and/or visual data) (e.g., as described above in relation to method 1700), wherein the first set of one or more devices includes the first sensor when the first predefined location corresponds to the second type of location. In some examples, the first sensor is in communication with the computer system. In some examples, the computer system includes the first sensor. In some examples, in accordance with a determination that the first predefined location does not correspond to the second type of location, activating (e.g., automatically and without intervening user input) the first set of one or more devices does not include capturing data via the first sensor (e.g., as described above in relation to method 1700), wherein the first set of one or more devices does not include the first sensor when the first predefined location does not correspond to the second type of location.

Activating a sensor when a location corresponds to a particular type ensures that a user does not need to think about where they are and what sensor to active, which reduces the number of inputs needed to perform an operation.

In some examples, in conjunction with being at the first predefined location: in accordance with a determination that the first predefined location corresponds to a third type of location, activating (e.g., automatically and without intervening user input) the first set of one or more devices includes outputting, via a second sensor (e.g., a microphone and/or a camera), data (e.g., audio data and/or visual data) (e.g., as described above in relation to method 1700), wherein the first set of one or more devices includes the second sensor when the first predefined location corresponds to the third type of location. In some examples, the second sensor is in communication with the computer system. In some examples, the computer system includes the second sensor.

In some examples, in accordance with a determination that the first predefined location does not corresponds to the third type of location, activating (e.g., automatically and without intervening user input) the second set of one or more devices does not include outputting data (e.g., outputting audio data and/or information and/or visual information to the environment and/or from the environment) via the second sensor (e.g., as described above in relation to method 1700), wherein the first set of one or more devices does not include the second sensor when the first predefined location does not correspond to the third type of location.

Activating a sensor when a location corresponds to a particular type ensures that a user does not need to think about where they are and what sensor to active, which reduces the number of inputs needed to perform an operation.

In some examples, in conjunction with being at the first predefined location: in accordance with a determination that the first predefined location corresponds to a fourth type of location (e.g., pick up 1626), activating (e.g., automatically and without intervening user input) the first set of one or more devices includes causing an actuator (e.g., as described above in relation to method 1700) to move a portion of the computer system (e.g., and/or a portion of another computer system) from a first position to a second position that is different from the first position (e.g., audio data and/or visual data), wherein the first set of one or more devices includes the actuator when the first predefined location corresponds to the fourth type of location. In some examples, the actuator is in communication with the computer system. In some examples, the computer system includes the actuator.

In some examples, in accordance with a determination that the first predefined location does not corresponds to the fourth type of location, activating (e.g., automatically and without intervening user input) the second set of one or more devices does not include causing the actuator to move the portion of the computer system from the first position to the second position (e.g., as described above in relation to method 1700), wherein the first set of one or more devices does not include the actuator when the first predefined location does not correspond to the fourth type of location.

Activating a sensor when a location corresponds to a particular type ensures that a user does not need to think about where they are and what sensor to active, which reduces the number of inputs needed to perform an operation.

In some examples, the computer system, in response to receiving the set of one or more user inputs: in accordance with a determination that the respective input was directed to the first user interface object, displays, via the display generation component, a representation (e.g., a map, a live feed, and/or a computer-generated representation that is not a live feed and/or a camera feed) of the first predefined location (e.g., that was not previously displayed) (e.g., without displaying the representation (e.g., an enlarged representation) of the second predefined location); and in accordance with a determination that the respective input was directed to the second user interface object, displays, via the display generation component, a representation of the second predefined location (e.g., that is different from the representation of the first predefined location) (e.g., without displaying the representation (e.g., an enlarged representation) of the first predefined location).

Displaying representations of where a user is located allows a user to know where they are, which provides improved visual feedback to the user.

In some examples, the computer system, while at the first predefined location, displays, via the display generation component, a third user interface object that, when activated, causes the computer system to navigate away from the first predefined location.

Displaying a user interface object to navigate away from a predefined location ensures that a user has control of a computer system, which provides additional control options without cluttering the user interface with additional displayed controls.

In some examples, the computer system, while at the first predefined location and while displaying the third user interface object, detects an input (e.g., tap input, a mouse click, speech input, a gaze, and/or an air gesture) directed to the third user interface object; and in response to detecting the input directed to the third user interface object, deactivates the first set of one or more devices (and, in some embodiments, without activating the second set of one or more devices).

Giving the user the ability to deactivate devices ensures that a user has control of a computer system, which provides additional control options without cluttering the user interface with additional displayed controls.

In some examples, the computer system, while at the first predefined location: in accordance with a determination that the second predetermine location is a remaining location (e.g., a location that the computer system has not navigated away from, visited, and/or past while at the destination) for a destination, displays, via the display generation component, the second user interface object; and in accordance with a determination that the second predetermine location is not a remaining location for the destination, forgoes display of the second user interface object.

Only displaying locations remaining to visit allows the user to know the state of their trip, which provides improved visual feedback to the user, reduces the number of inputs needed to perform an operation, and provides additional control options without cluttering the user interface with additional displayed controls.

Note that details of the processes described above with respect to method 1800 (e.g., FIG. 18) are also applicable in an analogous manner to the methods described above. For example, method 1700 optionally includes one or more of the characteristics of the various methods described above with reference to method 1800. For example, after arriving at the second predefined location of method 1800, the computer system can navigate to the second location of method 1700. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve navigating to objects. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to navigate to objects. Accordingly, use of such personal information data enables users to have calculated control of navigation. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of navigation, the present technology can be configured to allow users to select to “opt in” or “opt out” of participation in the collection of personal information data during registration for services or anytime thereafter. In another example, users can select not to provide navigation data for navigating to objects. In yet another example, users can select to limit the length of navigation-associated data is maintained or entirely prohibit the development of a baseline navigation profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, objects can be navigated to by inferring preferences based on non-personal information data or a bare minimum amount of personal information, such as the content being requested by the device associated with a user, other non-personal information available to the navigation services, or publicly available information.

What is claimed is:

1. A method, comprising:
at a computer system that is in communication with a display generation component and one or more sensors:
detecting, via the one or more sensors, a gesture and
in response to detecting the gesture:
in accordance with a determination that a first set of one or more criteria is met, wherein the first set of criteria includes a criterion that is met when a determination is made that the gesture is a particular type of gesture, causing a portion of the computer system to move in the physical environment; and
in accordance with a determination that a second set of one or more criteria is met, forgoing causing the portion of the computer system to move in the physical environment, wherein the second set of one or more criteria is different from the first set of one or more criteria.

2. The method of claim 1, wherein the first set of one or more criteria includes a criterion that is met when a determination is made that the gesture is within a predetermined threshold distance from the computer system.

3. The method of claim 1, wherein the first set of one or more criteria includes a criterion that is met when a determination is made that the computer system is in a particular context.

4. The method of claim 1, wherein detecting the gesture includes detecting a user who made the gesture, and wherein the first set of one or more criteria includes a criterion that is met when a determination is made that the user is a particular type of user.

5. The method of claim 1, wherein the first set of one or more criteria includes a criterion that is met when a determination is made that the portion of the computer system has moved less than a predefined amount.

6. The method of claim 1, wherein:
in response to detecting the gesture:
in accordance with a determination that a third set of one or more criteria is met, wherein the third set of one or more criteria is different from the first and second set of one or more criteria:
in accordance with a determination that the gesture corresponds to a first direction, causing the portion of the computer system to move in the first direction; and
in accordance with determination that the gesture corresponds to a second direction that is different from the first direction, causing the portion of the computer system to move in the second direction.

7. The method of claim 6, wherein:
in response to detecting the gesture:
in accordance with a determination that the third set of one or more criteria is met and in accordance with a determination that the gesture corresponds to a third direction, forgoing causing the portion of the computer system to move.

8. The method of claim 1, wherein:
in response to detecting the gesture:
in accordance with a determination that a fourth set of one or more criteria is met, wherein the fourth set of one or more criteria is different from the first, second, and third set of one or more criteria:
in accordance with a determination that the gesture was detected for a first period of time, causing the portion of the computer system to move by a first amount; and
in accordance with a determination that the gesture was detected for a second period of time that is different from the first period of time, causing the portion of the computer system to move by a second amount that is different from the first amount.

9. The method of claim 1, further comprising:
in response to detecting the gesture:
in accordance with a determination that a fifth set of one or more criteria is met, wherein the fifth set of one or more criteria is different from the first, second, third, and fourth set of one or more criteria:
in accordance with a determination that the gesture is a first type of gesture, causing the portion of the computer system to move to a first position in the physical environment; and
in accordance with a determination that the gesture is a second type of gesture that is different from the first type of gesture, causing the portion of the computer system to move to a second position in the physical environment that is different from the first position.

10. The method of claim 1, wherein the computer system is in communication with a wearable device, and wherein the gesture is detected by one or more sensors of the wearable device.

11. The method of claim 1, wherein the computer system is in communication with a camera, and wherein the gesture is detected via the camera.

12. A non-transitory computer-readable storage medium storing one or more programs configured to be executed by one or more processors of a computer system that is in communication with a display generation component and one or more sensors, the one or more programs including instructions for:
detecting, via the one or more sensors, a gesture and
in response to detecting the gesture:
in accordance with a determination that a first set of one or more criteria is met, wherein the first set of criteria includes a criterion that is met when a determination is made that the gesture is a particular type of gesture, causing a portion of the computer system to move in the physical environment; and
in accordance with a determination that a second set of one or more criteria is met, forgoing causing the portion of the computer system to move in the physical environment, wherein the second set of one or more criteria is different from the first set of one or more criteria.

13. A computer system configured to communicate with a display generation component and one or more sensors, comprising:
one or more processors; and
memory storing one or more programs configured to be executed by the one or more processors, the one or more programs including instructions for:
detecting, via the one or more sensors, a gesture and
in response to detecting the gesture:
in accordance with a determination that a first set of one or more criteria is met, wherein the first set of criteria includes a criterion that is met when a determination is made that the gesture is a particular type of gesture, causing a portion of the computer system to move in the physical environment; and
in accordance with a determination that a second set of one or more criteria is met, forgoing causing the portion of the computer system to move in the physical environment, wherein the second set of one or more criteria is different from the first set of one or more criteria.
